(19) United States
(12) Patent Application Publication
(10) Pub. No.: US 2012/0102543 A1
(43) Pub. Date: Apr. 26, 2012

(54) Audit Management System

(75) Inventors: Ashwin Kohli, Forest Hills, NY (US); David A. George, Somers, NY (US); Kevin Tinagero, Oakdale, NY (US)

(73) Assignee: 360 GRC, Inc.

(21) Appl. No.: 13/279,498

(22) Filed: Oct. 24, 2011

Related U.S. Application Data
(60) Provisional application No. 61/406,590, filed on Oct. 26, 2010.

(51) Int. Cl. G06F 21/00

(52) U.S. Cl. 726/1

(57) ABSTRACT

A computer implemented method and system for managing an audit of one or more network layer devices is provided. An audit management system accessible by a user via a graphical user interface acquires network layer device information of the network layer devices and a configuration file comprising configuration file commands. The audit management system allows creation and/or selection of one or more audit policies for the network layer devices. The audit policies comprise one or more audit rules that define functioning of the network layer devices for one or more compliance policies. The audit management system executes the audit policies for performing the audit of the network layer devices by comparing the configuration file commands of the configuration file with the audit rules of the audit policies, and generates a report comprising information about security and compliance of the network layer devices with the compliance policies based on the audit.

### CROSS REFERENCE TO RELATED APPLICATIONS

This application claims the benefit of provisional patent application No. 61/406,590 titled “Audit Management System”, filed on Oct. 26, 2010 in the United States Patent and Trademark Office.

The specification of the above referenced patent application is incorporated herein by reference in its entirety.

### BACKGROUND

The computer implemented method and system disclosed herein, in general, relates to device auditing. More particularly, the computer implemented method and system disclosed herein relates to managing an audit of one or more network layer devices to analyze security and compliance of the network layer devices with one or more compliance policies.

It is well established that effective governance and auditing is crucial to management of an organization for regulating its working and operations, for example, for regulating the quality of products, the manufacturing processes, the financial operations, human resource management, etc. Organizations also need to ensure compliance with a vast number of policies for ensuring product quality, system security, etc. Organizations need to assess potential risks, for example, technological risks, commercial risks, information security risks, etc., and align internal policies of the organization to compliance standards required or suggested by regulating agencies. A number of diverse regulating agencies, protocols, etc., stipulate policies to ensure uniformity, standardization of product features, and efficient resource management. Therefore, there is a need for an automated system that can track regulatory policies, verify whether network layer devices of an organization are configured to meet the compliance standards, identify risks that may potentially impede realization of the organization's objectives, and ensure that the organization complies with the policies.

Auditing systems typically perform audits by parsing device configuration files and verifying the existence, format, and order of the instructions in the device configuration files. The configuration files define the device configuration, the functioning of the network layer devices, etc. Conventional auditing systems require manual effort from users for uploading configuration files, performing audit checks, etc. Moreover, most network layer devices configured to meet the requirements of multiple protocols to ensure forward and backward compatibility are associated with bulky configuration files that demand a considerable amount of effort from auditing systems for data acquisition and processing.

Conventional auditing systems offer limited flexibility in terms of allowing the user to upload, create, and modify rules required for auditing. Conventional auditing systems are often confined to accessing or retrieving a predefined configuration file associated with a network layer device, thereby limiting the possibility of using a user defined customized configuration file for auditing. Moreover, most conventional auditing systems operate according to a fixed schedule for information acquisition and performance of the audit. Furthermore, conventional auditing systems are often constrained by an inability to quickly adapt to changes in technologies of network layer devices, device interfaces, etc., and need to be constantly upgraded to ensure compatibility with newer technologies. Furthermore, there is a need for auditing systems that cover compliance policies of multiple compliance agencies and cater to a wide spectrum of devices and device vendors. Moreover, conventional auditing systems are often not user friendly, thereby requiring knowledge and training for utilizing these auditing systems, and also do not offer many options for selective auditing. With advances in technology domains such as security, communication, networking, etc., there is a constant need for ensuring compliance with an increasing number of protocols, thereby necessitating a faster, effective auditing system that can perform auditing across multiple technological domains.

Moreover, conventional auditing systems have often been limited to conservative methods of auditing, for example, sequential processing of configuration files, utilization of fixed auditing tools, etc. This has typically placed limitations on the efficiency of auditing, for example, when performing auditing of network layer devices in accordance with multiple compliance policies within a short span of time. Since network layer devices are required to comply with a number of compliance policies that are constantly upgraded to cover additional functionalities, there is a need for a speedier auditing system that can perform auditing for testing the compliance of the network layer devices with multiple compliance policies simultaneously.

Furthermore, information acquisition, for example, acquisition of device inventory information and acquisition of configuration files, is carried out by third party vendors and information gathering systems that require auditing systems to be well equipped to handle interoperable information gathering. Furthermore, there is a need for auditing systems to adapt flexibly for performing an audit with different software and hardware versions, different vendors, etc. For example, some network layer devices may have been designed in a way that allows them to only meet specific compliance policies. When there is a new set of compliance policies brought out by a regulating agency for a new functionality, the network layer devices of a particular vendor may not be equipped to match the new compliance policies, and may be need to be excluded from a particular audit. Furthermore, there is a need for auditing systems to be able to cope with different audit schedules, different compliance policies, etc.

Furthermore, conventional auditing systems often adopt fixed methods for generating audit reports and are not equipped to provide customized reports according to user-specified requirements, for example, according to a particular compliance policy, according to device parameters, etc. Therefore, the user is required to review a large number of reports with unnecessary detail, when the user may want to verify only a selected number of compliance policies, network layer devices, etc.

Hence, there is a long felt but unresolved need for a computer implemented method and system that manages an audit of one or more network layer devices and allows greater flexibility and speed in the auditing process. Moreover, there is a need for a computer implemented method and system that allows the user to customize the steps of the audit in terms of utilizing user-defined configuration files, performing the audit according to user-defined audit policies and schedules, generating customized reports, managing and reducing risks based on the compliance policies, etc. Furthermore, there is a need for a computer implemented method and system that can adapt the auditing process to cover multiple compliance policies, protocols, and network layer devices across multiple technological domains.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above mentioned needs for managing an audit of one or more network layer devices with greater flexibility and speed in the auditing process, allowing the user to customize the steps of the audit in terms of utilizing user-defined configuration files, performing the audit according to user-defined audit policies and schedules, generating customized reports, managing and reducing risks based on compliance policies, etc. As used herein, the term “network layer device” refers to a device, for example, a router, a switch, a firewall, etc., that operates in a network layer of an open systems interconnection (OSI) model of computer networking. The computer implemented method and system disclosed herein also addresses the above mentioned need for adapting the auditing process to cover multiple compliance policies, protocols, and network layer devices across multiple technological domains.

The computer implemented method and system disclosed herein provides an audit management system for managing an audit of one or more network layer devices. The audit management system is accessible by a user, for example, over a network via a graphical user interface (GUI). The audit management system acquires network layer device information of the network layer devices via the GUI. The network layer device information comprises, for example, a name, a description, a location, a category, etc., of each of the network layer devices. The audit management system acquires the network layer device information of the network layer devices, for example, by acquiring manual entries of the network layer device information from the user via the GUI, extracting the network layer device information based on a simple network management protocol (SNMP), performing an interoperable gathering of the network layer device information from third party entities associated with the audit management system, etc.

The audit management system acquires a configuration file comprising configuration file commands that define configuration of each of the network layer devices, via the GUI. The configuration file is a customizable specification that defines a desired running state of a network layer device. The audit management system acquires the configuration file of each of the network layer devices, for example, by acquiring manual entries of the configuration file from the user via the GUI, extracting the configuration file based on a simple network management protocol (SNMP), performing an interoperable gathering of the configuration file from third party entities associated with the audit management system, etc.

The audit management system allows creation and/or selection of one or more audit policies comprising one or more audit rules for the network layer devices. As used herein, the term “audit rule” refers to a reference instruction that defines a characteristic or a functionality that a network layer device needs to possess in order to ensure compliance with a compliance policy and enables a conditional audit of the network layer device. Also, as used herein, the term “audit policy” refers to a configurable template comprising a coupling or mapping of audit rules with the network layer devices in accordance with a compliance policy. Also, as used herein, the term “compliance policy” refers to one or more standards defined by a regulating agency, which govern the operation of network layer devices and aid in providing uniformity of interfacing between the network layer devices of different vendors. The audit rules define functioning of the network layer devices for one or more compliance policies. The audit policies define an association of the network layer devices with the audit rules. The audit rules of the audit policies comprise, for example, parent audit rules, child audit rules, a combination of parent audit rules and child audit rules, etc. The audit management system selects one or more parent audit rules and/or child audit rules for enabling a conditional audit of the network layer devices. The audit management system identifies one or more audit rules that apply commonly across the compliance policies to generate a list of unique audit rules for the audit policies during the creation of the audit policies.

In an embodiment, the audit management system creates one or more audit rules for the audit policies by identifying the scope details from the network layer device information associated with the network layer devices for selecting the network layer devices for the audit. As used herein, the term “scope details” refers to characteristic information of a network layer device, for example, the device type, series, model, code version, image name, etc. The scope details broadly determine the nature of network layer devices that are to be audited, and the scope of functionalities that need to be tested for compliance. The audit management system defines one or more audit commands that correspond to the configuration file commands of the configuration file. In an embodiment, the audit management system automatically selects audit commands that match the network layer device information and the configuration file commands of the configuration file for creating the audit rules for the audit policies. The audit management system creates one or more filter conditions for each of the audit commands. The created filter conditions specify criteria for finding a match between the configuration file commands of the configuration file and the audit rules during the execution of the audit policies. The filter conditions comprise, for example, a numerical range, an occurrence of a specific keyword, configuration values, etc. The audit commands with the created filter conditions create the audit rules for performing the audit of the selected network layer devices.

In an embodiment, the audit management system allows the user to define a rule action associated with one or more filter conditions of the audit rules, via the GUI. The audit management system performs the rule action when the filter conditions are met. In an embodiment, the audit management system selects one or more audit rules to be excluded during the execution of the audit policies via the GUI. In another embodiment, the audit management system selects one or more network layer devices to be excluded during the execution of the audit policies via the GUI.

In an embodiment, the audit management system groups one or more audit rules within each of the audit policies for optimizing the execution of the audit policies. The audit management system defines risk information for each of the selected network layer devices when a match between the configuration file commands of the configuration file and the audit rules is not found during the execution of the audit policies. In an embodiment, the audit management system schedules the acquisition of the network layer device information, the acquisition of the configuration file of each of the network layer devices, the creation of the audit policies, the execution of the audit policies, the generation of a report comprising information about security and compliance of the network layer devices with the compliance policies, and transmission of notifications on status of the audit based on input received from the user via the GUI.

Moreover, the audit management system monitors changes in network layer device information, the configuration files, the audit policies, etc., and triggers the acquisition of the network layer device information, the acquisition of the configuration file of each of the network layer devices, acquisition of input from the user for the creation of the audit policies and scheduling of the execution of the audit policies, etc., on detecting changes in the network layer device information, the configuration files, and the audit policies.

The audit management system executes the created and/or selected audit policies for performing the audit of the network layer devices. The audit management system compares the configuration file commands of the configuration file with the audit rules of the audit policies for verifying security and compliance of the network layer devices with one or more compliance policies during the execution of the audit policies.

In an embodiment, the audit management system performs a root cause analysis for determining cause of non-compliance of the network layer devices with the compliance policies on execution of the audit policies. The audit management system determines the non-compliance on identifying disparities between the configuration file commands of the configuration file with the audit rules of the audit policies, or on identifying absence of one or more of the configuration file commands in the configuration file. The audit management system collects risk information associated with the non-compliance. The risk information comprises, for example, a risk rating that defines the severity of the non-compliance. The audit management system also assigns a non-compliance score as a measure of the non-compliance. Moreover, the audit management system generates recommendations for remediating the non-compliance and presents the generated recommendations to the user via the GUI. The generated recommendations specify modes of adjusting, adding, and removing one or more of the audit rules from the audit policies.

The audit management system sets scope criteria based on the scope details acquired from the network layer device information for the audit of the network layer devices, identifies one or more network layer devices that fail to match the scope criteria set for the audit, and notifies the user on the identified network layer devices failing to match the scope criteria, during the performance of the root cause analysis. As used herein, the term “scope criteria” refers to a set of requirements that define the eligibility of a network layer device for a particular scheduled audit policy. The requirements comprise, for example, a hardware configuration version, a code version, forward and backward compatibility capabilities of the network layer device, etc. The audit management system monitors the scope details acquired from the network layer device information during the performance of the root cause analysis and notifies the user on determining that auditing security and compliance of the network layer devices with the compliance policies does not match with the scope details.

The audit management system generates a report comprising information about security and compliance of the network layer devices with the compliance policies based on the execution of the audit policies. The audit policy enables customization of the report by the audit management system based on the compliance policy. The audit management system highlights, prioritizes, and filters the information about the security and the compliance of the network layer devices with the compliance policies based on predetermined criteria. The predetermined criteria comprise, for example, ratings of impact assessment, the network layer device information, assignment of the network layer devices to the audit, exposure of the network layer devices to potential security intrusions, categories of the network layer devices, etc. As used herein, the term “security intrusions” refers to a broad category of activities related, for example, to cyber hacking, where sensitive information transferred via a network layer device is revealed, redirected, changed, or may cause an alteration in the state of the network layer device leading to disruption in the normal operation of the network layer device.

The audit management system selectively extracts results of the audit of the network layer devices based on ad-hoc queries received from the user via the GUI. As used herein, the term “ad-hoc query” refers to a query that specifies a set of logical conditions for extracting results from the last scheduled audit performed by the audit management system. The ad-hoc queries are, for example, associated with or based on one or more compliance policies and the network layer device information. The audit management system tracks the performance of the audit of the network layer devices over a predetermined period of time and presents risks associated with non-compliance of the network layer devices with the compliance policies, steps for remediation of the risks, and trends analyzed from the audit of the network layer devices to the user via the GUI.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing an audit of one or more network layer devices.

FIG. 2 exemplarily illustrates a flowchart comprising the steps for creating an audit rule for performing an audit of one or more network layer devices to verify security and compliance of the network layer devices with one or more compliance policies.

FIG. 3 exemplarily illustrates a flowchart comprising the steps for specification of an audit policy for performing an audit of one or more network layer devices.

FIGS. 4A-4B exemplarily illustrate a flowchart comprising the steps for analyzing and executing audit policies for verifying security and compliance of one or more network layer devices with one or more compliance policies.

FIG. 5 exemplarily illustrates a flowchart comprising the steps of a machine analysis performed during performance an audit of one or more network layer devices by an audit management system.

FIG. 6 exemplarily illustrates a flowchart comprising the steps for generating a report that records results of an audit performed on one or more network layer devices.

FIG. 7 illustrates a computer implemented system for managing an audit of one or more network layer devices.

FIG. 8 exemplarily illustrates the architecture of a computer system employed by the audit management system for managing an audit of one or more network layer devices.

FIGS. 9A-9C exemplarily illustrate a flowchart comprising the steps for managing an audit of one or more network layer devices.

FIGS. 10-64 exemplarily illustrate screenshots of interfaces provided by the audit management system via a graphical user interface for managing an audit of one or more network layer devices.

### DETAILED DESCRIPTION OF THE INVENTION

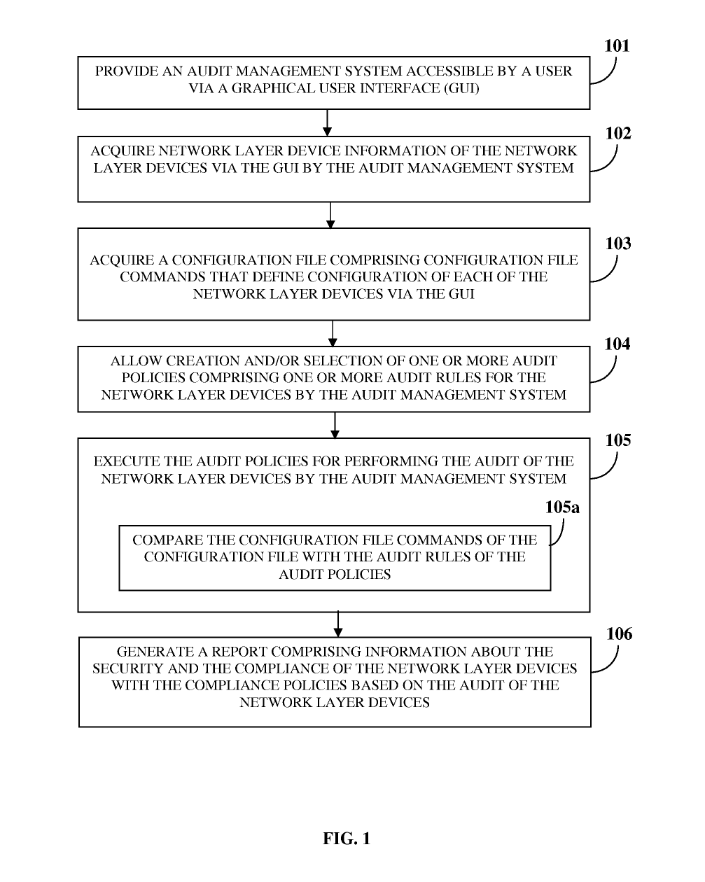

FIG. 1 illustrates a computer implemented method for managing an audit of one or more network layer devices. As used herein, the term “network layer device” refers to a device, for example, a router, a switch, a firewall, etc., that operates in a network layer of an open systems interconnection (OSI) model of computer networking. The computer implemented method disclosed herein provides 101 an audit management system accessible by a user via a graphical user interface (GUI). In an embodiment, the audit management system is hosted on a server and accessed remotely by the user via a network. The network is, for example, the internet, an intranet, a local area network, a wide area network, a communication network that implements Wi-Fi™ of the Wireless Ethernet Compatibility Alliance, Inc., a cellular network, a mobile communication network, etc. In another embodiment, the audit management system is implemented locally on the user's computing device.

The audit management system acquires 102 network layer device information of one or more network layer devices via the GUI. The network layer devices are, for example, routers, switches, hubs, gateways, firewalls, network interface cards, etc. The network layer device information comprises static content, for example, a name of each of the network layer devices, a description of each of the network layer devices, device characteristic information of the network layer devices, location of each of the network layer devices, a category of each of the network layer devices, etc. The audit management system provides, for example, a drop down menu on the GUI for enabling the user to select the locations of the network layer devices. This allows leveraging of audit schedules, when areas of an enterprise to which the network layer devices are applicable are under the management of organizations located in different countries and time zones. The information on the locations of the network layer devices comprises, for example, a name of the location, a street address, etc. The information on the category of each of the network layer devices comprises, for example, information on a data center, a branch, a department, etc., to which the network layer device is affiliated. The device characteristic information comprises, for example, information on a type of the network layer device such as a switch, a firewall, a router, etc., a series of network layer devices such as a family of network layer devices employing a common hardware component or a common software component, for example, a processor, a cabinet, etc., serial number identification information of each of the network layer devices, power supplies, one or more types of network ports, memory size, firmware code level internetwork operating system (IOS) software levels, etc. The network layer device information further comprises information on programs executing on the network layer devices, for example, a code version, name of a software image, device deployment duration, etc., component details such as vendor details, device type details, series, model, a central processing unit supervisor (CPU/SUP) processor type of the network layer device, code version details of the network layer devices, etc.

The audit management system acquires the network layer device information, for example, by acquiring manual entries of the network layer device information from the user via the GUI, extracting the network layer device information based on a simple network management protocol (SNMP), that is, SNMP based exploring, performing an interoperable gathering of the network layer device information from third party entities associated with the audit management system, etc. For example, the audit management system acquires the network layer device information from the user, for example, by providing dialog boxes on the GUI for allowing a manual entry of the network layer device information from the user. In another example, the audit management system provides a simple network management protocol (SNMP) based utility that employs an SNMP query mechanism for retrieving network layer device information of the network layer devices. The audit management system polls an SNMP agent running on a network layer device, for example, a router, for the network layer device information collected in a management information base (MIB) text file. The MIB comprises, for example, a compilation of statistics on processor usage, interface utilization, traffic congestion notifications, etc. In another example, the audit management system performs interoperable gathering of the network layer device information from third party entities associated with the audit management system. As used herein, the term “interoperable gathering” refers to a process of importing the network layer device information and configuration files associated with the network layer devices from systems and databases of third party entities. The third party entities are, for example, third party vendors and operators who provide information acquisition and inventory management services and utilities. The audit management system, for example, imports the network layer device information and configuration files from the third party entities over a network such as the internet.

In an embodiment, the audit management system enables a bulk upload of the network layer device information associated with each of the network layer devices. For example, the audit management system provides a bulk upload utility on the GUI for enabling a bulk upload of the network layer device information to the audit management system. The bulk upload utility saves the user's time required for manually entering the network layer device information for each network layer device separately, particularly when the network layer device information of a large number of network layer devices needs to be entered at the same time. In an example, the audit management system provides the user with a “device utility template” comprising columns for the user to enter the network layer device information. The user can fill the device utility template and specify the location where the device utility template is stored to the audit management system via the GUI. The audit management system imports the device utility template from the specified location and verifies the correctness of the information provided by the user.

The audit management system acquires 103 a configuration file comprising configuration file commands that define configuration of each of the network layer devices, via the GUI. The configuration file is a customizable specification that defines a desired running state of a network layer device. The configuration file is structured similar to a high-level macro programming language and is hierarchical in nature. The configuration file is used, for example, to specify interface settings such as a routing protocol setting, policies, passwords, etc. The audit management system acquires the configuration files of the network layer devices, for example, as “.txt” files, “.config” files, etc. The audit management system enables the user to upload a configuration file for auditing a network layer device. Further, the audit management system also acquires and stores information on the configuration file, for example, a configuration file version, a name of the configuration file, a date of upload of the configuration file, etc. The audit management system records each acquired configuration file for a specific network layer device with a new revision number. The audit management system allows the user to revert the configuration file to an older configuration version corresponding to a configuration file collected from the user at a prior point in time, based on the revision number. In an embodiment, the user can upload a user modified or a user defined configuration file to the audit management system.

In an embodiment, the audit management system enables a bulk upload of configuration files associated with each of the network layer devices. For example, the audit management system provides a bulk upload utility on the GUI for enabling a bulk upload of the configuration files of multiple network layer devices at the same time to the audit management system. The bulk upload utility saves the user's time required for manually uploading each configuration file of each network layer device separately.

The audit management system acquires the configuration file of each of the network layer devices, for example, by acquiring manual entries of the configuration file from the user via the GUI, extracting the configuration file based on a simple network management protocol (SNMP), performing an interoperable gathering of the configuration file from third party entities associated with the audit management system, etc. For example, the audit management system acquires the configuration files of the network layer devices by allowing a manual upload of the configuration files by the user through the GUI provided by the audit management system. In another example, the audit management system uses simple network management protocol (SNMP) based directives to query the configuration file and associated information of the network layer devices from SNMP agents running on the network layer devices. In another example, the audit management system performs interoperable information gathering by importing the configuration files from a third party entity associated with the audit management system.

In an embodiment, the audit management system tracks the timelines of the network layer device information and the configuration files, and limits the acquisition of the network layer device information and the configuration files to only changes in the network layer device information, the device configuration information, changes in user policies, etc.

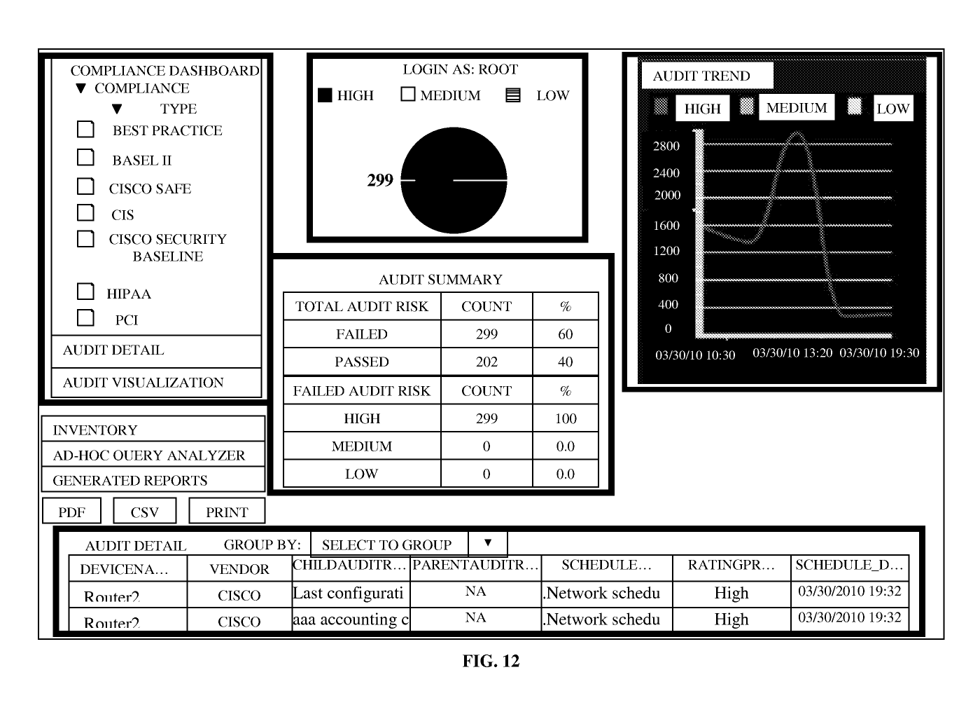

The audit management system provides a list of compliance policies that define mandatory compliance laws, industry best practices, governance frameworks, internal compliance names, etc., on the GUI. As used herein, the term “compliance policy” refers to one or more standards defined by a regulating agency, which govern the operation of network layer devices and aid in providing uniformity of interfacing between the network layer devices of different vendors. The compliance policies are, for example, the Cisco security baseline, Cisco SAFE, Cisco best practices, etc., defined by Cisco Systems®, Inc., the health insurance portability and accountability act (HIPAA), etc. The audit management system provides a compliance menu screen accessible via the GUI that allows the user to access the results of an audit according to the compliance policy and locate a root cause of non-compliance and a necessary remediation for a network layer device. The compliance menu screen presents information organized into an audit summary, audit visualization, audit trend lines, audit detail, etc., as exemplarily illustrated in FIG. 12.

The audit management system allows 104 creation and/or selection of one or more audit policies comprising one or more audit rules for the network layer devices. The audit policies define an association of the network layer devices with the audit rules. As used herein, the term “audit policy” refers to a configurable template comprising a coupling or mapping of audit rules with the network layer devices in accordance with a compliance policy. As used herein, the term “audit rule” refers to a reference instruction that defines a characteristic or a functionality that a network layer device needs to possess in order to ensure compliance with a compliance policy and enables a conditional audit of the network layer device. The audit rules define functioning of the network layer devices for one or more compliance policies. Therefore, a logical grouping of audit rules defines an audit policy. Each audit policy comprises at least one child audit rule and optionally, one or more parent audit rules. The audit policy associates multiple network layer devices in the user's network with multiple audit rules associated with the functioning of the network layer devices. The audit policy is constructed by selecting the audit rules created for different compliance policies from a list of audit rules associated with the network layer devices and the network layer devices to which the audit rules are applicable. Therefore, the audit policy is a named collection of compliance policies and network layer devices to which the compliance policies are applicable.

The audit rules refer to a set of specifications that define the configuration requirements for a network layer device to achieve compliance with a particular compliance policy. The audit rules can be security or compliance related audit rules. Each individual audit rule is associated with one or more entries, that is, configuration file commands in a configuration file of a network layer device. An audit rule can specify that a particular entry in the “running” configuration file is either optional or mandatory. Since the audit process can perform a check for multiple compliance policies in a single audit, it is possible that one or more audit rules are found to be common to two or more compliance policies. Therefore, the audit management system compiles a list of distinct audit rules for each network layer device in the audit. On completing the list, the audit management system queues the audit rule-network layer device pairs for processing.

In an embodiment, the audit management system creates one or more audit rules for the audit policies as follows: The audit management system identifies scope details from the network layer device information associated with the network layer devices for selecting the network layer devices for the audit. As used herein, the term “scope details” refers to characteristic information that identifies the details characterizing a network layer device. The scope details comprise, for example, vendor details such as a name of a vendor, the type of network layer device, the device series, the device model, the processor type, the code version, the image name, etc. In an example, the name of the vendor is Juniper Networks®, Inc., the type of the network layer device is a firewall, the device series is ISG5000, the model is ISG5050, the CPU/SUP is ISG5000, the code versions are 9.1, 9.2, and 9.3, and the image name is “Advanced for version 9.2”.

The audit management system defines audit commands that correspond to the configuration file commands of the configuration file. The audit commands are vendor specific commands that define a specific functionality or configuration of a network layer device. The audit management system collates the audit commands for each configuration file of each network layer device in an audit template. As used herein, the term “audit template” refers to a template comprising a list of audit commands that define the criteria for auditing a network layer device. The audit template defines the configuration needed for the functioning of a network layer device in compliance with one or more compliance policies. The audit management system organizes the configuration file into one or more audit sections and enables mapping of multiple audit commands to each of the audit sections of the configuration file. The audit sections cover, for example, the interfaces, protocols, policies such as forwarding, routing, screening, password settings, operating schedules, etc., supported by the network layer devices. Consider an example where the audit management system acquires the configuration file of a network layer device such as a router. The audit management system organizes the configuration file of the router into separate audit sections that allows a setting of audit checks for specific functionalities of the router.

The audit management system constructs audit commands for each audit section. In order to construct the audit command, the audit management system defines child types that specify a particular class of configuration file commands. The child types are the fundamental building blocks of the audit rules. That is, the child types define templates for the audit commands used to create the audit rules. The child types are, for example, vendor commands that broadly represent a family of audit commands mapped to the audit section and allow the selection of vendor specific audit commands. The audit commands are associated with the network layer device through the child type. For example, the audit management system provides an “all” child type which is a generic child type that can be used for all audit commands; an “auxiliary” child type that defines the allowed auxiliary port numbers; a “banner” child type that specifies messages to be displayed on a terminal when an EXEC process is created, for example, when an incoming connection is initiated from a network side of a router; a “class-map” child type that defines a traffic classification based on traffic flow information and protocols; a “console” child type that defines user interface configuration, etc.

The audit management system also provides an “interface” child type that defines types of interfaces that can be used by a network layer device, for example, gigabit Ethernet, fast Ethernet, loopback, tunnel, virtual interface, etc., the chassis, blade and interface detail, etc. Furthermore, the audit management system defines a “policy-map” child type that defines a series of functions to be performed on a set of classified inbound traffic; a “router” child type that specifies a router configuration; a “route-map” child type that define conditions for redistributing routes from one routing protocol into another; a “VLAN” child type that describes a layer 2 interface configuration, etc. The child types as applicable to the computer implemented method disclosed herein are further disclosed in the detailed description of FIG. 31. In an embodiment, the audit management system allows customization of the audit by the user by allowing the user to adjust, add or remove audit rules, audit policies, reports, etc.

The audit management system allows the user to create and/or select the audit commands from an audit database of audit commands associated with the audit management system, based on the selected child type. The audit management system provides a menu comprising the audit commands mapped to a particular child type to the user via the GUI. In an embodiment, the audit management system automatically selects audit commands that match the network layer device information and the configuration file commands of the configuration file for creation of the audit rules for the audit policies. For example, if a user is unsure of an exact vendor command for a particular child type, the audit management system performs a search in the audit database associated with the audit management system comprising audit commands, and based on the network layer device information and the child type, the audit management system automatically selects the audit commands that offer the nearest match to the network layer device information and the child type.

In an embodiment, the audit management system allows the user to create new audit commands that are referenced by the audit management system for creation of the audit rules. The audit management system allows the user to customize the audit commands to match the specifications of a particular vendor or a compliance policy. For example, when a vendor releases a new series of network layer devices, code images, device hardware, etc., the audit management system provides the user with the flexibility to enter audit commands that match the newer revisions via the GUI. The audit commands uploaded by the user are referenced by the audit management system for creation of the audit rules and for performing an audit of the network layer devices. The user may construct the audit command by first selecting scope details and defining the child type for enabling association with the audit command with a configuration file command of a configuration file. The scope details define the vendor and platform scope in order to add the new audit command. The child type is, for example, global, auxiliary, console, etc.

The audit management system provides the user with an option to enter a single audit command or carry out a bulk upload of the audit commands, which allows the user to customize the audit commands to accommodate the requirements of different vendors of the network layer devices. The audit management system provides a bulk upload utility that enables bulk upload of a number of audit commands at the same time. In an example, the user can create the audit commands in a text file, store the text file locally on a computing device connected to the audit management system via a network, and provide the file path for the text file to the audit management system. This allows the audit management system to access the text file from the computing device and transfer the audit commands to the audit database associated with the audit management system. The audit management system enables the user to create an audit command, for example, by providing a syntax and a format for a typical audit command via the GUI. Further, the audit management system provides the user with an option to delete one or more of the audit commands via the GUI.

For creation of the audit rules for the audit policies, the audit management system also creates one or more filter conditions for each of the audit commands. The created filter conditions specify criteria for finding a match between the configuration file commands of the configuration file and the audit rules during the execution of the audit policies. Therefore, the filter conditions define the constraints for the audit rule. For example, the filter conditions comprise a range and one or more configuration values. The audit commands with the created filter conditions create the audit rules for performing the audit of the selected network layer devices.

The first step in creating a conditional audit check is to define a “rule filter”. The rule filter represents the “IF” condition of the audit rule. The audit management system creates the rule filters for filtering the audit policies and customizing selection of the audit policies based on the user's input. Further, the audit management system allows creation of multiple rule filters for filtering the audit rules within an audit policy by the user. The filter conditions for the audit commands are created as part of defining the rule filter.

Each filter condition is completely defined by a “command option”, an “operator”, and a “value”. The command option lists keywords and configurable parameters, for example, strings, internet protocol addresses, etc., that define the audit command. The operator is used to set an evaluation condition, for example, “Equal to”, “Greater than or equal to”, “Lesser than or equal to”, etc. An “Exists” operator is used for example, to check if a keyword exists in the configuration file. The “Exists” operator checks the occurrence of the keyword as well as all related respective operators and associated conditions. An “If” operator is only available to a “global” child type and an “interface” child type and is used when there are dependent conditions. An “occurs” operator is used to specify the condition that the number of occurrences of a particular keyword in a configuration file command is equal to a predetermined value. An “occurslt” operator is used when the number of occurrences of a particular keyword is lesser than a predetermined value. An “occursgt” operator is used when the number of occurrences of a particular keyword is greater than a predetermined value. A “contains” operator is used when a condition specifies that a configuration file command needs to have a predetermined alphanumeric value. An “equal to” operator, a “not equal to” operator, a “greater than or equal to” operator, and a “lesser than or equal to” specify whether a number in a configuration file command needs to be equal to, not equal to, greater than or equal to, or lesser than equal to a predetermined numerical value specified in a “value field” respectively. A “use configuration value” operator is used when the user wants to use a configuration value from a configuration file.

The audit management system allows the user to employ address operators to set conditions for testing whether an address, for example, an internet protocol address specified in the configuration file is according to a predetermined value. For example, a “range” operator is used if the user wants to ensure that an address falls within a certain range, for example, 1.1.1.1 to 1.255.255.255. String operators are used if the user wants to specify conditions for a specific string. For example, a “length greater than or equal to” operator is used if a string needs to have a length greater than or equal to a mandated string length, a “length lesser than or equal to” operator is used if a string needs to have a length lesser than or equal to a specific value, such as in the case of password setting, etc.

The “value” field is used to specify a particular value mandated by a compliance policy. In an example, if there is no value specified in the audit command in the audit template, the audit management system allows a direct reuse of a numerical value provided in the configuration file command when defining the audit command in the audit template. In another example, the audit management system allows a child audit rule to use a numerical value provided by a parent audit rule to which the child audit rule is mapped.

In an embodiment, the audit management system allows the user to define a rule action associated with the filter conditions of each of the audit rules via the GUI. The audit management system performs the rule action when the filter conditions of an audit rule are met. Therefore, the rule action defines an action to be performed based on a result of execution of the filter conditions defined for an audit command for the audit of the network layer devices. For example, if the filter condition is considered as the “IF clause” of the audit, the rule action defines the “THEN ELSE” clause of the audit. The rule action may, for example, invoke another child audit rule or a parent audit rule when a filter condition passes.

The rule action can be used as a “cross-reference condition” that augments the filter condition and allows greater flexibility of performing the audit of the network layer devices. The rule action provides cross referencing of audit checks that allows the user to first pull an actual value from the configuration file, and then apply the extracted value to another audit command. The rule action is tagged to the same child types, options, operators, and values specified when constructing the rule filter. This allows the user to utilize the “value” field across multiple child types. In an example, the rule action is created as follows: Consider that the audit command “ip access-group 99 in” is mapped to the “interface” child type of the configuration file. The user wants to ensure that the audit command “access-list 99 permit ip any any” is configured and the user wants to match the number 99. In this example, the rule action may be configured to utilize the configured value 99 by defining the audit command as “ip access-list [number] in” and for the “number” option in the audit command, using the configured value 99 picked from the filter conditions defined by the rule filter.

In an embodiment, the audit management system automatically updates the audit commands in the audit template on determining a modification in the scope details identified from the network layer device information associated with the network layer devices. The audit management system enables customization of the configuration file commands of the configuration file and updates an audit template comprising audit commands corresponding to the configuration file commands of each configuration file of each network layer device, when scope details from the acquired network layer device information associated with the network layer devices are modified.

The audit management system defines risk information for each of the selected network layer devices when a match between the configuration file commands of the configuration file and the audit rules is not found during the execution of the audit policies. The risk information comprises, for example, a risk description, a risk rating, a weighting score, recommendation information, etc. The risk description is a statement of a risk faced due to non-compliance of the network layer devices with the compliance policies. The risk rating allows the user to define the information technology infrastructure library (ITIL) rating, urgency of remediation, impact of the risk that determines a priority that needs to be accorded towards remediation of the non-compliance, etc. The audit management system allows the user to associate the child type and a rating value, for example, between 0 and 10 with the risk rating to measure the extent of the risk, that is, if the audit rule fails. The weighting score is another measure of the risk that provides an average numerical score to the audit rule.

The recommendation information defines a recommendation to remediate the non-compliance, the child type encompassing the recommendation, the audit command that should be used should the audit check fail, a command reference comprising the audit commands that could be accessed for constructing the remediation, and the web reference that redirects the user to an online web reference.

The audit rules of the audit policy comprise, for example, parent audit rules, child audit rules, or a combination of parent audit rules and child audit rules. The audit management system selects one or more parent audit rules, child audit rules, or a combination of parent audit rules and child audit rules for enabling a conditional audit of the network layer devices. As used herein, the term “conditional audit” refers to auditing performed on a network layer device to determine validity of configuration for a specific independent functionality of the network layer device based on certain conditions. The conditions are, for example, a keyword, a configuration range, a configuration value, etc. A conditional audit helps avoid an auditing of the entire configuration file of the network layer device when there is a change in the compliance policy applicable to only a single functionality.

As used herein, the term “child audit rules” refers to a set of fundamental audit checks that can be applied to the network layer devices. Therefore, each child audit rule is an individual, isolated audit check that requires no dependency with other audit rules during the audit. The child audit rule is also the lowest level single conditional check, albeit the child audit rule can have multiple filter conditions. The filter conditions are logical constructs that match the scope criteria to the network layer device being tested for compliance. Further, the filter conditions match an audit rule to a particular configuration file command line in the configuration file of a network layer device. For example, a filter condition may specify a specific string of characters such as a string of blank spaces followed by at least one blank space, a combination of strings, numerals, and other specific alpha-numeric content. Therefore, each child audit rule defines a “filter” to determine if the audit rule matches a line entered in the configuration file of a network layer device being audited.

The child audit rules can be created, removed, copied, edited, and customized depending, for example, on the vendor details, and can be accessed by the parent audit rules. However, a child audit rule cannot refer to or be referenced by other child audit rules. The child audit rule allows the user to create a conditional audit check based on a single vendor command, and depending on whether the vendor command exists or does not exist in the configuration file, the audit management system notifies the user of the compliance of the network layer device with the compliance policy specified by the user. The child audit rule can be referenced by a parent audit rule or an audit group.

Consider an example for creation of a child audit rule. The user creates an audit rule for service password encryption. The user selects the scope details by selecting switches with a code version greater than 10.0. The user defines the child type as “global” and selects the audit command “service password-encryption” based on the child type. The user sets the filter condition as “exists” for the keyword “service password-encryption” indicating that the only condition for the child audit rule to pass is the presence of the keyword specified.

The term “parent audit rules” refers to a set of audit checks that allows auditing of the network layer devices based on multiple conditions. The parent audit rule is a declarative for compounding, for example, at least two child audit rules specifying at least two conditions for determining if the child audit rules apply to an entry of a configuration file command in the currently executing configuration file. Therefore, a parent audit rule is a bundle of child audit rules comprising at least two child audit rules that must be applied together at the same time to ensure a meaningful context to the audit rule test. The parent audit rules can reference other child audit rules and other parent audit rules. Consider an example where a parent audit rule validates that a 128-bit encryption is carried out on a virtual private network (VPN) by a network layer device, for example, a router. The parent audit rule uses a first child audit rule to verify that the router is configured to operate on a wide area network (WAN) that is within a particular address range. Further, the parent audit rule uses a second child audit rule to verify whether internet protocol (IP) forwarding is off since the router may also serve a local area network (LAN) within the same address range.

In another example, consider a parent audit rule that tests the security configuration of a network layer device during service login to a particular service. Suppose the network layer device accesses the service over an external network such as the internet, and in accordance with a compliance policy is required to employ a high encryption security level. Consider a child audit rule “A” that tests a configuration file command “X” in the configuration file of the network layer device. The configuration file command X specifies the parameters for a service login by the network layer device to a particular service. Further, a child audit rule “B” tests if the network layer device is connected to the internet. In this example, the parent audit rule references the child audit rule B to perform a test to check if a network interface of the network layer device is connected to the internet. If the child audit rule B returns “true”, that is the child audit rule B passes, the parent audit rule references the child audit rule A to determine whether the configuration file command X for service login has specified a high encryption security level. Therefore, the parent audit rule cascades multiple child audit rules to cover a plurality of adapters. Consequently, each parent audit rule maintains a testing context comprising at least two child audit rules. As a corollary, a conditional trigger for a child audit rule comprises an extraction of rule pass or fail results of other child audit rules, made possible by the coordinating parent audit rule. The parent audit rules can in turn be referenced by other parent audit rules and rule groups. The parent audit rule allows the user to create “conditional” audit checks or “conditional” child audit rules and provides the ability to call other parent audit rules, child audit rules or customized audit commands. The parent audit rule combines the outcomes of multiple child audit rules to provide a more complex audit check.

The audit management system allows a mapping of the child audit rules to the parent audit rules. For example, the audit management system allows a user to reference a child audit rule through a parent audit rule, for example, via a “Call Child Audit Rule Only” option provided on the GUI. The audit management system executes the referenced child audit rule and depending on whether the child audit rule passed or failed, the audit management system evaluates a specified rule action. The audit management system allows the user to reference another parent audit rule through the parent audit rule, for example, via a “Call Parent Audit Rule” option provided on the GUI, and depending on whether the invoked parent audit rule passes or fails, evaluates a specified rule action.

In an embodiment, the audit management system groups one or more audit rules within each of the audit policies for optimizing the execution of the audit policies. For example, grouping audit rules that can be referenced within an audit policy saves time when a user repeatedly uses the same audit rules. The audit management system creates one or more “rule groups” by grouping single or multiple child audit rules or parent audit rules for expediting selection of the group of the audit rules within the audit policies. In an embodiment, the audit management system allows the user to select only a set of child audit rules or a set of parent audit rules to form a rule group. If the user attempts to select both child audit rules and parent audit rules within the same rule group, the audit management system notifies the user through an error message. The audit management system collates one or more rule groups to form an audit group. The audit management system creates an audit group across multiple vendors, platform, code versions image name, etc. The audit groups can be referenced easily within an audit policy by the user, rather than invoking individual audit rules.

Consider an example where a configuration file has been organized into an audit section to verify network layer device management through the use of a simple network management protocol (SNMP). The audit management system allows the creation of multiple audit rules that can audit various areas of the configuration information acquired through the SNMP protocol. The audit management system provides the user with an option to refer to the individual audit rules within an audit policy or logically categorize the audit rules and refer to a single rule group. The audit management system prompts the user to select the scope details, for example, vendor details, type of device, device series, device model, etc., for obtaining a list of network layer devices from different vendors to which the rule group is available. The audit management system enables the user to select a child type of the configuration file of the network layer device on the basis of which the child audit rules or the parent audit rules were created. For example, if a child audit rule was created with the “global” child type, the audit management system selects all the “global” child audit rules. The audit management system collects all the child audit rules and parent audit rules mapped to the child type, and displays the audit rules to the user via the GUI, allowing the user to select the audit rules. The audit management system allows the user to select a single or multiple child audit rules from all the child audit rules displayed for the specific child type, and creates a child audit rule group, or allows the user to select a single or multiple parent audit rules from all the parent audit rules corresponding to the child type for creating a parent audit rule group. The audit management system allows the user to select only child audit rules, or only parent audit rules for creating an audit group.

The audit management system further allows the user to modify an existing rule group, for example, by adding or removing audit rules from a rule group, by modifying the filter conditions of the audit rules, etc. Furthermore, the audit management system tracks the history of the modifications and provides an audit trail, for example, the date of modification, an identity of the user modifying the audit rule, the modifications in the configuration values, etc.

The audit management system enables the creation of an audit group comprising multiple rule groups for a particular audit policy. The audit management system enables the auditing of network layer devices associated with multiple vendors and multiple device types together, by allowing the user to broaden the scope details, for example, through including older and newer code versions, etc. The audit management system allows the user to select parent audit rule groups and/or child audit rule groups for a specific audit section and collates the rule groups to create the audit group. The audit management system further allows editing, removal, etc., of individual audit groups. Moreover, the audit management system creates a set of default audit groups based on standard child types associated with the configuration of a network layer device that can be used directly by a user. Furthermore, the audit management system allows the user to select different audit rules for different network layer devices within an audit policy.

The audit management system identifies one or more audit rules that apply commonly across the compliance policies to generate a list of unique audit rules for the audit policies. The audit management system maps the audit rules created for testing a compliance policy with the network layer devices to which the audit rules are applicable. For example, the audit management system employs a database management system to create multiple tables, with each table representing a list of audit rules for a particular compliance policy, tagged to a network layer device. The audit management system stores the tables in the audit database associated with the database management system. The audit management system queries the audit database to obtain all the audit rules applicable to the network layer device and searches for audit rules common to more than one compliance policy. For example, parent audit rules and child audit rules for administrative password setting may be associated with multiple compliance policies. The audit management system filters out the redundant audit rules and prepares a final list of distinct and independent parent audit rules and child audit rules to ensure that a particular audit rule is invoked only once for a network layer device when the audit policy is executed for the network layer device. This enables optimization of execution of the audit policies and eliminates repetition of the audit.

Furthermore, the audit management system allows the user to define the ambit of the audit policy by providing filters for selecting the scope details, relevant network layer devices, child audit rules, parent audit rules, rule groups, etc. The audit management system provides additional filters for allowing the user to refine the list of network layer devices applicable to the audit policy, for example, on the basis of the location, category, vendor, etc., of the network layer devices. The audit management system allows the user to select different audit rules for different network layer devices within the same audit policy. The audit management system provides search boxes on the GUI that allow the user to search for a set of child audit rules, parent audit rules, rule groups, etc., based on a specific criteria, such as authentication and accounting management. Furthermore, the audit management system provides filters to allow the user to filter the audit rules according to a compliance policy, for example, Cisco security baseline. The audit management system allows the user to edit an audit policy, delete an audit policy, etc.

In an embodiment, the audit management system allows the user to select one or more audit rules to be excluded during the execution of the audit policies comprising the audit rules, via the GUI. For example, a user may set an exception for blocking the execution of a set of audit rules during an audit scheduled for a particular date and time, or to skip a particular audit in the event of a recurring audit schedule. In another embodiment, the audit management system allows the user to select one or more network layer devices to be excluded during the execution of the audit policies via the GUI. The audit management system provides an extra level of control to the auditing process.

The audit management system also presents a history of modifications made to different audit rules over a period of time to the user via the GUI. The audit management system provides an audit trail by allowing the user to have visibility on the users who modified an audit rule, the date of modification, the fields of the audit rule that were modified, the preceding value of a particular field of the audit rule, the current value of the field, etc.

In an embodiment, the audit management system controls the acquisition of the network layer device information, the acquisition of the configuration file, acquisition of input from the user for the creation of the audit policies and scheduling of the execution of the audit policies based on changes made to the network layer device information, the configuration file, and the audit policies. For example, the audit management system monitors changes in the network layer device information, the configuration file, and the audit policies. The audit management system triggers acquisition of the network layer device information, acquisition of the configuration file, acquisition of input from the user for the creation of the audit policies and scheduling of execution of the audit policies on detecting changes in the network layer device information, the configuration file, and the audit policies.

The audit management system schedules the execution of the audit policies based on input received from the user via the GUI. That is, the audit management system defines the actual date and time at which an audit policy is to be executed on the configuration files of the network layer devices. The schedule refers to the actual run of the audit process. The output of the scheduled audit is a report generated by the audit management system. Each schedule of an audit comprises execution of at least one audit policy, and encompasses a dichotomy of audit checks in a single operation. The audit management system, for example, allows the user to specify a specific schedule start date and end date and time, a recurring schedule with a predetermined period of recurrence such as a weekly audit, a daily audit, an annual audit, etc., an immediate scheduling of the audit, etc. Therefore, the audit management system allows the process of auditing to be triggered through manual invocation by a user, through a scheduled start, through an event driven scheduling, etc. The audit management system allows the user to add a new schedule, edit an existing schedule, remove an existing schedule, etc., via the GUI. The audit management system associates an audit policy with an audit schedule.

Further, the audit management system periodically notifies different stages of the schedule and provides status updates to the user via the GUI. For example, once the audit schedule has been created, the audit management system assigns a “schedule status” to the audit and notifies if the audit is in progress, if the audit has been completed, the results of the audit over the last seventy two hours, etc., on the GUI. The audit management system highlights different stages of the schedule status in different colors. The audit management system refreshes the schedule status at predetermined time intervals to track when the schedule has been completed. Furthermore, the audit management system allows the user to stop a scheduled audit in case the wrong schedule began for an audit. The audit management system presents a warning message to the user via the GUI if the user tries to schedule another audit when an audit is already running. The audit management system transmits notifications on the status of the audit to the user via the GUI.

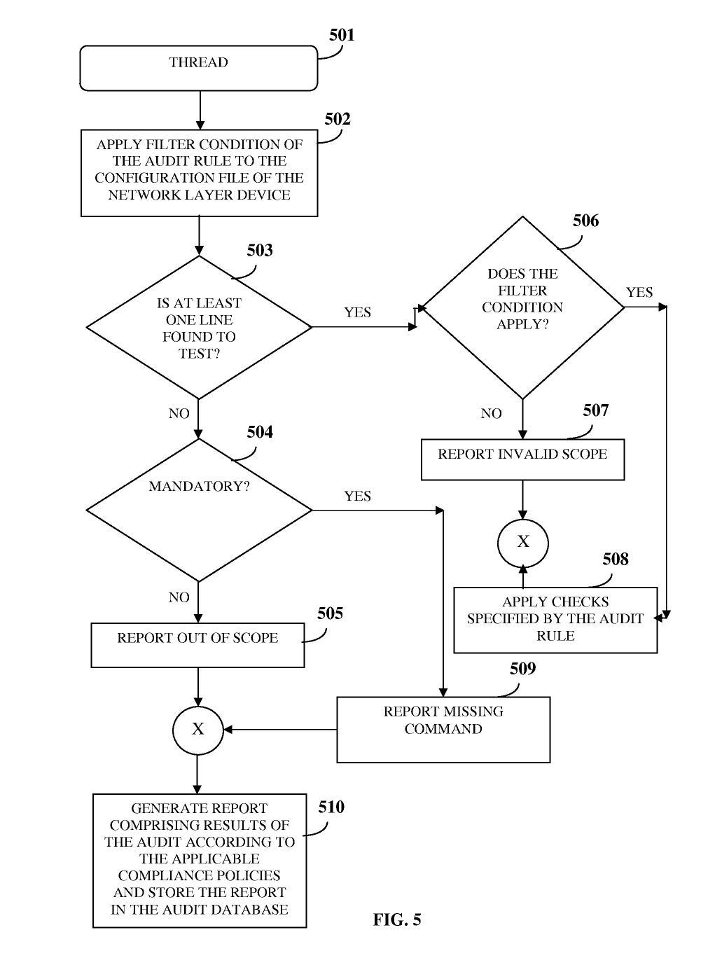

The audit management system executes 105 the audit policies for performing the audit of the network layer devices. The audit management system compares 105a the configuration file commands of the configuration file with the audit rules of the audit policies for verifying security and compliance of the network layer devices with the compliance policies during the execution of the audit policies. In an example, the audit management system creates threads for performing the comparison between the configuration file and the audit rules as disclosed in the detailed description of FIG. 5. A thread accesses the “running” configuration file, stored in the audit management system, and performs a line by line examination to obtain a match of the configuration file command to the audit rule. In an example, the audit management system extracts text strings from the configuration file commands, identifies keywords, and compares the keywords with the keywords used in the audit rules of the audit policy in the audit template. The text string comprise, for example, alphanumeric characters such as letters, special characters, etc. The audit management system checks for the existence of a keyword, a specific number of occurrences of the keyword in the configuration file commands, the exact characters in the keyword, the length of the keyword, etc., during the execution of the audit policies.

Furthermore, the audit management system checks for command parameters allowed under a specific compliance policy, for example, the allowed range of configuration values, internet protocol (IP) addresses, etc. For example, the audit management system compares a range of configuration values such as a predetermined numerical range specified by the configuration file commands for defining a specific protocol with the audit command associated with the audit rule in the audit template and records if there is a match between the configuration file and the audit rule. The audit management system also performs a check for an exact numerical value and verifies whether the numerical value provided by the configuration file command is greater, lesser, equal to, or not equal to the numerical value tagged to the audit command of the audit rule.

The audit management system performs a root cause analysis for determining cause of non-compliance of the network layer devices with the compliance policies on execution of the audit policies. The audit management system determines the non-compliance on identifying disparities between the configuration file commands of the configuration file with the audit rules of the audit policies, or on identifying absence of one or more of the configuration file commands required to ensure compliance with the compliance policy, in the configuration file. For example, the audit management system identifies all network layer devices that fail a compliance policy, due to at least one entry line, that is, a configuration file command in the configuration file failing to match at least one audit rule in the audit policy. In another example, the audit management system identifies the network layer devices that fail a particular compliance policy by failing to include at least one mandatory entry line, that is, a configuration file command in the configuration file of the network layer device. The audit management system records that the network layer devices are non-compliant if the mandatory entry line was missed in the configuration file of the network layer device.

The audit management system collects risk information associated with the non-compliance as part of presenting the findings of the root cause analysis to the user. The risk information comprises, for example, a risk rating that defines the severity of the non compliance. The audit management system identifies risks and provides recommendations for ensuring the security and compliance of the network layer devices with the compliance policies. The analysis of the root cause for failure of the configuration of the network layer devices comprises identifying non-compliance of the network layer devices and the configuration files of the network layer devices with the compliance policies, assigning a risk rating to define the severity of the non-compliance, and assigning a risk category, a risk definition, and a recommendation for remediation of the non-compliance of the network layer devices with the compliance policies. Furthermore, the audit management system assigns a non-compliance score as a measure of the non-compliance. The scoring for a non-compliance discovery is based on a rating of importance of the non-compliance. The non-compliance score is, for example, from a recommended “cautionary” non-compliance score up to an imperative “high alarm” non-compliance score, on a scale of the severity between 1 and 10. A score of 10, for example, indicates that the network layer device is in direct conflict with a compliance policy which in turn indicates that the network layer device is not secure from violations that include intentional violation of trusted content, cyber attacks, capture of confidential data, etc. The non-compliance score is, for example, a rating and weighting score. The audit management system displays the findings of the scheduled audit in the order of appearance of the configuration file commands in the configuration file of the network layer device.

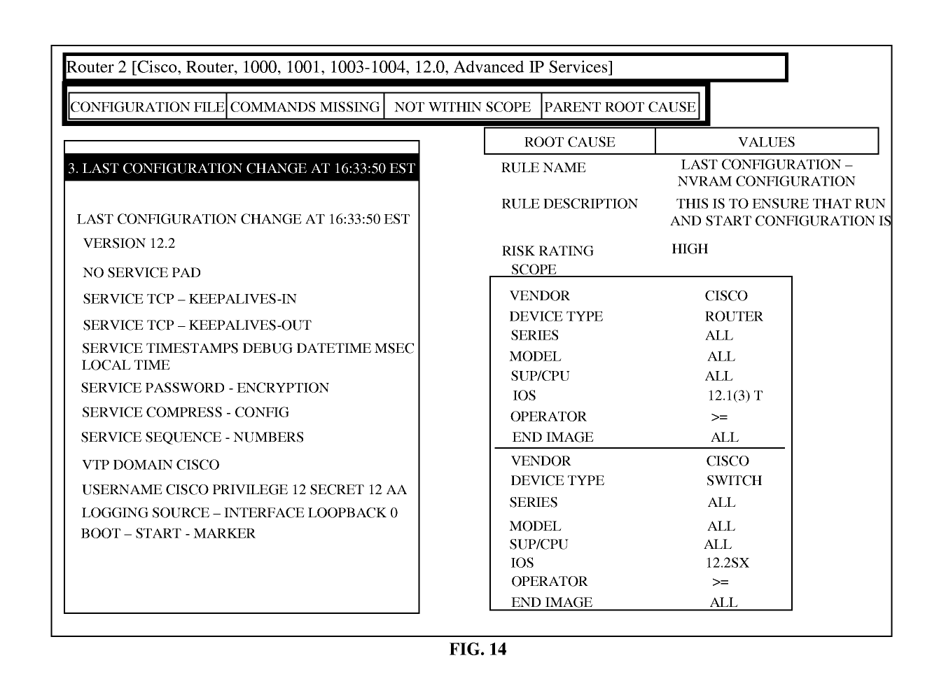

The GUI used by the audit management system for the presentation of the root cause analysis is exemplarily illustrated in FIG. 14. The audit management system provides a non-compliance score for auditing based on the compliance policy. For example, a rating and weighting of 10 means the audit check represents a high non-compliance rating and a low rating and weighting represents a hundred percent compliance.

The risk definition provides a formal description of the audit finding for a specific compliance policy. The risk definition describes the compliance policy violated by the network layer devices of a particular vendor. For example, if a configuration file command fails the schema for object oriented extensible markup language (SOX) compliance, the risk definition indicates the SOX compliance reference number and the finding details such as an inadequacy in the security and disaster recovery infrastructure. The risk rating assigns different levels of severity to the risk information, for example, “High”, “Medium”, “Low”, etc.

The audit management system generates recommendations for remediating the non-compliance, and presents the generated recommendations to the user via the GUI. The audit management system defines risk recommendations to remediate a non-compliant configuration file command. For example, if a configuration file command fails under peripheral component interconnect (PCI) compliance, the audit management system indicates the PCI compliance recommendation. Furthermore, the audit management system provides a uniform resource locator (URL) link to the vendor baseline compliance or security baseline in the risk recommendation, that specifies the standard compliance policies defined by an organization internally or by regulating agencies. Consider for example a risk recommendation generated for a compliance policy associated with a network layer device such as a router. If the user clicks on the URL, the audit management system redirects the user to an online link for Cisco network security baseline. Furthermore, the audit management system provides a reference list of configuration file commands that need to be incorporated in the configuration file for remediation.

The generated recommendations specify modes of adjusting, adding, and removing one or more of the audit rules from the audit policies. The modes are, for example, providing a command line interface for uploading the audit rules, etc. The audit management system provides a command line interface that allows command line replacement, command line elimination, command line inclusion, etc., that allows the user to incorporate the recommendations provided by the audit management system via the command line interface. Furthermore, the audit management system provides an explanation for the remediation, for example, in an audit policy description, an audit rule description, etc. The audit management system provides a web link to an external authority for governance, standards, best practices, etc. The recommendation information comprises, for example, an impact of the remediation, international and governmental compliances, industry standards, mandated enterprise regulations, etc.

The audit management system sets scope criteria based on scope details acquired from the network layer device information for the audit of the network layer devices, identifies one or more of the network layer devices that fail to match the scope criteria, for example, for utilizing obsolete hardware, firmware in whole or in part, etc., set for the audit, and notifies the user on the identified network layer devices failing to match the scope criteria during the performance of the root cause analysis by the audit management system. As used herein, the term “scope criteria” refers to a set of requirements that define the eligibility of a network layer device for a particular scheduled audit policy. The scope criteria comprise, for example, the hardware configuration version, the code version, the forward and backward compatibility capabilities, etc. The scope criteria further comprise, for example, characteristics of the network layer device such as the model of the equipment, the manufacturer of the equipment, version of the operating software, version of the hardware, etc. In an example, the scope criteria specifies the model of the equipment as “5400XL-EN”, the manufacturer of the equipment as “Cisco”, the version of the operating software as “12.0+” indicating that all software versions greater than or equal to 12.0 are included in the audit, and the version of the hardware as 4.57+ indicating that all hardware versions greater than or equal to 4.57 are included in the audit. The audit management system identifies the network layer devices that are no longer supported by a vendor. The audit management system excludes those network layer devices from the audit, and may tag the reason for exclusion of the network layer devices as “end of support”, “end of life”, “obsolete”, “not recommended”, etc. The audit management system guards against “false positives”, that is, the audit management system ensures that network layer devices that do not fit the scope of the audit are not labeled as non-compliant.

In an embodiment, the audit management system selectively extracts results of the audit of the network layer devices based on ad-hoc queries associated with the compliance policies and the network layer device information, received from the user via the GUI. As used herein, the term “ad-hoc query” refers to a query that specifies a set of logical conditions for extracting results from the last scheduled audit performed by the audit management system. Therefore, the ad-hoc query is a user customized query used for adjusting the screening of the results of the audit. The ad-hoc queries are, for example, based on compliance policies and network layer device information. The ad-hoc query enables a conditional audit of an audit section in a configuration file of a network layer device. Furthermore, the ad-hoc query allows a quick check of audit results for a specific audit section in a configuration file. The audit management system enables the construction of the ad-hoc query by the user based on query criteria, for example, a specific compliance policy such as a defense information systems agency (DISA) compliance, network layer device information such as the vendor details, the type of network layer device, the processor type, code version, image name, etc. In an example, the audit management system allows the user to compile an ad-hoc query for obtaining a list of network layer devices that have successfully passed an audit and which have been categorized under a particular compliance policy, a set of child audit rules, parent audit rules, audit groups, a location where the network layer devices reside, the category or department to which the network layer device belongs, etc.

The audit management system allows the user to provide “simple” and “complex” ad-hoc queries via the GUI. A simple ad-hoc query is, for example, a one-line query that uses a single query criterion. A complex ad-hoc query uses multiple query criteria in a single query. In an example, the user defines the query criteria as “DISA” and specifies that the ad-hoc query is based on a compliance policy. The audit management system performs an analysis of the ad-hoc query and returns a list of network layer devices compliant with DISA, the vendors of the network layer devices, the individual child audit rules and parent audit rules defining the different aspects of the compliance policies, risk categories, rating priorities, etc. The audit management system allows grouping and organization of the output information based on the names of the network layer devices, the vendors, etc. In another example, the user submits an ad-hoc query with the query criteria “Cisco 2960 Series switches”. The audit management system analyzes the ad-hoc query and returns a list of Cisco 2960 Series switches, the complete list of associated child audit rules and parent audit rules, the compliance policies followed by the network layer devices, etc.

The audit management system allows the user to execute a customized ad-hoc query with multiple audit conditions using logical operators such as AND, OR, NOT, etc., based on the last scheduled audit, and analyzes the ad-hoc query. For example, the user may define a query with multiple conditions such as a list of all Cisco devices that have failed the schema for object oriented extensible markup language (SOX) compliance, with the audit checks categorized under network management, and that have not failed the diagnostic bootup level complete audit command. The user uses the AND operator to specify that all the conditions need to be satisfied. The audit management system classifies the compliance policy as “SOX”, the audit condition as “failed”, the audit category as “network management”, the audit command as “diagnostic bootup level complete”, and the vendor as “Cisco”.

The audit management system generates 106 a report comprising information about the security and compliance of the network layer devices with the compliance policies based on the execution of the audit policies. The audit management system allows filtering of the security and compliance information based on the network layer device information in the report. The report, for example, provides a high level overview indicating the total number of passed and failed audit rules, a summary of high risk vulnerabilities, individual failed audit rules for a specific compliance policy, etc. The audit management system generates the reports in the form of GUI screen visuals, portable document format (PDF) files, parsable computer files, query capable databases, etc. A query capable database, for example, retrieves the results of the audit that match the queries submitted by the user via the GUI and presents the retrieved results of the audit to the user via the GUI.

In an embodiment, the audit management system enables customization of the generated report. The generated report is organized, for example, according to a compliancy policy. However, the audit management system allows the user to customize the generated report according to the user's environment. The customization of the report is, for example, based on different file formats, for example, PDF of Adobe Systems®, Inc., a comma-separated values (CSV) file format, etc., designs, etc. Further, the audit management system provides different alternatives for the format of the report. For example, the user can choose to be presented with only a report on the GUI, or to be provided with a PDF report. The audit management system transmits a notification message, for example, through an electronic mail (email) to the email address provided by the user specifying that the report is available for display on the GUI. The audit management system allows the user to add a personalized corporate logo to the generated report. The audit management system generates a printed copy of the generated report for the user. In an example, the audit management system notifies the user of the report via an email, that is, through email updates.

Furthermore, the audit management system allows the user to customize the generated reports as a means to prioritize the user's review of non-compliance issues in accordance with standard practices in infrastructure maintenance in an organization. The generated reports can be tailored to issue independent listings of specific details to personnel responsible for various strata in infrastructure and administration. The listings are, for example, selection of equipment, interconnection, settings, assignment, etc.

The audit management system highlights, prioritizes, and filters the information about the security and compliance of the network layer devices with the compliance policies based on predetermined criteria, during generation of the report. The predetermined criteria are criteria specified according to the types of compliance policies, for example, risk related compliance policies, compliance policies based on best practices, compliance policies specifying the rules of governance according to legal requirements, etc. Therefore, the predetermined criteria comprise the content of the rules mandated by a compliance policy. The predetermined criteria that determine the filtering of the generated report specify the ratings of impact assessment, that is, the ramifications of non-compliance, the network layer device information, the assignment of the network layer devices to the audit, exposure of the network layer devices to potential security intrusions and vulnerabilities, categories of network layer devices, for example, a series or a model of a particular network layer device, etc. As used herein, the term “security intrusions” refers to a broad category of activities related, for example, to cyber hacking, where sensitive information transferred via a network layer device is revealed, redirected, changed, or may cause an alteration in the state of the network layer device leading to disruption in the normal operation of the network layer device. The impact assessment refers to the notion of “high”, “medium”, and “low” as applied to the risk, compliance to best practices, and governance. For example, a high variance from a mandated specification of a health insurance portability and accountability act (HIPAA) compliance policy may violate certain laws as well as impact an organization's insurability.

In an embodiment, the audit management system schedules the acquisition of the network layer device information, the acquisition of the configuration file of each of the network layer devices, the creation of the audit policies, the execution of the audit policies, the generation of the report comprising information about security and compliance of the network layer devices with the compliance policies, and the transmission of notifications on status of the audit based on input received from the user via the GUI. Therefore, the audit management system allows an end to end user specified schedule for the audit.

The audit management system provides a utility for automating the steps of audit management as per the user specified schedule. This utility is configured to access the network layer device information of the network layer devices from a predetermined file location, for example, a local directory or a mapped directory, upload new configuration files, and execute the audit policies at scheduled points in time specified by the user. For example, the audit management system allows the user to specify if the audit needs to be performed immediately, or with a specified recurrence period such as an hourly audit, a weekly audit, etc., or on a specified date and time. Furthermore, the audit management system acquires the location of the network layer device information and the configuration files, for example, the path of the directory where the files are stored. In another example, the user can specify the address of a remote server where the network layer device information and the configuration files are stored. The specification may, for example, be in terms of an internet protocol (IP) address, a user name, a password, and a folder name of a folder associated with the remote server where the files are stored. Further, the user may specify the date, time and frequency at which the user needs the reports of the audit. The audit management system performs the audit based on the time at which the audit is scheduled. The utility applies, for example, a simple file transfer protocol (SFTP) to copy the configuration files and network layer device information files from the specified folder in the remote server, to the audit database associated with the audit management system, at the specified time.

The audit management system executes the audit policy to perform the audit on the acquired network layer device information and the configuration files. The audit management system transmits the reports periodically, or at a date and time specified by the user. Further, the audit management system notifies the user of status updates of the scheduled audit periodically, for example, via emails, a short message service (SMS) message, etc. Further, the audit management system performs data cleansing that is, the audit management system discards information that is no longer needed or is out of date, etc. In an embodiment, the audit management system performs data as scheduled by the user. The audit management system also allows the user to delete a scheduled audit.

The audit management system tracks the performance of the audit of the network layer devices over a predetermined period of time and presents risks associated with non-compliance of the network layer devices with the compliance policies, steps for remediation of the risks, and trends analyzed from the audit of the network layer devices to the user via the GUI. For example, the audit management system provides a dashboard on the GUI that displays the results from a predetermined number of audits scheduled prior to the last scheduled audit of the network layer devices. The dashboard allows the user to get a high-level, accurate view of the infrastructure at a point in time since an audit was last performed. The dashboard provides the user with an alternative to “jump” to previous dates/times to review trends of the infrastructure over time. The dashboard, for example, displays a list of riskiest network layer devices recorded with the highest number of risks, a list of riskiest audit rules, a list of riskiest vendor models, a list of riskiest vendor types, etc. The dashboard displays, for example, a graphical representation of the trends for the last five audit results, the compliance rating and weighting value along with the overall rating in terms of a percentage for a selected compliance policy for a particular date and time, etc. Furthermore, the dashboard presents different modes of presentation of the results of the audit, for example, a “chart view” such as a bar chart or a pie chart, a “score view” that displays the non-compliance score in terms of a rating, a percentage, etc., for a selected compliance policy for a particular date and time, a “trend line view” that displays the trend line for the last five results of the audit, etc.

In an embodiment, the computer implemented method disclosed herein enables control of the administration of the audit management system and creates user policies to determine the accessibility of a user to the audit management system, based on management roles. The management roles define the type of user, for example, an administrator, a manager, a general user, etc., of the audit management system The administrator of the audit management system creates a user account for the user, assigns the user to user groups, and determines the allocation of access privileges to the user based on the user group, which in turn determines the access rights for a user to add, modify, and delete audit commands, audit rules, audit policies, audit schedules, configuration files, etc., to the audit management system.

The administrator of the audit management system creates accounts for a user according to “user privileges”, “group privileges”, and “department privileges” that are allowed to the user. For example, the user privileges define a read and write access for an individual user to different operating areas of the audit management system, the group privileges define access permissions for a group of users and override individual user privileges, etc. The department privileges define privileges in accordance with a managerial status of a user and allot the user to a particular department of an organization. The administrator of the audit management system specifies the user settings, the access restrictions, etc., and allows group, department and session management. Furthermore, the administrator of the audit management system can edit the user accounts, department accounts, group accounts, etc. The audit management system acquires user information, for example, a user name, a password, a user type, details of a department to which the user is affiliated, telephone details, electronic mail address, etc., from the user via the GUI. Furthermore, the administrator of the audit management system monitors the user account settings, the access restrictions, for example, the internet protocol (IP) address with which the user can access the audit management system, the number of times the user can access the audit management system, etc. The administrator of the audit management system creates user policies for streamlining the access permissions of the users who are allowed to upload the network layer device information and the configuration files associated with the network layer devices. The administrator of the audit management system applies the user policies to monitor the users who are responsible, for example, for updating the configuration information associated with the network layer devices.

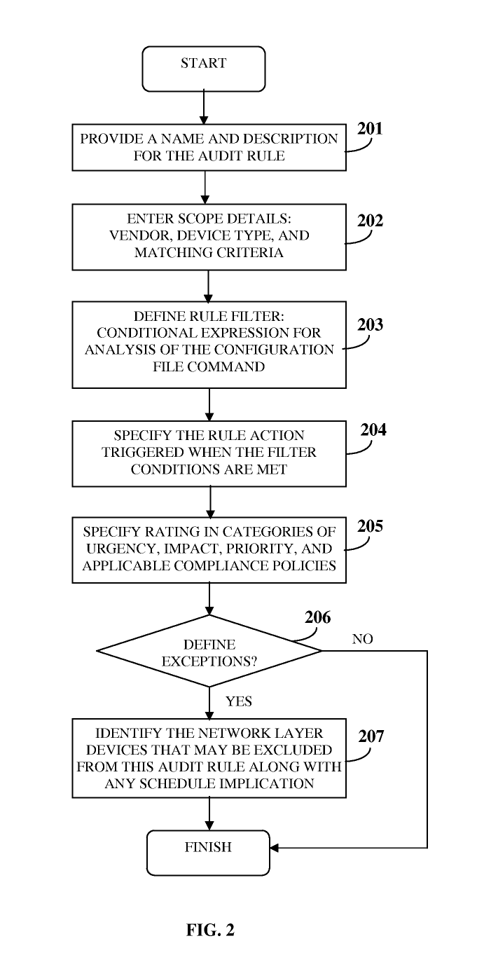

FIG. 2 exemplarily illustrates a flowchart comprising the steps for creating an audit rule for performing an audit of one or more network layer devices to verify security and compliance of the network layer devices with one or more compliance policies. The audit management system allows the user to provide 201a name for the audit rule and a description stating the functionality covered by the audit rule via the graphical user interface (GUI). The audit management system allows the user to enter 202 the scope details, for example, the vendor, device type, and matching criteria via the GUI. The audit management system constructs scope criteria for the audit based on the scope details and matching criteria acquired from the user. The audit management system allows the user to define 203 a rule filter comprising rule filter conditions or conditional expressions for the audit commands for enabling analysis of the configuration file commands while performing the audit of the network layer devices. The filter conditions are the logical constructs that match the scope criteria to the network layer devices being audited. The audit management system allows the user to specify 204 the rule action to be performed when the filter conditions of the audit rule are met. Furthermore, the audit management system allows the user to specify 205 a rating in the categories of urgency, impact, priority, and applicable compliance policies tagged to a particular audit rule. The audit management system prompts the user to check if the user wants to define 206 exceptions for the audit rule. If the user specifies that exceptions are to be created for the audit rule, the audit management system identifies 207, for example, the network layer devices that may be excluded from a specific audit rule or from a particular schedule of the audit, as specified by the user.

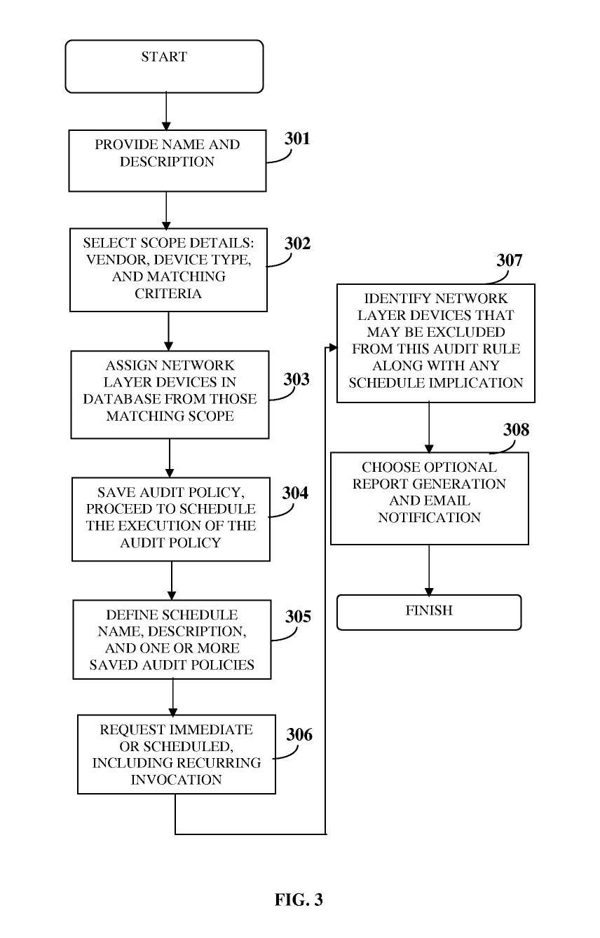

FIG. 3 exemplarily illustrates a flowchart comprising the steps for specification of an audit policy for performing an audit of one or more network layer devices. The audit management system allows the user to provide 301a name for each of the audit rules and a description stating the functionality covered by each of the audit rules via the graphical user interface (GUI). The audit management system allows the user to select 302 the scope details comprising the vendor details for the network layer devices, the type of network layer devices, and the matching criteria, for example, the compliance policy via the GUI. The audit management system performs a search for the list of network layer devices in an audit database associated with the audit management system that match the scope details, and assigns 303 the list of network layer devices for auditing. The audit management system saves 304 the audit policy comprising the audit rules and proceeds to schedule the execution of the audit policy. The audit management system allows the user to define 305 a name and a description for the schedule, and select one or more saved audit policies to match a compliance policy via the GUI. The audit management system allows the user to define the date, time and recurrence of the schedule for the audit of the network layer devices. For example, the audit management system allows the user to request 306 for an immediate scheduling of the audit, or a schedule for a particular date and time, or a recurring schedule configured for predetermined intervals of time, etc. The audit management system identifies 307 the network layer devices that are considered as exceptions to the audit, that is, those network layer devices that may be excluded from a specific audit rule or for a particular schedule of the audit, as specified by the user. The audit management system allows the user to choose 308 to receive a report generated by the audit management system recording the results of the audit on the GUI, or receive an electronic mail (email) notification with the results of the audit, or receive a PDF report, etc.

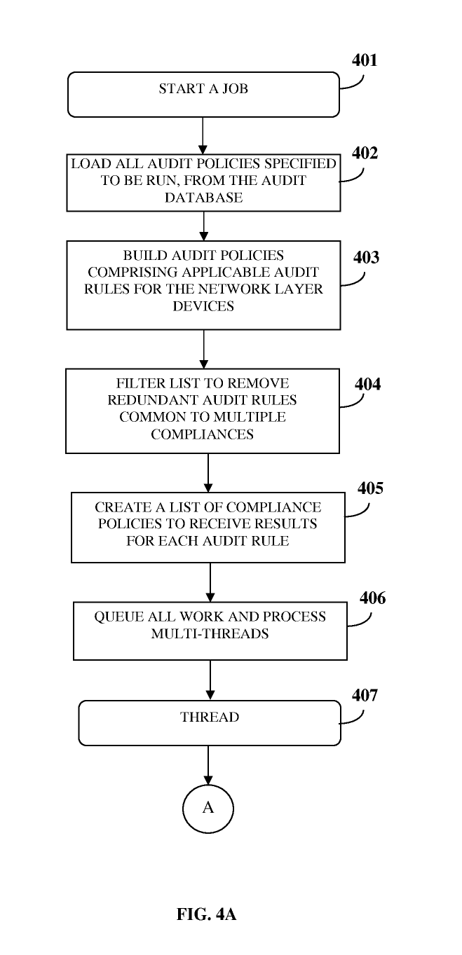

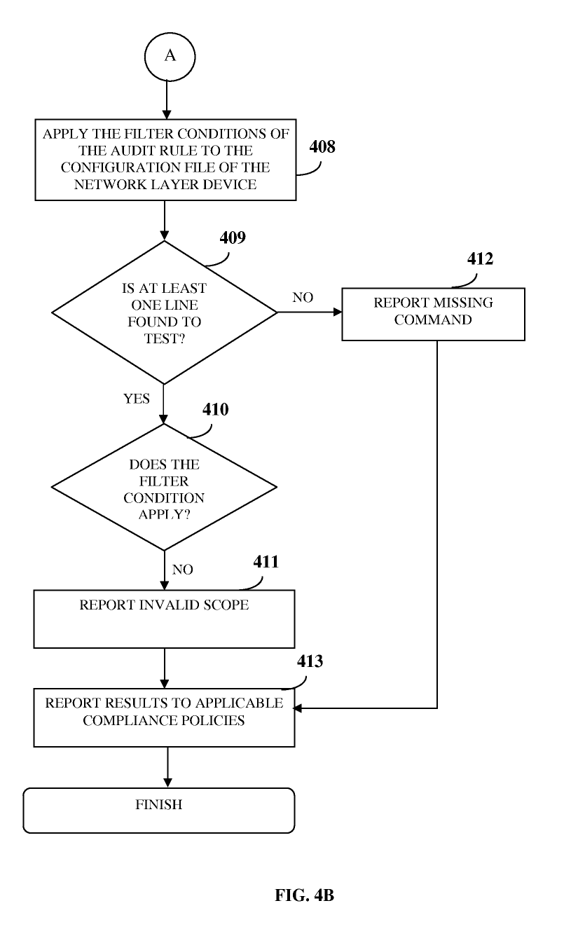

FIGS. 4A-4B exemplarily illustrate a flowchart comprising the steps for analyzing and executing an audit policies for verifying security and compliance of one or more network layer devices with one or more compliance policies. The audit management system first starts 401 a job, for example, runs a program that accesses the audit rules associated with an audit policy. The audit management system loads 402 all the audit policies applicable to the network layer devices for a particular compliance policy from an audit database associated with the audit management system. The audit management system builds 403 the audit policies comprising applicable audit rules for the network layer devices for enabling analysis of security and compliance of the network layer devices with the compliance policies. The audit management system filters 404 the list of audit rules to remove the redundant audit rules that are common to multiple compliance policies. This eliminates duplicating the audit when a single audit is applicable to multiple compliances. The results are annotated in the generated report.

The audit management system creates 405 a list of compliance policies that map to the audit rules, to receive results for each audit rule. The audit management system collects all the audit rules collected from multiple compliance policies that are associated with the audit and filters out the audit rules that are common to multiple compliance policies to avoid repetition of audit checks. The audit management system queues 406 the distinct audit rules and creates and processes multiple threads for performing the audit of multiple configuration parameters or functionalities parallely, with each thread assigned to a single independent audit rule. The audit management system configures 407 threads to access a configuration file of a network layer device and search for a match for each child audit rule in the audit template with the configuration file commands in the configuration file associated with the network layer device. Each independent audit rule is executed by a separate thread. The audit management system applies 408 the filter conditions of the audit rule to the configuration file commands of the configuration file of the network layer device. That is, the audit management system compares the rule filter conditions specified by the audit rule against the configuration file commands of the configuration file associated with the network layer device. The audit management system checks 409 if at least one line, that is, a configuration file command is found in the list of configuration file commands that matches an audit rule. For example, the audit management system checks for a keyword that defines a configuration file command and meets a compliance policy. If at least one line is found in the configuration file, the audit management system checks 410 if the filter conditions of the audit rule apply to the configuration file command. The rule filter conditions determine whether a particular network layer device “passes” or “fails” the requirements set by a compliance policy for which the audit rule is constructed. If there is no line in the configuration file that matches the audit command of the audit rule, the audit management system reports 412 that the configuration file command required for compliance with the compliance policy is missing in the configuration file. If the conditions specified for the configuration file command are not found to match the required rule filter conditions, the audit management system checks if the scope details for the network layer device are applicable to the scope criteria of the audit policy specified for a compliance policy. If the scope details for the network layer device are not applicable to the scope criteria of the audit policy specified for the compliance policy, the audit management system reports 411 invalid scope details for the network layer devices. The audit management system assigns 413 the results of the audit to the applicable compliance policies.

FIG. 5 exemplarily illustrates a flowchart comprising the steps of a machine analysis performed during performance an audit of one or more network layer devices by the audit management system. The audit management system creates 501 separate threads for performing the audit. Each thread is associated with a particular child audit rule. The audit management system configures each thread to access a configuration file of a network layer device stored in an audit database associated with the audit management system, and examine each line, that is, a configuration file command in the configuration file to search for a match with the audit rule. The thread is configured to apply 502 the filter conditions of the audit rule to the configuration file of the network layer device. The audit management system checks 503 if there is at least one line, that is, a configuration file command found in the configuration file of the network layer device that matches the audit rule for a particular functionality. If there is at least one line found in the configuration file of the network layer device that matches the audit rule, the audit management system checks 506 if the filter conditions apply to the network layer device. If the scope details of the network layer device do not match the scope criteria, the audit management system reports 507 that the scope defined by the network layer devices is invalid. If the scope details of the network layer device match the scope criteria, the audit management system applies 508 the checks or filter conditions specified by the audit rule. If there is no line in the configuration file that matches the audit rule, the audit management system checks 504 if the configuration file command is mandatory for achieving compliance with the compliance policy. If the configuration file command is not mandatory for achieving compliance with the compliance policy, the audit management system reports that the audit command is out of scope of the configuration of the network layer device and is therefore not applicable to the audit. If the configuration file command is mandatory for achieving compliance with the compliance policy, the audit management system reports 509 that the configuration file command is missing from the configuration file and the network layer device is non-compliant with the compliance policy determined for the network layer device. The audit management system generates 510 a report comprising the results of the audit according to the applicable compliance policies and stores the report in the audit database.

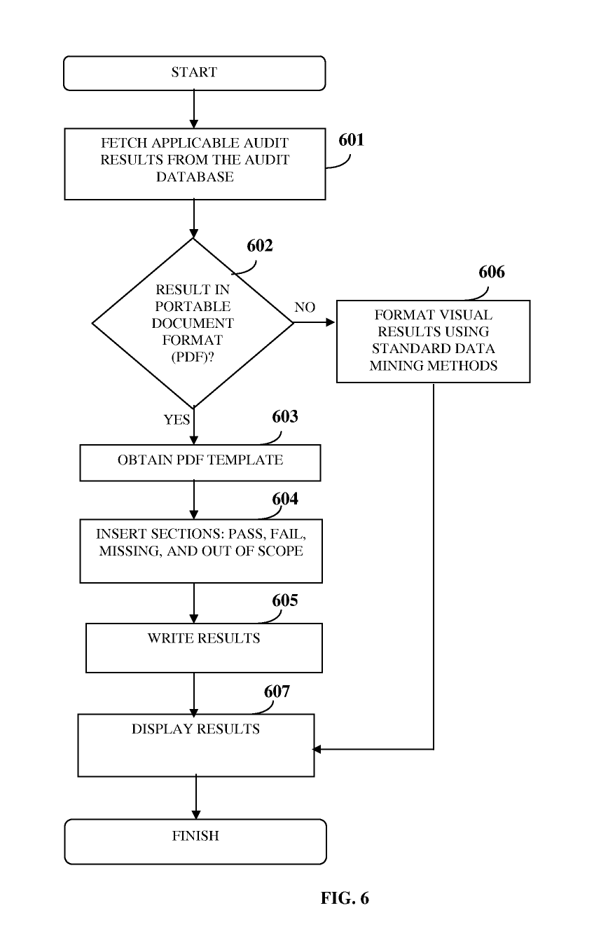

FIG. 6 exemplarily illustrates a flowchart comprising the steps for generating a report that records results of an audit performed on one or more network layer devices. The audit management system fetches 601 the applicable audit results of the analysis process from an audit database associated with the audit management system 201. The audit management system checks 602 whether the user has requested for the report in a portable document format (PDF). If the user has requested for the report in the PDF, the audit management system obtains 603 a PDF template and inserts 604 sections, for example, “Pass”, “Fail”, “Missing”, and “Out of scope” in the PDF template. The audit management system populates the PDF template by writing 605 the results of the audit into the PDF template. If the user has not requested for the report in the PDF, the audit management system applies 606 standard data mining methods, for example, for extracting patterns in the results of the audit of the network layer devices, clustering the network layer devices with similar device characteristics, classifying the network layer devices into compliant and non-compliant network layer devices, etc., and formatting the results in the required visual format. The audit management system displays 607 the results of the audit on the graphical user interface (GUI) provided by the audit management system.

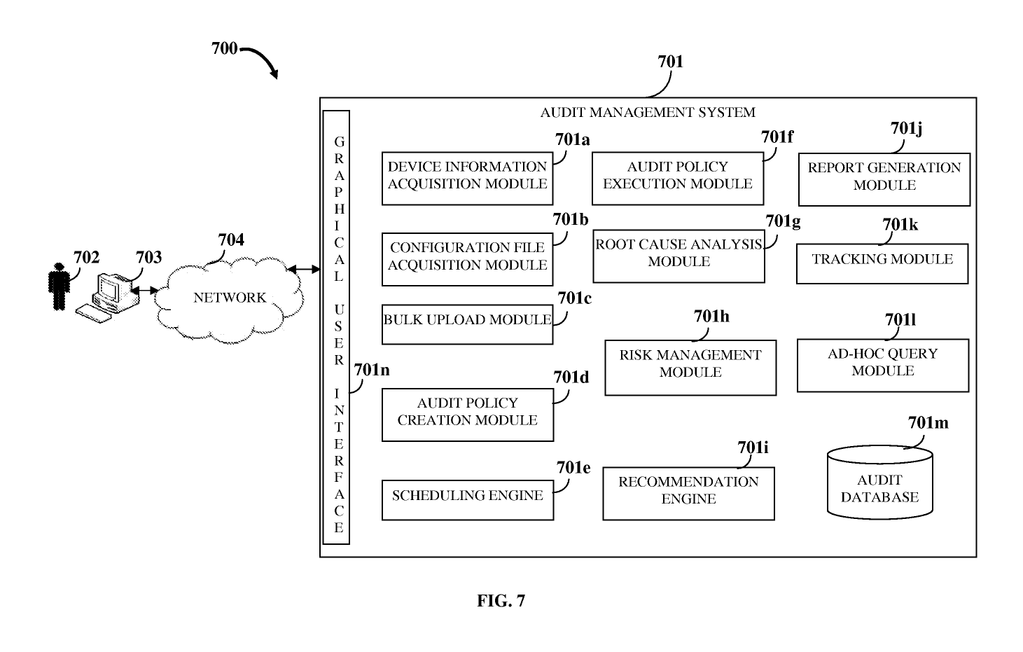

FIG. 7 illustrates a computer implemented system 700 for managing an audit of one or more network layer devices. The computer implemented system 700 comprises the audit management system 701 accessible to a user 702, for example, over a network 704 via a graphical user interface (GUI) 701n. The user 702 accesses the audit management system 701 via the network 704 using a computing device 703, for example, a personal computer, a laptop, a mobile phone, a personal digital assistant, a tablet computing device, etc. The audit management system 701 comprises a device information acquisition module 701a, a configuration file acquisition module 701b, a bulk upload module 701c, an audit policy creation module 701d, a scheduling engine 701e, an audit policy execution module 701f, a risk management module 701h, a recommendation engine 701i, and a report generation module 701j. The audit management system 701 further comprises a root cause analysis module 701g, an ad-hoc query module 701l, a tracking module 701k, and an audit database 701m.

The device information acquisition module 701a acquires network layer device information of the network layer devices via the GUI 701n. The device information acquisition module 701a acquires manual entries of the network layer device information from the user 702 via the GUI 701n, extracts the network layer device information based on a simple network management protocol, and performs an interoperable gathering of the network layer device information from third party entities associated with the audit management system 701. The configuration file acquisition module 701b acquires a configuration file comprising configuration file commands that define configuration of each of the network layer devices, from the user 702 via the GUI 701n. The configuration file acquisition module 701b acquires manual entries of the configuration file from the user 702 via the GUI 701n, extracts the configuration file based on a simple network management protocol, and performs an interoperable gathering of the configuration file from third party entities associated with the audit management system 701.

The audit policy creation module 701d allows creation and/or selection of one or more audit policies comprising one or more audit rules for the network layer devices as disclosed in the detailed description of FIG. 1. The audit policy creation module 701d creates the audit rules for the audit policies. The audit policy creation module 701d creates, for example, parent audit rules, child audit rules, a combination of parent audit rules and child audit rules, etc., for enabling conditional audit of the network layer devices. The audit policy creation module 701d identifies scope details from the network layer device information associated with the network layer devices for selecting one or more of the network layer devices for the audit. The audit policy creation module 701d defines audit commands that correspond to the configuration file commands of the configuration file. The audit policy creation module 701d creates one or more filter conditions for each of the audit commands, where the filter conditions specify criteria for finding a match between the configuration file commands of the configuration file and the audit rules during the execution of the audit policies. The audit policy creation module 701d creates the audit rules from the audit commands with the filter conditions for performing the audit of the selected network layer devices.

Furthermore, the audit policy creation module 701d enables definition of a rule action associated with the filter conditions of the audit rules by the user 702 via the GUI 701n. The audit policy creation module 701d allows the user 702 to group one or more audit rules within each of the audit policies for optimizing the execution of the audit policies. In an embodiment, the audit policy creation module 701d automatically selects audit commands that match the network layer device information and the configuration file commands of the configuration file for creation of the audit rules for the audit policies. The audit policy creation module 701d automatically updates the audit commands on determining a modification in the scope details identified from the network layer device information associated with the network layer devices. The audit policy creation module 701d performs a search based on the network layer device information and the configuration file, and automatically selects audit commands matching the network layer device information and the configuration file. Furthermore, the audit policy creation module 701d identifies one or more audit rules that apply commonly across the compliance policies to generate a list of unique audit rules for the audit policies. Furthermore, the audit policy creation module 701d allows the selection of one or more audit rules to be excluded during the execution of the audit policies by the user 702 via the GUI 701n. The audit policy creation module 701d also allows the selection of one or more network layer devices to be excluded during the execution of the audit policies by the user 702 via the GUI 701n.

The audit policy execution module 701f executes the audit policies for performing the audit of the network layer devices. The audit policy execution module 701f executes the audit policies by comparing the configuration file commands of the configuration file with the audit rules of the audit policies for verifying security and compliance of the network layer devices with the compliance policies. Further, the audit policy execution module 701f performs the rule action defined by the audit policy creation module 701d when the filter conditions of the audit rules are met.

The root cause analysis module 701g performs a root cause analysis for determining cause of non-compliance of the network layer devices with one or more compliance policies on execution of the audit policies. The root cause analysis module 701g, for example, determines the non-compliance by identifying disparities between the configuration file commands of the configuration file with the audit rules of the audit policies, identifying absence of one or more of the configuration file commands in the configuration file, etc. The root cause analysis module 701g also sets scope criteria based on scope details acquired from the network layer device information for the audit of the network layer devices. The root cause analysis module 701g identifies the network layer devices that fail to match the scope criteria set for the audit, and notifies the user 702 on the identified network layer devices that fail to match the scope criteria, during the performance of the root cause analysis.

The risk management module 701h defines risk information for each of the selected network layer devices when the match between the configuration file commands of the configuration file and the audit rules is not found during the execution of the audit policies. The risk management module 701h collects risk information associated with the non-compliance of the network layer devices with the compliance policies determined on execution of the audit policies and assigns a risk rating that defines the severity of the non-compliance. The risk management module 701h assigns a non-compliance score as a measure of the non-compliance.

The recommendation engine 701i generates recommendations for remediating the non-compliance and presents the generated recommendations to the user 702 via the GUI 701n. The recommendation engine 701i specifies modes of adjusting, adding, and removing one or more of the audit rules from the audit policies in the generated recommendations. The ad-hoc query module 701l selectively extracts results of the audit of the network layer devices based on ad-hoc queries associated with the compliance policies and the network layer device information, received from the user 702, via the GUI 701n.

The tracking module 701k tracks the performance of the audit of the network layer devices over a predetermined period of time and presents risks associated with non-compliance of the network layer devices with the compliance policies, the steps for remediation of the risks, and trends analyzed from the audit of the network layer devices to the user 702 via the GUI 701n. The tracking module 701k monitors changes in the network layer device information, the configuration file, and one or more audit policies. The tracking module 701k, in communication with the device information acquisition module 701a, the configuration file acquisition module 701b, and the audit policy creation module 701d, triggers the acquisition of the network layer device information, the acquisition of the configuration file, acquisition of input from the user 702 for the creation of the audit policies and scheduling of the execution of the audit policies, on detecting changes in the network layer device information, the configuration file, and the audit policies. In an embodiment, the tracking module 701k transmits notifications on status of the audit to the user 702 via the GUI 701n.

The bulk upload module 701c enables a bulk upload of the network layer device information associated with the network layer devices, the audit commands, and the configuration files associated with the network layer devices. The bulk upload module 701c, for example, provides a device information utility for enabling bulk upload of the network layer device information, a command upload utility for enabling bulk upload of the audit commands, and a configuration file upload utility for enabling a bulk upload of the configuration files of the network layer devices. In an embodiment, the audit management system 701 stores the network layer device information, the configuration files, and the audit commands in the audit database 701m. The audit database 701m creates separate records for each of the network layer devices and enables tracking of the configuration files acquired at different scheduled points in time, the revisions of the configuration files, the network layer device information, etc. The audit database 701m allows the user 702 to revert the configuration file used for auditing to an older configuration version corresponding to a configuration file collected from the user 702 at a prior point in time, based on a revision number. Furthermore, the audit database 701m allows the user 702 to select audit commands for creating audit rules and stores the audit rules.

The scheduling engine 701e schedules the acquisition of the network layer device information, the acquisition of the configuration file, the creation of the audit policies, the execution of the audit policies, the generation of the report comprising the information about security and compliance of the network layer devices with the compliance policies, and transmission of notifications on the status of the audit based on inputs received from the user 702 via the GUI 701n.

The report generation module 701j generates a report comprising information about the security and the compliance of the network layer devices with the compliance policies based on the execution of the audit policies. The report generation module 701j highlights, prioritizes, and filters the information about the security and the compliance of the network layer devices with the compliance policies based on predetermined criteria, comprising, for example, ratings of impact assessment, network layer device information, assignment of the network layer devices to the audit, exposure of the network layer devices to potential intrusions, categories of the network layer devices, etc. The report generation module 701j stores the generated report in the audit database 701m.

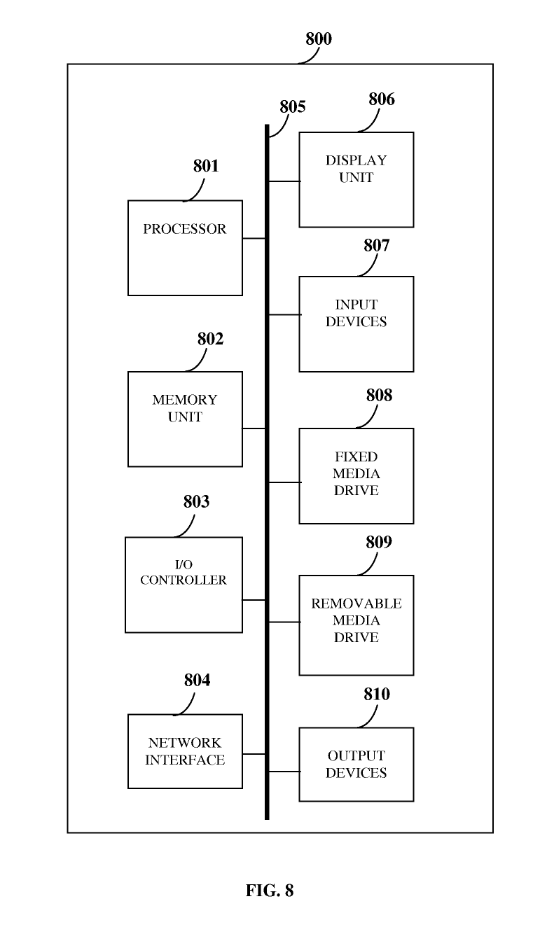

FIG. 8 exemplarily illustrates the architecture of a computer system 800 employed by the audit management system 701 for managing an audit of one or more network layer devices. The audit management system 701 of the computer implemented system 700, exemplarily illustrated in FIG. 7, employs the architecture of the computer system 800 exemplarily illustrated in FIG. 8 for managing an audit of one or more network layer devices.

The audit management system 701 communicates with the computing device 703 of the user 702 via the network 704, for example, a short range network or a long range network. The network 704 is, for example, the internet, a local area network, a wide area network, a wireless network, a mobile communication network, etc. The computer system 800 comprises, for example, a processor 801, a memory unit 802 for storing programs and data, an input/output (I/O) controller 803, a network interface 804, a data bus 805, a display unit 806, input devices 807, a fixed media drive 808, a removable media drive 809 for receiving removable media, output devices 810, etc.

The processor 801 is an electronic circuit that executes computer programs. The memory unit 802 is used for storing programs, applications, and data. For example, the device information acquisition module 701a, the configuration file acquisition module 701b, the bulk upload module 701c, the audit policy creation module 701d, the scheduling engine 701e, the audit policy execution module 701f, the risk management module 701h, the recommendation engine 701i, the ad-hoc query module 701l, the root cause analysis module 701g, the report generation module 701j, the tracking module 701k, etc., of the audit management system 701 are stored in the memory unit 802 of the computer system 800 of the audit management system 701. The memory unit 802 is, for example, a random access memory (RAM) or another type of dynamic storage device that stores information and instructions for execution by the processor 801. The memory unit 802 also stores temporary variables and other intermediate information used during execution of the instructions by the processor 801. The computer system 800 further comprises a read only memory (ROM) or another type of static storage device that stores static information and instructions for the processor 801.

The network interface 804 enables connection of the computer system 800 to the network 704. For example, the audit management system 701 connects to the network 704 via the network interface 804. The network interface 804 comprises, for example, an infrared (IR) interface, a WiFi interface, a universal serial bus (USB) interface, a local area network (LAN) interface, a wide area network (WAN) interface, etc. The I/O controller 803 controls the input actions and output actions performed by the user 702 using the computing device 703, for example, for selecting the audit policies, for scheduling the audit, etc. The data bus 805 permits communications between the modules, for example, 701a, 701b, 701c, 701d, 701e, 701f, 701g, 701h, 701i, 701j, 701k, 701l, 701m, etc., of the audit management system 701.

The display unit 806 of the audit management system 701, via the GUI 701n, displays information, for example, in menus, display interfaces, icons, user interface elements such as dialog boxes, text fields, checkboxes for selecting the audit rules, the scope details, etc., to the user 702, that enable the user 702 to perform, for example, audit policy selection, etc. The display unit 806 displays the results of the audit performed on the network layer devices, the generated report comprising information on security and compliance of the network layer devices with the compliance policies based on the execution of the audit policies, analysis of the trends drawn from performing the audit on the network layer devices for a predetermined number of times, etc., to the user 702 via the GUI 701n.

The input devices 807 are used for inputting data into the computer system 800. The input devices 807 are, for example, a keyboard such as an alphanumeric keyboard, a joystick, a pointing device such as a computer mouse, a touch pad, a light pen, etc. The user 702 uses the input devices 807 to provide inputs to the audit management system 701. For example, the user 702 initiates scheduling of the audit by triggering the scheduling engine 701e, etc., using the input devices 807. The user 702 manually uploads the network device information and the configuration files to the audit database 701m via the graphical user interface (GUI) 701n using the input devices 807. In another example, the user 702 can submit an ad-hoc query for selectively extracting results of the audit to the audit management system 701 using the input devices 807.

The output devices 810 output the results of operations performed by the audit management system 701, on the computing device 703 via the GUI 701n. For example, the audit management system 701 notifies the user 702 through a pop-up window on an output device 810 such as a display screen about the network layer devices that are non-compliant with a particular compliance policy. The audit management system 701 also displays the generated report on an output device 810 such as a display screen on the user's 702 computing device 703.

Computer applications and programs are used for operating the computer system 800. The programs are loaded onto the fixed media drive 808 and into the memory unit 802 of the computer system 800 via the removable media drive 809. In an embodiment, the computer applications and programs may be loaded directly via the network 704. Computer applications and programs are executed by double clicking a related icon displayed on the display unit 806 using one of the input devices 807.

The computer system 800 employs an operating system for performing multiple tasks. The operating system is responsible for management and coordination of activities and sharing of resources of the computer system 800. The operating system further manages security of the computer system 800, peripheral devices connected to the computer system 800, and network connections. The operating system employed on the computer system 800 recognizes, for example, inputs provided by the user 702 using one of the input devices 807, the output display, files, and directories stored locally on the fixed media drive 808, for example, a hard drive. The operating system on the computer system 800 executes different programs using the processor 801.

The processor 801 retrieves the instructions for executing the modules, for example, 701a, 701b, 701c, 701d, 701e, 701f, 701g, 701h, 701i, 701j, 701k, 701l, 701m, etc., of the audit management system 701 from the memory unit 802. A program counter determines the location of the instructions in the memory unit 802. The program counter stores a number that identifies the current position in the program of the modules, for example, 701a, 701b, 701c, 701d, 701e, 701f, 701g, 701h, 701i, 701j, 701k, 701l, 701m, etc., of the audit management system 701.

The instructions fetched by the processor 801 from the memory unit 802 after being processed are decoded. The instructions are placed in an instruction register in the processor 801. After processing and decoding, the processor 801 executes the instructions. For example, the device information acquisition module 701a defines instructions for acquiring network layer device information of the network layer devices via the GUI 701n. The configuration file acquisition module 701b defines instructions for acquiring a configuration file comprising configuration file commands that define the configuration of each of the network layer devices, from the user 702 via the GUI 701n. The bulk upload module 701c defines instructions for enabling a bulk upload of the network layer device information, audit commands, and the configuration files associated with the network layer devices. The audit policy creation module 701d defines instructions for creating and/or selecting one or more audit policies comprising one or more audit rules for the network layer devices. Further, the audit policy creation module 701d defines instructions for identifying scope details from the network layer device information associated with the network layer devices for selecting one or more of the network layer devices for the audit, defining audit commands that correspond to the configuration file commands of the configuration file, creating one or more filter conditions for each of the audit commands, defining a rule action associated with the filter conditions, grouping one or more audit rules within each of the audit policies for optimizing the execution of the audit policies, identifying one or more audit rules that apply commonly across the compliance policies to generate a list of unique audit rules for the audit policies, etc.

The scheduling engine 701e defines instructions for scheduling the acquisition of the network layer device information, the acquisition of the configuration file, the creation of the audit policies, the execution of the audit policies, the generation of the report comprising the information about security and compliance of the network layer devices with the compliance policies, and transmission of notifications on the status of the audit based on inputs received from the user 702 via the GUI 701n. The audit policy execution module 701f defines instructions for executing the audit policies for performing the audit of the network layer devices. The audit policy execution module 701f defines instructions for comparing the configuration file commands of the configuration file with the audit rules of the audit policies for verifying security and compliance of the network layer devices with the compliance policies. The audit policy execution module 701f also defines instructions for performing a rule action defined by the audit policy creation module 701d when the filter conditions of the audit rules are met.

The root cause analysis module 701g defines instructions for determining cause of non-compliance of the network layer devices with one or more compliance policies on execution of the audit policies. The root cause analysis module 701g also defines instructions for setting scope criteria based on scope details acquired from the network layer device information for the audit of the network layer devices. The root cause analysis module 701g also defines instructions for identifying the network layer devices that fail to match the scope criteria set for the audit, and notifying the user 702 on the identified network layer devices that fail to match the scope criteria, during the performance of the root cause analysis. The risk management module 701h defines instructions for defining risk information for each of the selected network layer devices when a match between the configuration file commands of the configuration file and the audit rules is not found during the execution of the audit policies. Furthermore, the risk management module 701h defines instructions for collecting risk information associated with the non-compliance of the network layer devices with the compliance policies, assigning a risk rating that defines the severity of the non-compliance, and assigning a non-compliance score as a measure of the non-compliance. The recommendation engine 701i defines instructions for generating recommendations for remediating the non-compliance of the network layer devices with the compliance policies and presenting the generated recommendations to the user 702 via the GUI 701n. The ad-hoc query module 701l defines instructions for selectively extracting results of the audit of the network layer devices based on ad-hoc queries associated with the compliance policies and the network layer device information, received from the user 702 via the GUI 701n.

The tracking module 701k defines instructions for tracking the performance of the audit of the network layer devices over a predetermined period of time and presenting risks associated with non-compliance of the network layer devices with the compliance policies, the steps for remediation of the risks, and trends analyzed from the audit of the network layer devices to the user 702 via the GUI 701n. The tracking module 701k defines instructions for monitoring changes in the network layer device information, the configuration file, and one or more audit policies. The tracking module 701k also defines instructions for triggering the acquisition of the network layer device information, the acquisition of the configuration file, acquisition of input from the user 702 for the creation of the audit policies and scheduling of the execution of the audit policies, on detecting changes in the network layer device information, the configuration file, and the audit policies.

The report generation module 701j defines instructions for generating a report comprising information about the security and the compliance of the network layer devices with the compliance policies based on the execution of the audit policies. The report generation module 701j defines instructions for highlighting, prioritizing, and filtering the information about the security and the compliance of the network layer devices with the compliance policies based on predetermined criteria, comprising, for example, ratings of impact assessment, network layer device information, assignment of the network layer devices to the audit, exposure of the network layer devices to potential intrusions, categories of the network layer devices, etc.

The processor 801 of the computer system 800 employed by the audit management system 701 retrieves the instructions defined by the device information acquisition module 701a, the configuration file acquisition module 701b, the bulk upload module 701c, the audit policy creation module 701d, the scheduling engine 701e, the audit policy execution module 701f, the risk management module 701h, the recommendation engine 701i, the ad-hoc query module 701l, the root cause analysis module 701g, the report generation module 701j, the tracking module 701k, etc., of the audit management system 701 and executes the instructions.

At the time of execution, the instructions stored in the instruction register are examined to determine the operations to be performed. The processor 801 then performs the specified operations. The operations comprise arithmetic and logic operations. The operating system performs multiple routines for performing a number of tasks required to assign the input devices 807, the output devices 810, and memory for execution of the modules, for example, 701a, 701b, 701c, 701d, 701e, 701f, 701g, 701h, 701i, 701j, 701k, 701l, 701m, etc., of the audit management system 701. The tasks performed by the operating system comprise, for example, assigning memory to the modules, for example, 701a, 701b, 701c, 701d, 701e, 701f, 701g, 701h, 701i, 701j, 701k, 701l, 701m, etc., of the audit management system 701, and to data used by the audit management system 701, moving data between the memory unit 802 and disk units, and handling input/output operations. The operating system performs the tasks on request by the operations and after performing the tasks, the operating system transfers the execution control back to the processor 801. The processor 801 continues the execution to obtain one or more outputs. The outputs of the execution of the modules, for example, 701a, 701b, 701c, 701d, 701e, 701f, 701g, 701h, 701i, 701j, 701k, 701l, 701m, etc., of the audit management system 701 are displayed to the user 702 on the display unit 806.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 801, except for a transitory, propagating signal.

The computer program product disclosed herein comprises multiple computer program codes for managing an audit of one or more network layer devices. For example, the computer program product disclosed herein comprises a first computer program code for acquiring network layer device information of one or more network layer devices via the GUI 701n; a second computer program code for acquiring a configuration file comprising configuration file commands that define the configuration of each of the network layer devices, via the GUI 701n; a third computer program code for allowing creation and/or selection of one or more audit policies comprising one or more audit rules for the network layer devices; a fourth computer program code for executing the audit policies for performing the audit of the network layer devices, where the execution of the audit policies comprises comparing the configuration file commands of the configuration file with one or more audit rules of the audit policies for verifying security and compliance of the network layer devices with the compliance policies; and a fifth computer program code for generating a report comprising information about the security and the compliance of the network layer devices with the compliance policies for the verification of the security and the compliance of the network layer devices with the compliance policies based on the execution of the audit policies. The computer program product disclosed herein further comprises additional computer program codes for performing additional steps that may be required and contemplated for managing an audit of one or more network layer devices.

The computer program codes comprising the computer executable instructions are embodied on the non-transitory computer readable storage medium. The processor 801 of the computer system 800 retrieves these computer executable instructions and executes them. When the computer executable instructions are executed by the processor 801, the computer executable instructions cause the processor 801 to perform the method steps for managing an audit of one or more network layer devices. In an embodiment, a single piece of computer program code comprising computer executable instructions performs one or more steps of the computer implemented method disclosed herein for managing an audit of one or more network layer devices.

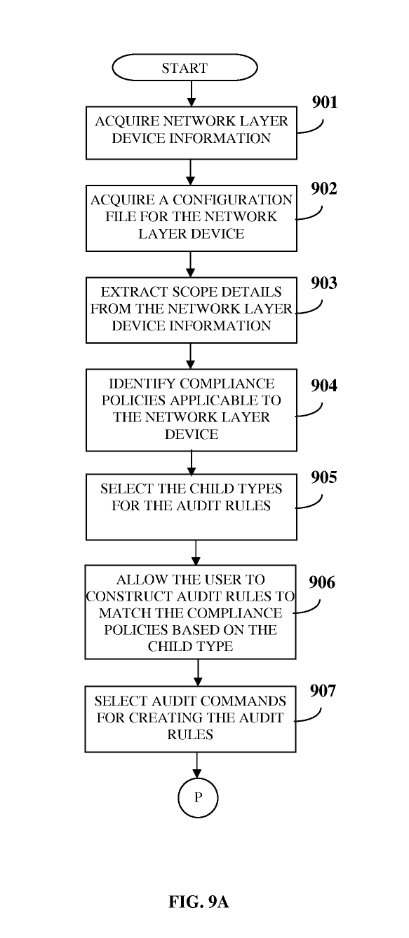

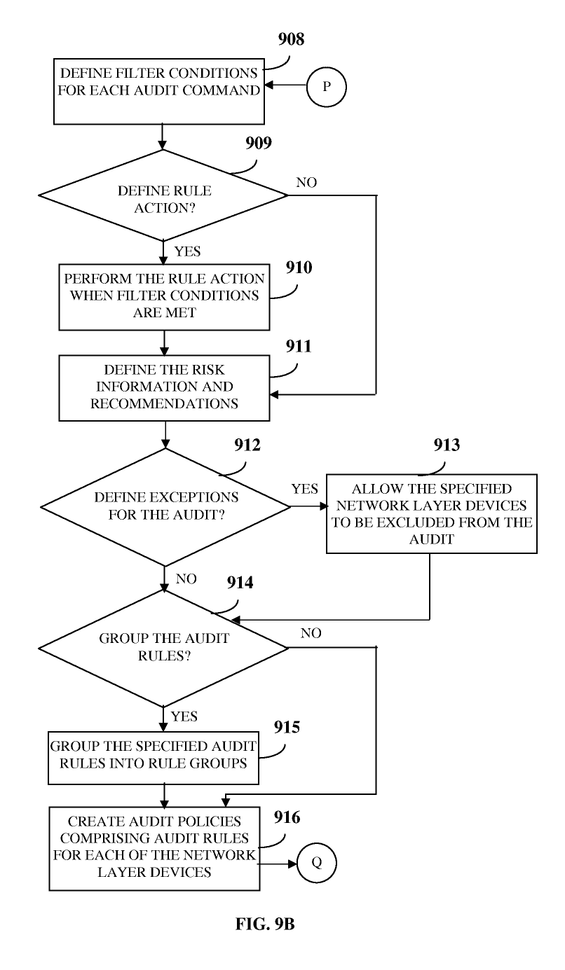

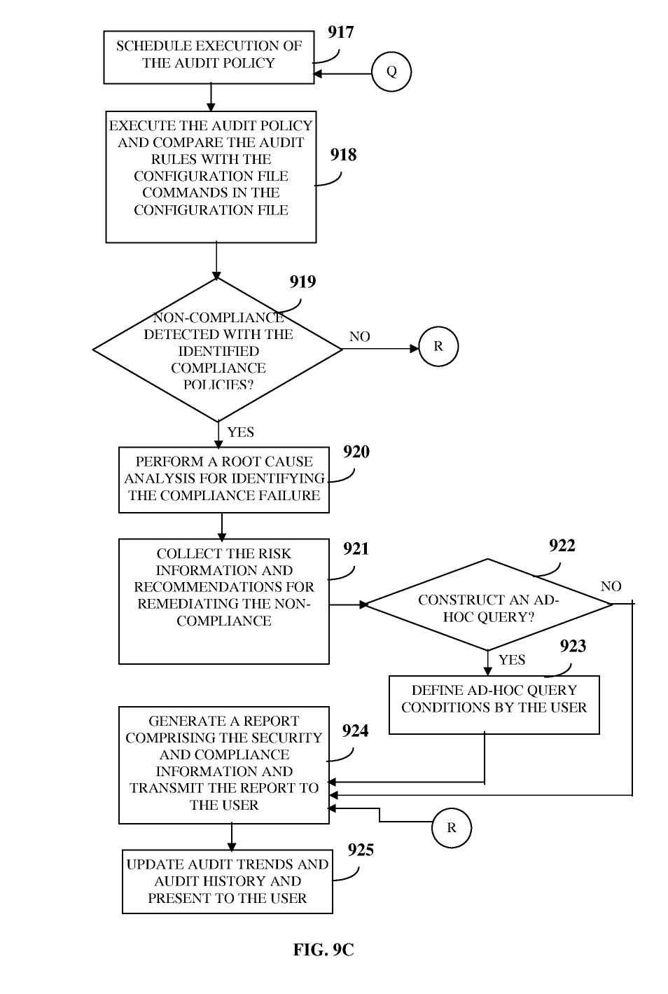

FIGS. 9A-9C exemplarily illustrate a flowchart comprising the steps for managing an audit of one or more network layer devices. Consider an example where the audit management system 701, exemplarily illustrated in FIG. 7, is hosted on a server for performing an audit for network layer devices manufactured by an organization. A user 702 runs an audit using the audit management system 701 to verify if a network layer device, for example, a router is compliant with industry compliant standards such as the Cisco security baseline and the Cisco SAFE standard. The audit management system 701 acquires 901 network layer device information from the user 702 over a network 704, for example, the internet, via the graphical user interface (GUI) 701n of the audit management system 701. In this example, the network layer device information acquired from the user 702 comprises a device type such as the type of router, device series of the router, a network processor used in the router, a version of software running on the router, etc. The audit management system 701 acquires the network layer device information from the text files uploaded by the user 702 via the GUI 701n and stores the network layer device information in the audit database 701m.

The audit management system 701 acquires 902 a configuration file for the router, over the network 704 via the GUI 701n. The configuration file of the router comprises, for example, a routing protocol setting, routing policy settings, etc. The audit management system 701 extracts 903 scope details from the network layer device information for defining the network layer devices applicable to the audit. In this example, the scope details comprise all routers, with hardware version greater than 6.2, and vendor A. The audit management system 701 identifies 904 compliance policies applicable to the network layer device, in this example, the router. In this example, the compliance policies comprise the Cisco security baseline, Cisco SAFE compliance policies, etc. The audit management system 701 organizes the configuration file into audit sections. The audit management system 701 selects 905 a child type for audit rules to create an audit policy. In this example, the audit management system 701 selects the “global” child type. The audit management system 701 allows the user 702 to construct 906 audit rules to match the compliance policies based on the child type.

The audit management system 701 further selects 907 audit commands for creating the audit rules based on the child type on receiving input from the user 702 via the GUI 701n. For example, the audit management system 701 selects the “aaa accounting connection h.323 start-stop group [string]” command. The router, in this example, renders voice over internet protocol (VoIP) services and is therefore configured to support the h.323 recommendation of international telecommunication union telecommunication standardization sector (ITU-T). The audit management system 701 defines 908 the filter conditions for the audit command based on the input received from the user 702 via the GUI 701n. In this example, the audit management system 701 defines the filter condition as “Exists” for the keyword “aaa accounting connection” and “contains” for the alphanumeric string “h.323”.

The audit management system 701 checks 909 with the user 702 via the GUI 701n if a rule action needs to be defined for the filter conditions. If the user 702 defines the rule action, the audit management system 701 performs 910 the rule action when the filter conditions are met. If the user 702 does not define a rule action, the audit management system 701 proceeds with defining the risk information and the recommendations. In this example, the user 702 does not request for a rule action and proceeds with the definition of the risk information and the recommendations to remediate a non-compliance of the router with the compliance policies.

The audit management system 701 defines 911 the risk information and recommendations. The audit management system 701 specifies that the absence of the “aaa accounting connection h.323 start-stop group [string]” command would limit the efficiency of the router in managing accounting for tracking individual and group usage of network resources over a VoIP network. The audit management system 701 provides the recommendation by providing a command reference and a web link to the Cisco SAFE and Cisco security baseline specifications.

Furthermore, the audit management system 701 checks 912 if the user 702 wants to define exceptions for the audit. This may, for example, be due to a change in the code version of the program operating on the network layer device that calls for an exemption from the auditing process. If the user 702 wants to define exceptions for the audit, the audit management system 701 allows the specified network layer devices to be excluded 913 from the audit. In this example, the user 702 defines the exceptions by marking a router of a vendor “A”, with the hardware version greater than “11.2”, to be excluded from the audit scheduled for a particular date. If the user 702 does not want to define exceptions for the audit, the audit management system 701 checks 914 if the user 702 wants to group the audit rules.

The audit management system 701 checks 914 with the user 702 via the GUI 701n if the user 702 wants to group the audit rules to construct a rule group. If the user 702 wants to construct a rule group, the audit management system 701 allows the user 702 to group 915 specified audit rules to the rule group. If the user 702 does not specify a rule group, the audit management system 701 proceeds with the creation of an audit policy. In this example, the user 702 wants to construct a rule group for “aaa accounting commands” for all routers of vendor A.

The audit management system 701 creates 916 the audit policies comprising audit rules for each of the network layer devices. The audit policies map the specified network layer device, in this example, the router to the audit rules specified for verifying the compliance of the router with the compliance policy, for example, the Cisco security baseline. The audit management system 701 schedules 917 execution of the audit policy as a recurring schedule to be performed on a weekly basis. The audit management system 701 executes 918 the audit policy and compares the audit rules of the audit policy with the configuration file commands specified in the configuration file of the router. The audit management system 701 invokes threads to access the configuration file commands in the configuration file of the router and performs a line by line check with the audit rules. In this example, the audit management system 701 checks if the keyword “aaa accounting connection” exists in the configuration file of the router, and the alphanumeric string “h.323” is contained in the configuration file. The audit management system 701 records the result of the comparison.

The audit management system 701 checks 919 if the router has been detected as being non-compliant with the compliance policy Cisco security baseline. If the router is non-compliant with the Cisco security baseline, the audit management system 701 performs 920 a root cause analysis for identifying the compliance failure. In this example, the configuration file of the router does not have the audit command “aaa accounting connection h.323 start-stop group [string]” and the audit management system 701 records the root cause of failure of compliance as “missing configuration command”.

The audit management system 701 collects 921 the risk information and recommendations specified during the creation of the audit policy for collating the security and compliance information with the results of the audit. The audit management system 701 checks 922 if the user 702 wants to construct an ad-hoc query for performing a conditional audit on the network layer devices. If the user 702 wants to construct an ad-hoc query, the audit management system 701 allows the user 702 to define 923 the ad-hoc query conditions. If the user 702 does not want to make use of the ad-hoc query option, the audit management system 701 proceeds with the generation of a report based on the audit. In this example, the user 702 specifies the ad-hoc query as “All routers of vendor A with hardware version greater than “6.2” and compliant with “Cisco SAFE policy”. The audit management system 701 extracts the results of the last scheduled audit matching the ad-hoc query and displays the results of the audit to the user 702.

The audit management system 701 generates 924 the report, in this example, a PDF report comprising the security and compliance information and transmits the generated PDF report to the user 702, for example, via an electronic mail. The audit management system 701 updates 925 audit trends and audit history and presents the audit trends, the prominent risks and compliance failures of the router to the user 702 via the GUI 701n.

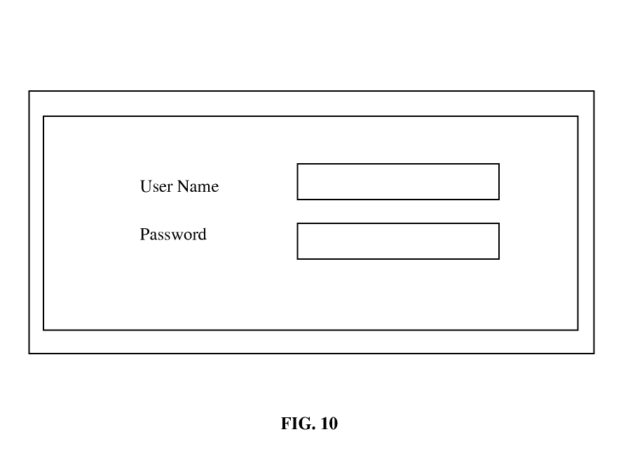

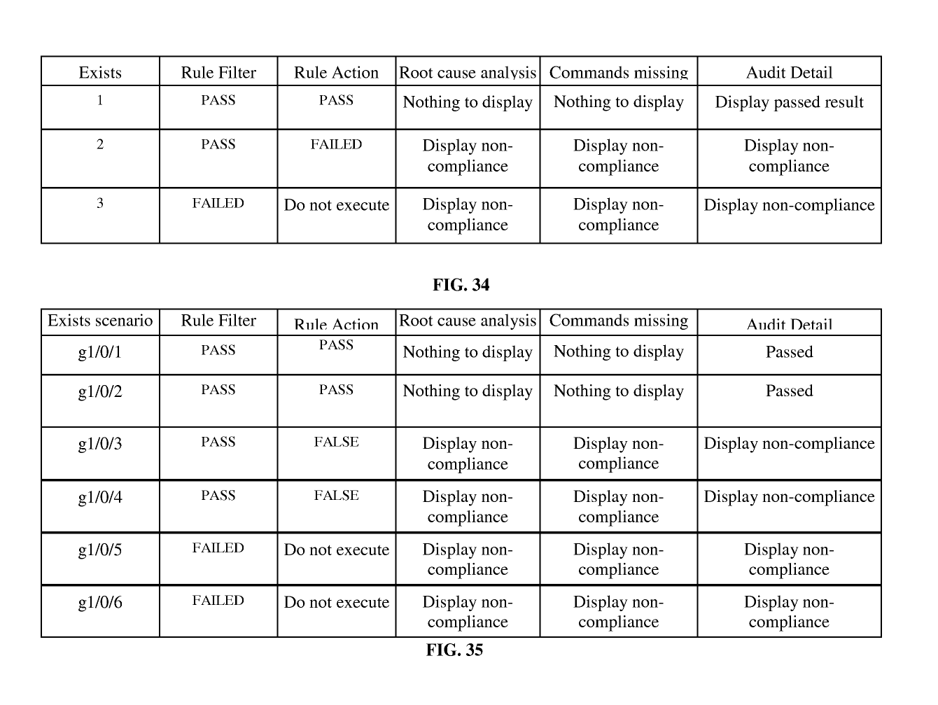

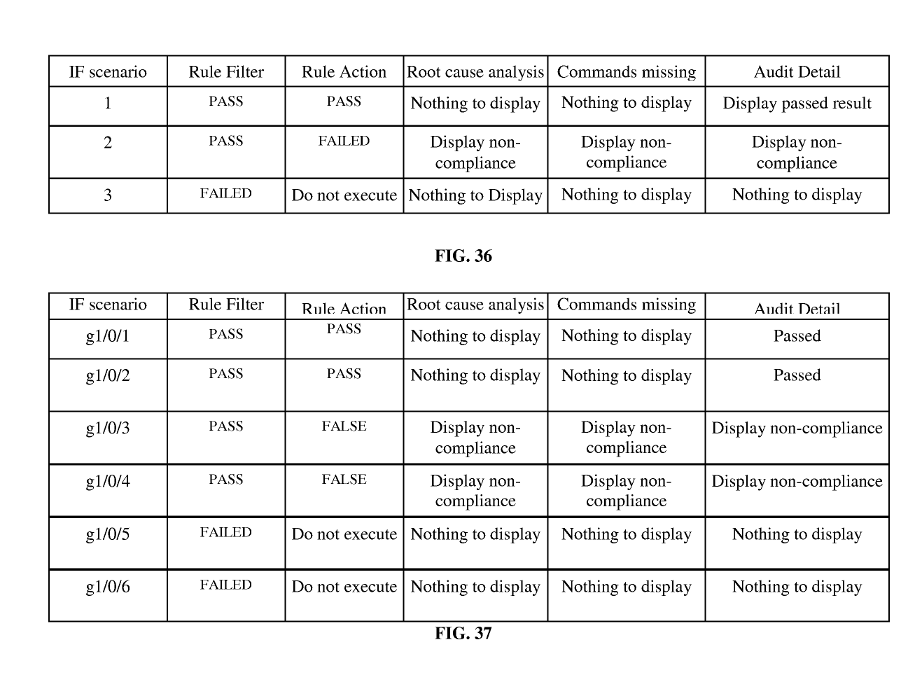

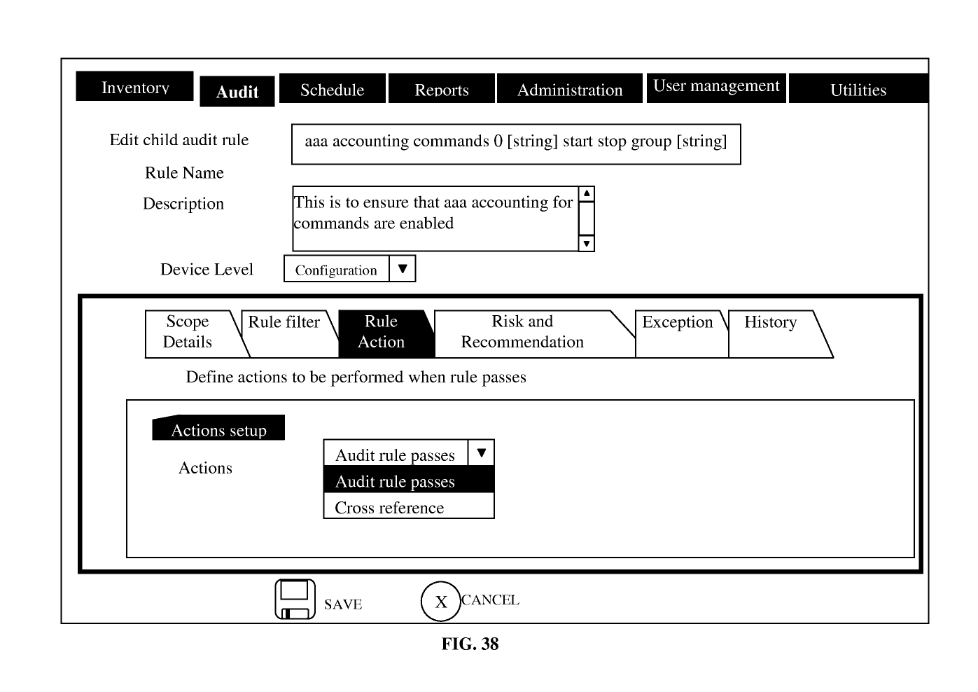

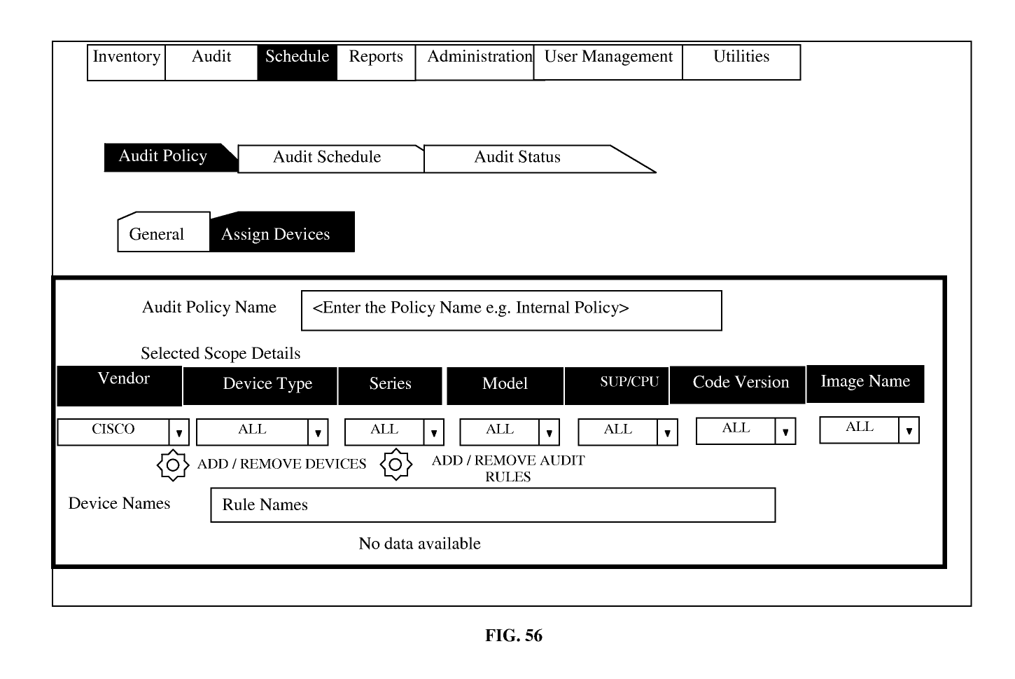

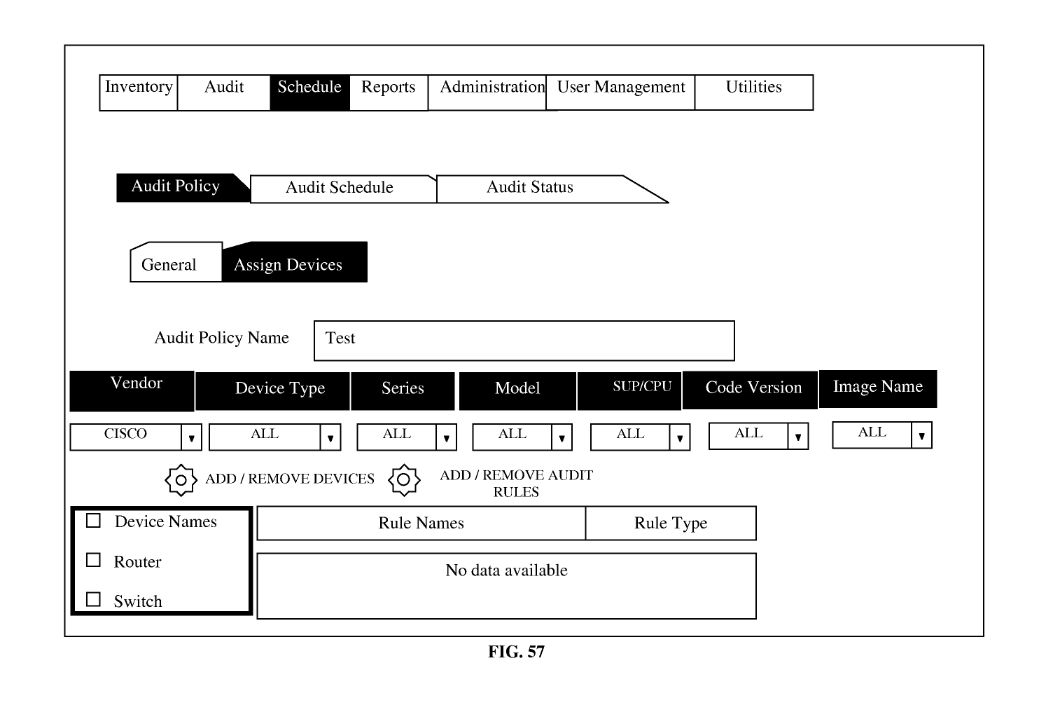

FIGS. 10-64 exemplarily illustrate screenshots of interfaces provided by the audit management system 701 via the graphical user interface (GUI) 701n exemplarily illustrated in FIG. 7, for managing an audit of one or more network layer devices. The user 702 accesses the audit management system 701, for example, using a flash enabled, Java enabled browser application such as Internet Explorer 6 of Microsoft Corporation on a display screen of the user's 702 computing device, for example, a personal computer, a mobile phone, a tablet computer, etc. The user 702 logs into the audit management system 701 over a network 704, for example, the internet by entering user credentials, for example, a username and a password via an interface exemplarily illustrated in FIG. 10. An administrator of the audit management system 701 is also provided a unique username and password. The audit management system 701 enables the user 702 to enter a license key, for example, when the user 702 initially logs into the audit management system 701, when an internet protocol (IP) address of a server hosting the audit management system 701 changes, when the number of network layer devices exceeds the number prescribed by the license, when the number of audits performed by the audit management system 701 has exceeded, when the number of configuration files uploaded per network layer device has exceeded, etc. When the license key expires or the license key is deemed invalid, the audit management system 701 prompts the user 702 to update the license.

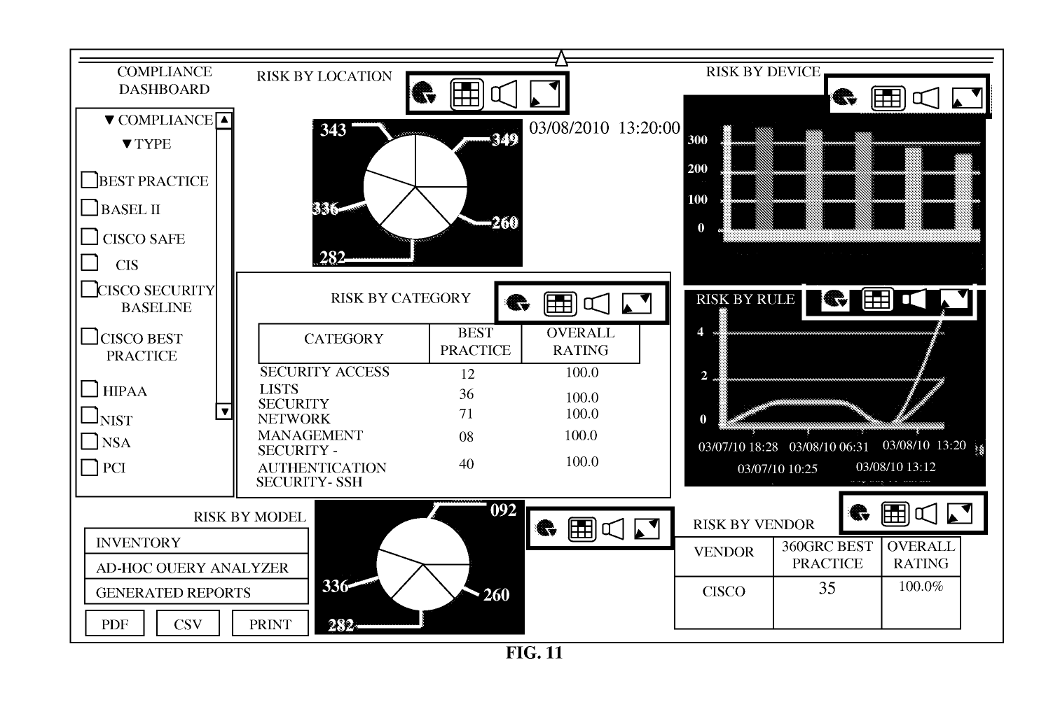

FIG. 11 exemplarily illustrates a screenshot of a dashboard provided by the audit management system 701. The dashboard is the initial interface presented to the user 702 who is logged into the audit management system 701. The dashboard allows the user 702 to get a high-level and accurate view of the infrastructure at a point in time when the last audit was performed by the audit management system 701. The user 702 can also “jump” to previous dates/times to review trends of the infrastructure over time. The dashboard of the audit management system 701 enables, for example, quick access to specific issues of an audit, visualization of a trend on how the audits of the infrastructure are progressing, as well as to manage and reduce risk in the networked environment based on a particular type of security and compliance.

The dashboard of the audit management system 701 is divided, for example, into two sections as exemplarily illustrated in FIG. 11. In one section on the left hand side of the dashboard, the audit management system 701 displays security and audit compliance policies. When the user 702 selects a particular compliance policy on the dashboard, the section on the right hand side of the dashboard reflects the selected compliance policy and items unique to the selected compliance policy. For example, there are six panels on the right hand side of the dashboard displaying the top five compliance failures, the top five riskiest locations, the top five riskiest devices, the top five riskiest categories, the top five riskiest audit rules, the top five riskiest vendor models, the top five riskiest vendor types, etc.

The audit management system 701 displays, for example, a chart view, a score view, a trend line view, a maximize view, etc., on each panel of the dashboard. The chart view displays a bar or pie chart. The score view displays a compliance rating and weighting value along with an overall rating in percentage for a selected compliance for a particular date and time. The trend line view displays, for example, the trend line for the last five audit results for a particular panel. If there is more than one item being presented, the timeline is represented, for example, in different colors for a maximum of five trend lines in any one panel. If a slider provided on the top of the dashboard is moved, the trend line displays the last five audit results based on the date and time selected by the slider. The maximize view displays the chart view, the score view, and the trend line view. The audit management system 701 displays failure results of the last audit performed. At the top center of the dashboard of the audit management, the date and time of the last audit are displayed. The user 702 can move the slider on the dashboard of the audit management system 701 to either the left or the right to see previous audit results. The audit management system 701 updates the date/time as well as each of the panels according to the movement of the slider. The slider can be moved back to review the audit results from up to three years.

The audit management system 701 provides a compliance menu on an interface, as exemplarily illustrated in FIG. 12, to allow the user 702 to access a particular audit and obtain a root cause analysis of each failure. This allows non-compliant items to be viewed easily for each compliance area and for remediation. The compliance menu ensures that the user 702 can navigate to the root cause analysis. The compliance menu displays the results of an entire audit. The compliance menu is divided, for example, into two sections. The first section of the compliance menu comprises the compliance policies. The audit management system 701 updates the second section of the compliance menu when a user 702 selects the different compliance policies on the left panel. The second section of the compliance menu displays, for example, an audit summary, audit visualization, an audit trend line, and audit details.

A display panel is provided on the left hand side of the compliance menu. The audit management system 701 displays panels on the second section of the compliance menu depending on the menu options chosen on the first section of the compliance menu. The audit management system 701 displays compliance menu options, for example, type displaying the compliance policies, risk, and device. The risk options comprise an audit result displaying either passed or failed results, a category for enabling the user 702 to browse through several options, and a rule type for defining a child audit rule, a parent audit rule, or an audit group rule. The device options are divided into locations, vendor, and device category. The location option displays physical or virtual locations where the network layer device is located. The vendor option displays the network layer devices by a device vendor. The device category displays categories to which the network layer devices may be assigned.

The audit summary provides the total of passed or failed items for a particular audit schedule as exemplarily illustrated in FIG. 12. The audit summary results are based on the date and time selected in the audit trend line. The passed or failed results are based on a total represented by either a count value or a percentage value. In this manner, the audit management system 701 allows the user 702 to identify a percentage of failed network layer devices in a particular audit. When the user 702 clicks on the failed results on the audit summary panel of the interface, the audit management system 701 displays the failed results categorized by high, medium, or low risk. In this manner, the audit management system 701 enables the user 702 to identify the audit results by risk category. The audit management system 701 updates the audit visualization, the audit trend line, and audit detail tables when the user 702 clicks on the failed results table. When an audit schedule is executed, the audit management system 701 updates the rules count with failed or passed values based on the network layer device and its configuration file. The audit management system 701 displays the result count on the audit summary in a total audit risk table display on the interface.

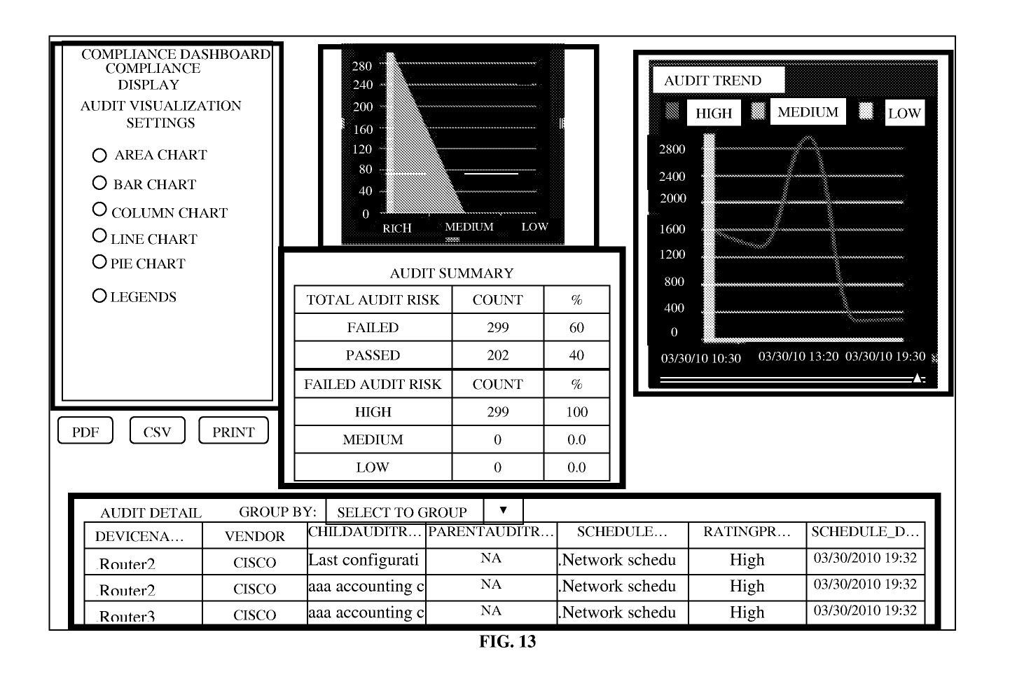

The audit management system 701 updates the audit details when the user 702 clicks on the passed results. The audit management system 701 enables the user 702 to view the failed versus passed audits so that the user 702 is able to remediate. The audit management system 701 reads the audit visualization from the audit summary failed table providing the user 702 with a graphical view of the failed results categorized, for example, by high risk displayed in red, medium risk displayed in orange, and low risk displayed in yellow. The audit management system 701 displays a pie chart that is used to represent the details of the failed audit summary results. The audit management system 701 displays, for example, an area chart, a bar chart, a column chart, a line chart, a pie chart, a plot chart, etc., as exemplarily illustrated in FIG. 13. The audit trend line of the audit management system 701 allows the users 702 to navigate the trend line to view results of a prior audit. The audit trend line is represented by a slider that the user 702 can move to the left or to the right. The audit trend line displays, for example, the trend line for the last five audits. The X-Axis represents the date and time of the previous audits. The Y-axis represents the audit count that is derived from the audit summary failure table. The audit detail section provides a detailed view of the audit schedule. The audit detail section presents all audit rules that have either passed or failed for a given completed audit per network layer device.

The audit management system 701 enables the user 702 to group or ungroup the categories to manipulate the results in the audit schedule. The audit management system 701 displays the output if the user 702 grouped the categories by device name. The user 702 can add or remove columns in the audit detail section to customize the output. The audit management system 701 provides two options to the user 702 under the compliance audit detail setting. The first option enables the user 702 to add details using the audit rules. The user 702 sees additional details for a particular passed or failed audit rule. The second option provided by the audit management system 701 enables the user 702 to add details using an inventory details interface. By adding columns, the user 702 sees additional details for a particular passed or failed audit rule. The audit management system 701 enables customization of each view of each panel. The audit management system 701 resizes the view of the panel when the user 702 moves a graphical icon on the interface either up or down to zoom in or out. The audit management system 701 enables the user 702 to customize the audit detail maximized window and add columns by choosing additional fields in the audit rules or inventory menu. The audit management system 701 enables the user 702 to print details of an audit schedule for outputting the contents of the audit detail section in, for example, a portable document format (PDF) report, a comma-separated values (CSV) report, etc., as exemplarily illustrated in FIG. 13, where the data can be further manipulated.

The audit management system 701 enables the user 702 to view results of a root cause analysis on an interface as exemplarily illustrated in FIG. 14. To view the root cause of the audit schedule in a configuration view, the user 702 can click on any audit finding in the audit detail panel or audit detail maximize window on the interface as exemplarily illustrated in FIG. 14. The root cause window displays the audit files in a view familiar to the user 702 that represents the configuration view of the network layer device. The audit management system 701 allows the user 702 to quickly view the findings, determine the risks, and view the recommendations for remediation. The root cause window displays device details and allows the user 702 to navigate to the root cause for findings of a specific network layer device. The default tab on the root cause window is, for example, the configuration file tab. This configuration file tab displays the findings of the audit schedule as findings appear in the configuration file of the network layer device. The user 702 can click on highlighted lines in the configuration file section to view a non-compliant item and the root cause.

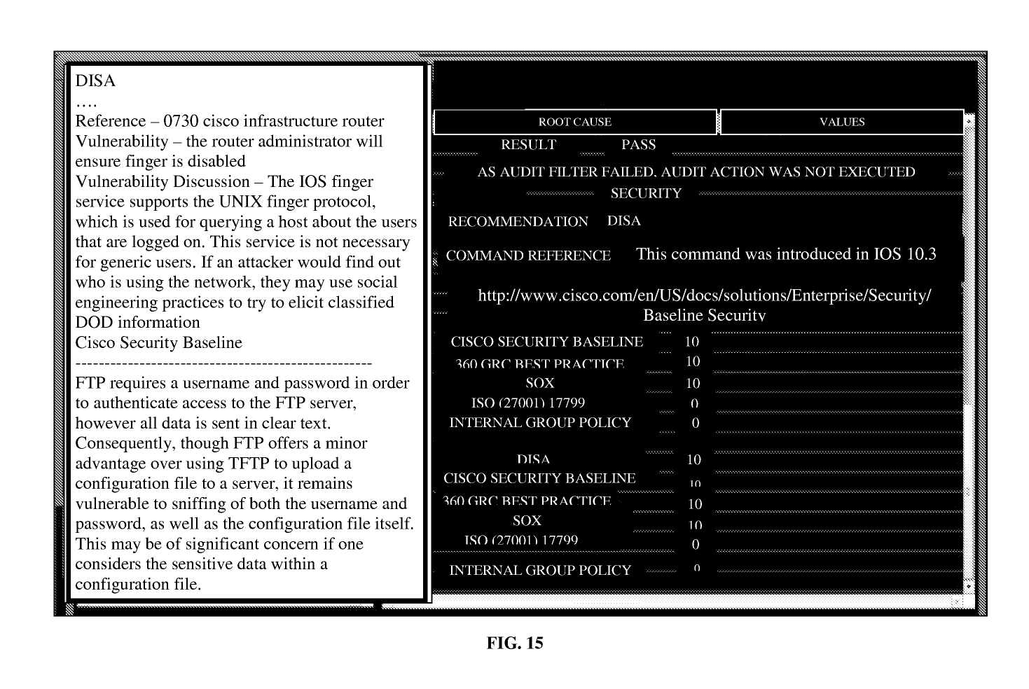

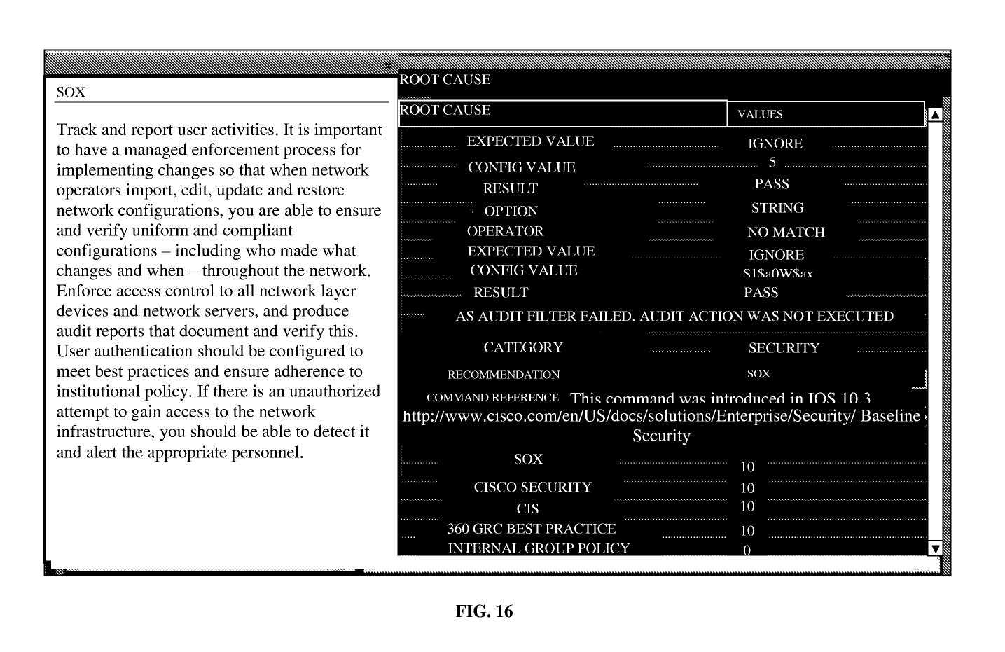

The root cause panel displays the reasons why a particular command in the configuration file did not pass for a given compliance item. The root cause panel displays a number of details, for example, rule name which is the name of the child or parent audit rule, rule description that describes why the audit rule failed, high, medium and low risk ratings that determine the non-compliance rating of a configuration finding, etc. Furthermore, the root cause panel displays scope indicating vendor criteria that matched the audit rule so that the finding is most relevant to the type of network layer device, audit filter rule type, for example, a child audit rule or a parent audit rule. The root cause panel displays the audit filter as a child type indicating the type of command within the configuration file, a risk category identifying the category where the non-compliant command is located, a risk definition that is the actual written compliance finding, etc. If a command fails a schema for object oriented extensible markup language (SOX) compliance, for example, the risk definition field indicates the SOX compliance reference number and the finding details, as exemplarily illustrated in FIGS. 15-16. The user 702 clicks on an icon on the interface to view the non-compliant findings.

The audit management system 701 provides recommendations to remediate the non-compliant command as exemplarily illustrated in FIG. 16. For example, if a command fails under PCI compliance, a field on the interface indicates the PCI compliance recommendation and enables the user 702 to view the recommendation. The root cause panel displays a uniform resource locator (URL) link to the vendor baseline compliance or security baseline.

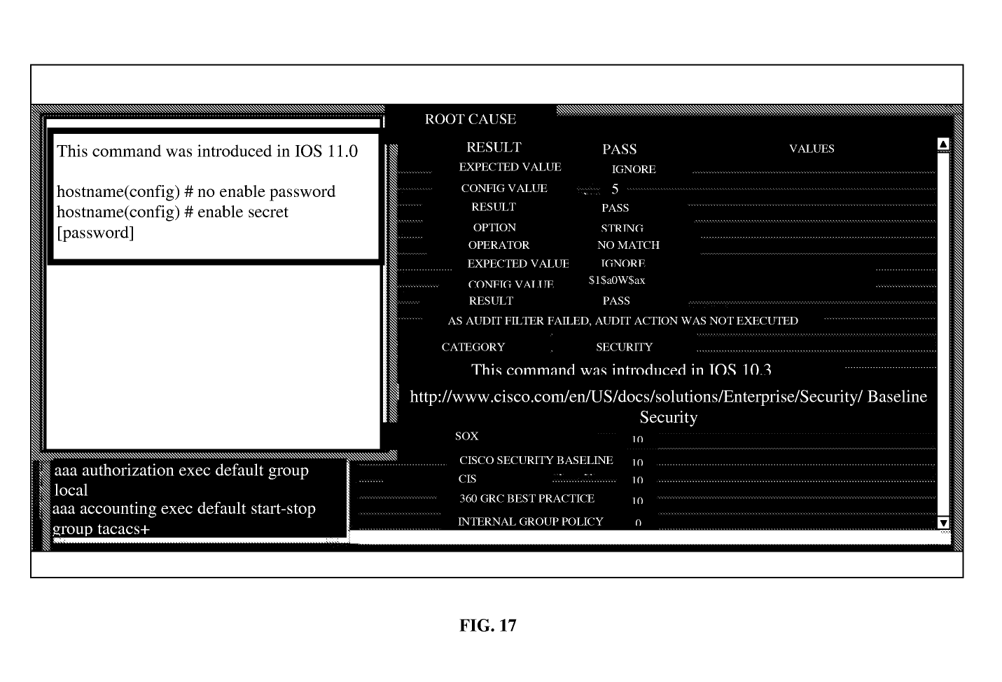

The audit management system 701 provides a command reference guide for each vendor that contains one or more commands needed for remediation as exemplarily illustrated in FIG. 17. The audit management system 701 provides an individual score to each audit check based on the compliance policy. A rating and weighting of 10 means the audit check has a high non-compliant rating. A low rating and weighting represents the opposite or 100% compliance. The audit management system 701 provides a command missing tab on the interface exemplarily illustrated in FIG. 14, for identifying commands that should have been configured in a network layer device but were missing. When the user 702 clicks on any of the findings in the command missing tab, the root cause on the right hand side is updated.

The audit management system 701 identifies audit checks that are part of an audit for a network layer device but are not within the scope of the audit due to one or more factors, for example, a different code version, chassis, etc. The audit management system 701 displays these audit checks under a tab on the interface to ensure against false positives that otherwise would be introduced into the audit. The root cause panel displays the scope to indicate that the audit finding does not fit within the scope of the audit check.

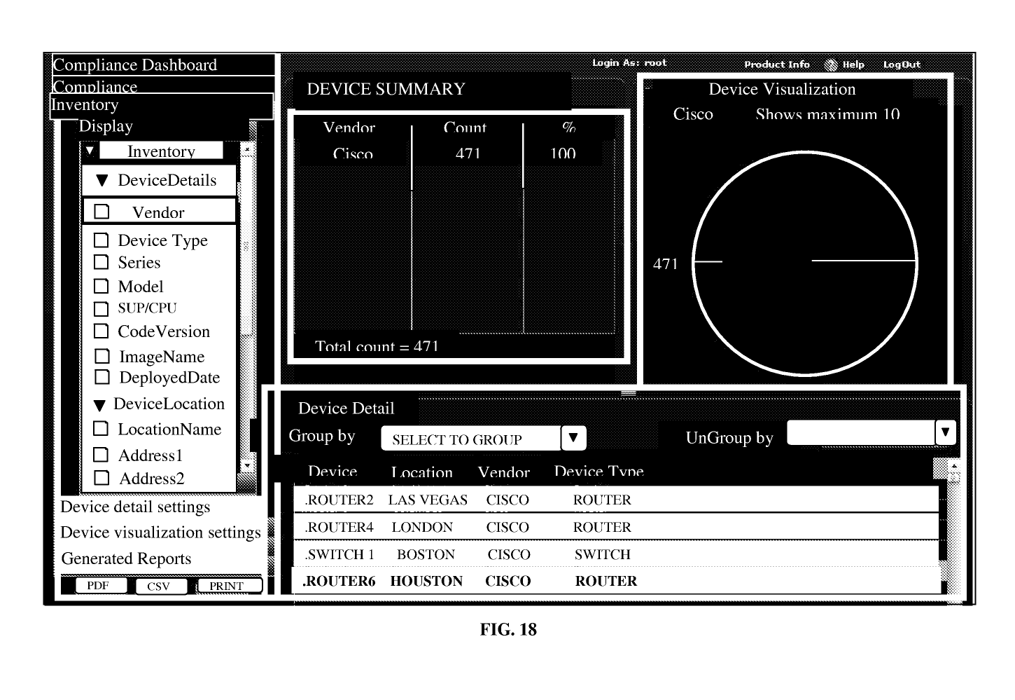

The audit management system 701 allows the user 702 to view the network layer devices in a logical representation, for example, by vendor, series, model, code version, etc., and allows the user 702 to customize an inventory report and print out the inventory report. The audit management system 701 provides an inventory menu screen that is divided into two sections, as exemplarily illustrated in FIG. 18. The left hand section displays the ways the inventory are categorized based on device details comprising information regarding vendor, series, model, etc., device location comprising location name, street address, etc., category details comprising data center, branch, etc., device configuration comprising file name or version, etc. The right hand section of the inventory menu screen comprises panels for device summary, device visualization, and device detail. When the user 702 clicks the categories on the left section of the inventory menu screen, the right section of the inventory menu screen is updated on each of the panels. The device summary panel provides a summarized view broken down by the category chosen in the inventory menu screen. The total is represented by either a count value or a percentage value that allows the user 702 to identify the percentage breakdown for a particular category. The device visualization panel is populated from the device summary table and provides a graphical view of the inventory results. A maximum of ten categorized items are populated in the device visualization panel using, for example, a pie chart, an area chart, a bar chart, a column chart, a line chart, a plot chart, etc.

The device detail panel provides the view of the inventory status as exemplarily illustrated in FIG. 18. The entire inventory can be listed in the device detail panel. The device detail panel is customized by either grouping or ungrouping the categories. The audit management system 701 enables the user 702 to add and remove columns in the device detail panel to customize the output. When the user 702 clicks on the left hand menu under the inventory of the device detail settings menu, the device detail settings menu enables the user 702 to add columns in the device detail panel. By adding columns, the user 702 can view more details on the infrastructure. The view of each panel on the interface is customizable. The audit management system 701 enables the resizing of the view of a panel by moving a graphical icon either up or down to zoom in or out. The audit management system 701 enables the user 702 to customize the reports to be printed out. The user 702 can select the columns that appear in the device detail panel using default columns or by adding or removing columns from the device detail settings menu or the inventory menu. Once the columns have been selected, the user 702 has the option to print, for example, a PDF report, a CSV report, etc., comprising contents of the device detail where the data can be further manipulated.

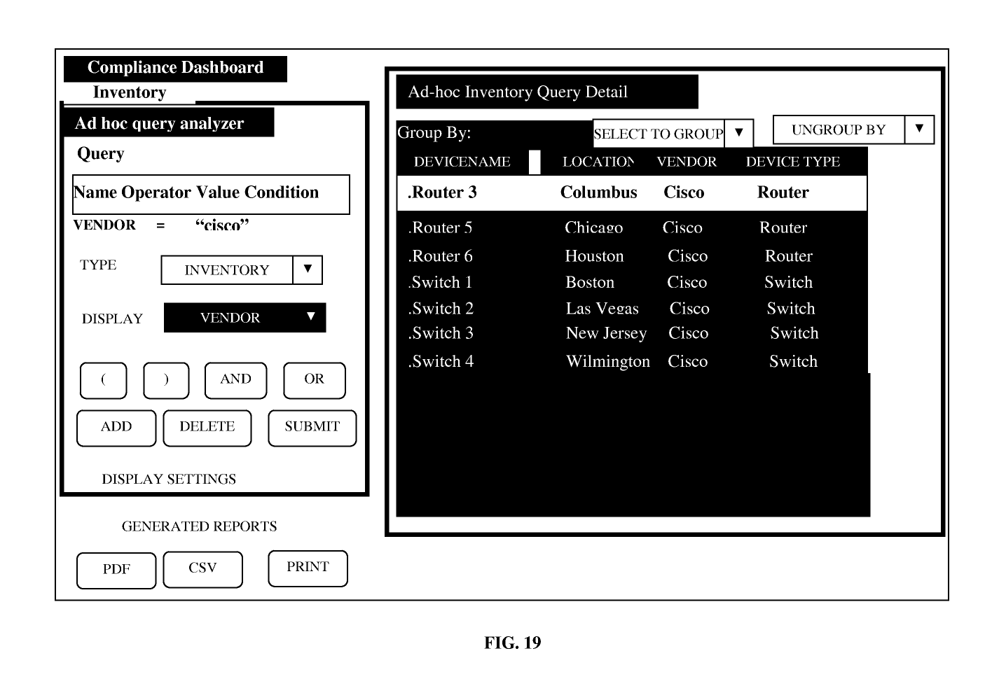

In an embodiment, the audit management system 701 provides an ad-hoc query analyzer (AQA) interface as exemplarily illustrated in FIG. 19. The ad-hoc query analyzer enables the user 702 to run ad-hoc queries using logical conditions based on the last audit schedule. The ad-hoc query analyzer is divided into two panels namely a query panel and a results panel. The query panel provides options that can be chosen to create a custom ad-hoc query. The results of the ad-hoc query are displayed on the results panel. The ad-hoc queries are customizable based on the results of the last audit schedule. The audit management system 701 enables the user 702 to create a custom ad-hoc query, for example, based on the compliance or inventory details, using logic conditions such as AND, OR and NOT operators.

The compliance options provided by the ad-hoc query analyzer interface are type, pass or fail audit result, categories, child audit rule, parent audit rule, audit group, physical or virtual location, and device category. The inventory options that can be chosen by the user 702 to narrow down the ad-hoc query are, for example, the name of the vendor, the type of network layer device, the device family series, the model type of the network layer device, the processor type of the network layer device, code version of the network layer device, the software image name, date the network layer device was deployed, location of the network layer device, additional location details such as address, city, state, country, floor, cabinet, category details of the network layer device, the department of the networks, on-site contact name of the network layer device, on-site contact number of the network layer device, configuration file version of the network layer device, name of the configuration file, the date the configuration file was uploaded into the audit management system 701, etc.

The ad-hoc query analyzer interface enables the user 702 to generate a one-line ad-hoc query in the query panel. The user 702 defines query criteria listing all audit checks, which passed or failed an audit. The user 702 defines either a compliance or inventory ad-hoc query analysis. In an example, if the user 702 runs a compliance query, the compliance policy is chosen on the display option. The user 702 enters the query criteria in the input box. The user 702 adds or deletes a line to the ad-hoc query on the query panel. The user 702 can change the ad-hoc query at any time by clicking the line in question and clicking delete. The user 702 can then submit the ad-hoc query to the query panel. The results are displayed on the results panel located on the right hand side. If the output of the ad-hoc query is too long, the user 702 can group or ungroup the results. When the user 702 clicks a category, the user 702 can expand the group to navigate. By selecting display settings, a user 702 can add or remove columns. To add another line to the ad-hoc query, the user 702 uses the logical conditions, for example, AND or OR. The user 702 can add and remove columns in the results panel to customize the output.

The audit management system 701 allows the user 702 to add details using compliance and audit rules and inventory details sections on the interface as exemplarily illustrated in FIG. 18. By adding columns, the user 702 sees additional details for a particular passed or failed audit rule. The user 702 clicks submit to select additional items. The new columns are displayed in the audit details panel. The audit management system 701 allows the user 702 to add details using the inventory details section. By adding columns, the user 702 can see additional details for a particular passed or failed audit rule. The user 702 can select the columns that appear in the audit detail using the default columns or by adding or removing columns from the audit detail settings menu or the inventory menu. Once the columns have been selected, the user 702 can print a PDF report, a CSV report, etc., or print in any format as exemplarily illustrated in FIG. 18.

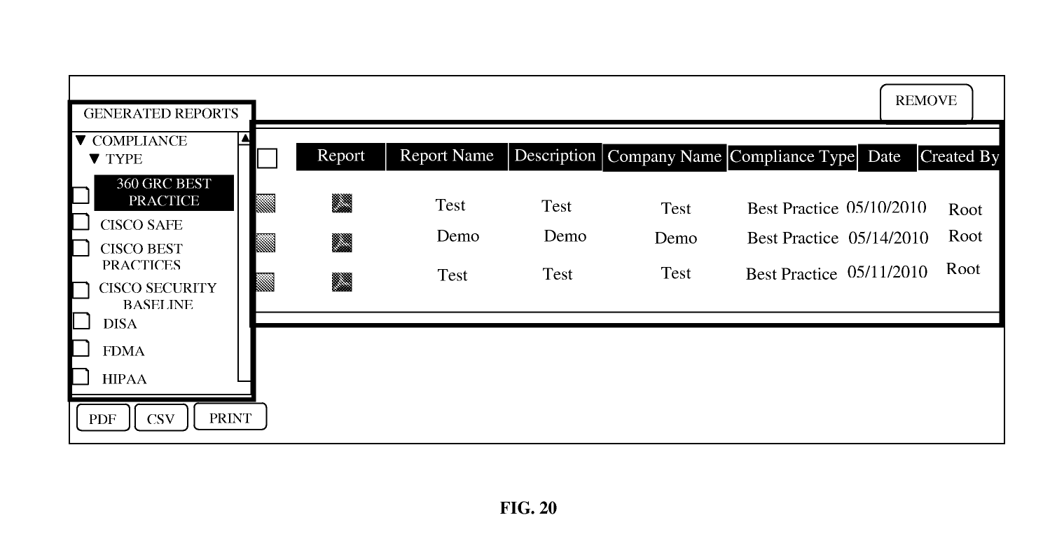

The audit management system 701 allows the users 702 to view and print previously created audit reports in the PDF format. The audit management system 701 provides a “generated reports” screen comprising a left panel and a right panel as exemplarily illustrated in FIG. 20. The left panel is a compliance panel that allows the user 702 to select a compliance policy. The right panel displays the reports corresponding to the selected compliance policy. The compliance panel displays all compliance policies. The audit management system 701 is developed with default compliance policies. However, the audit management system 701 can be customized to include only specific compliance reports based on a user's 702 unique environment. The reports panel appears on the right of the generated reports screen. The reports panel lists the reports that have been historically generated for a specific compliance policy. The reports are, for example, listed in date and time order. The audit management system 701 also enables the user 702 to delete generated reports using a “remove” button on the interface as exemplarily illustrated in FIG. 20.

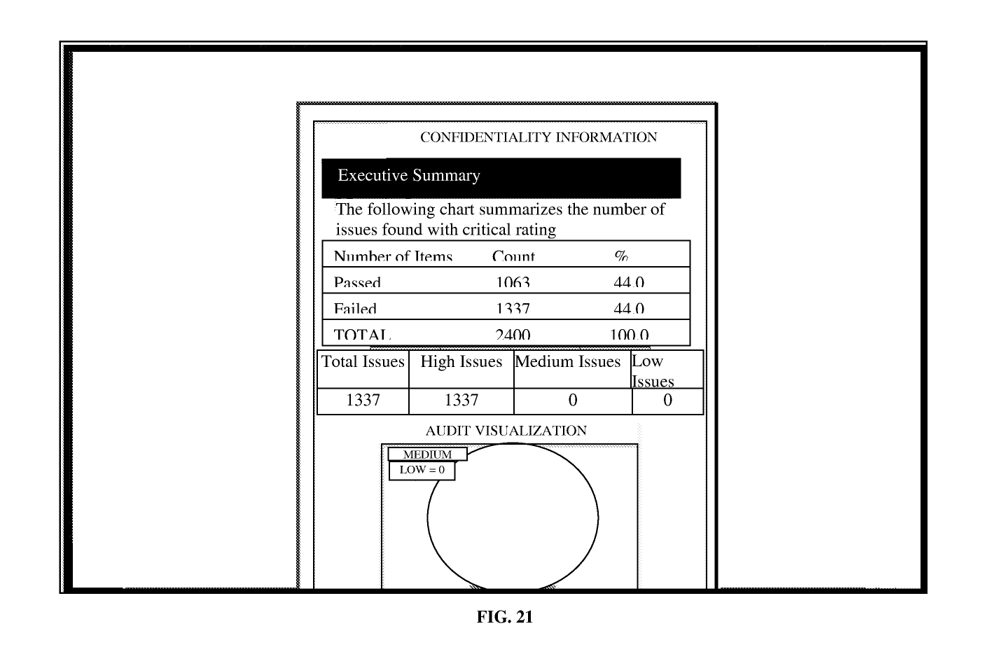

The audit management system 701 generates PDF reports comprising multiple sections, for example, a title, a disclaimer, a table of contents, an executive summary, a summary of high risk vulnerabilities, and compliance details as exemplarily illustrated in FIG. 21. The title recites a background of the report. The contents of the title page can be changed when scheduling an audit. The disclaimer is a standard disclaimer page. The table of contents comprises each failed audit rule displayed in alphabetical order with the page number. The executive summary is a high-level overview of the report as exemplarily illustrated in FIG. 21. The summary of high-risk vulnerabilities provides summarized details of the high-risk vulnerabilities for the scheduled audit. The compliance details comprise each failed audit rule for each network layer device.

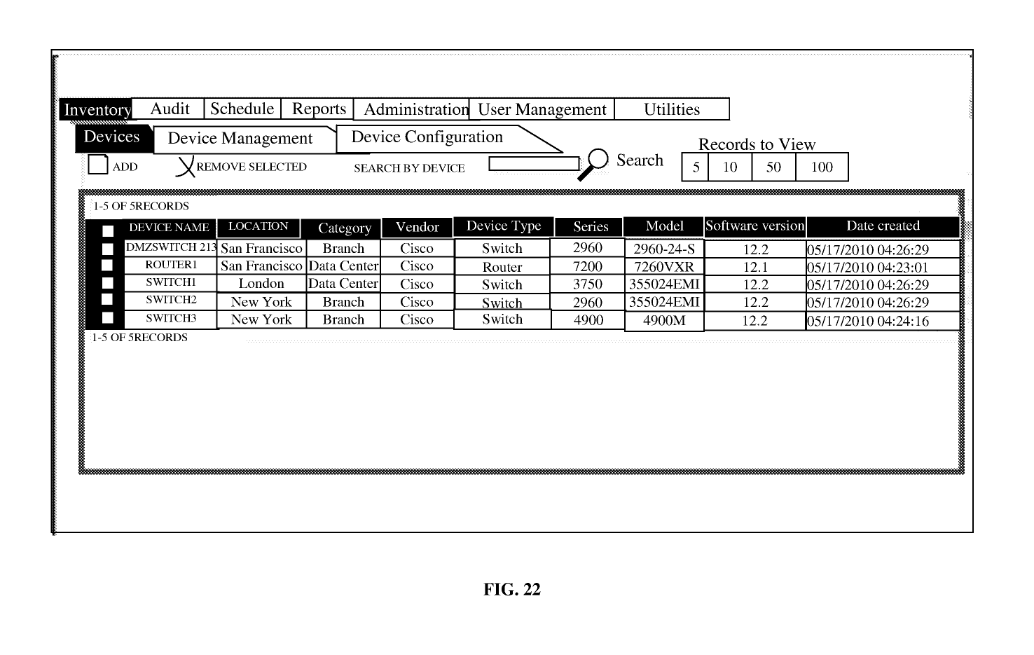

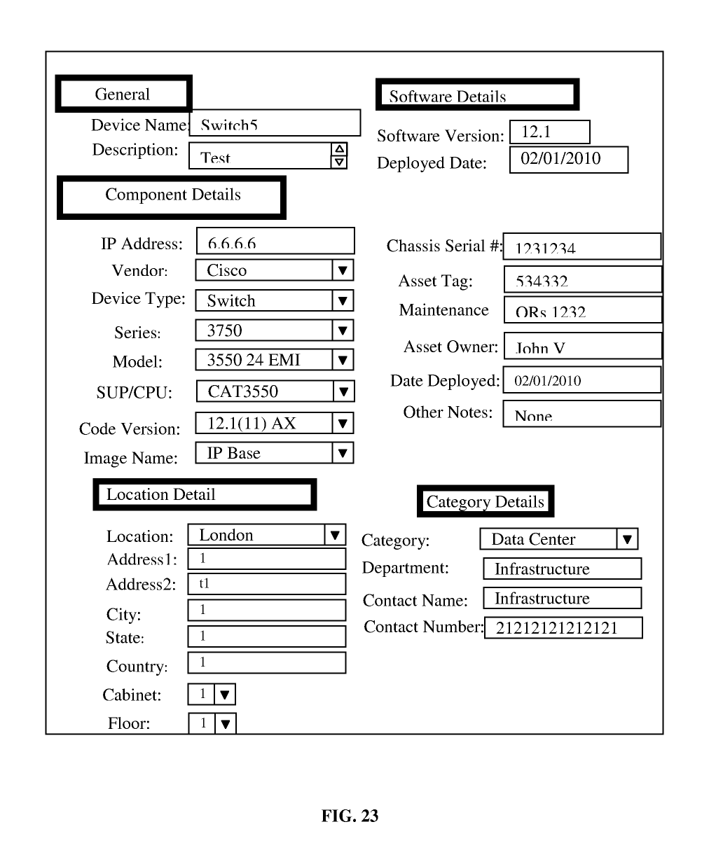

The audit management system 701 provides a detail inventory screen as exemplarily illustrated in FIG. 22. The detail inventory option allows users 702 to add, view or edit device details, make or view configuration changes, add or remove locations and categories for the network layer devices. The detail inventory screen contains three tabs namely “devices”, “device management”, and “device configuration” as exemplarily illustrated in FIG. 22. The devices tab allows the user 702 to manage, for example, add, edit or remove a network layer device in the device inventory. The device management tab allows the user 702 to manage other criteria of the network infrastructure, for example, locations within the infrastructure, categories within the infrastructure, and the type of devices within the infrastructure as exemplarily illustrated in FIG. 23. The device configuration tab allows the user 702 to manage the configuration files for network layer devices within the infrastructure. For example, the user 702 can manually upload new configuration files, control revision numbering, view changes, etc., using the device configuration tab of the detail inventory screen.

When the devices tab is first displayed, the user 702 sees the entire inventory of network layer devices. The devices tab allows the user 702 to manage the network layer devices within the infrastructure individually by individually adding, editing or removing a network layer device from the infrastructure, or in bulk using a device upload utility provided by the audit management system 701.

When running an audit schedule, the audit management system 701 reviews the device details, for example, vendor, model, code version, etc., and uses this information to match against the correct audit rules. Once this is completed, the audit management system 701 provides accurate results in the generated report. If the device details are not correct, the wrong audit check may be run on the network layer device. If the data on each network layer device, for example, location of the network layer device and the category of the network layer device are not accurate, the audit results will not be accurate. The audit management system 701 enables the user 702 to add a new network layer device, remove an existing network layer device, and edit device details.

The audit management system 701 provides an interface that is divided into sections, for example, general, software details, component details, location details, and category details as exemplarily illustrated in FIG. 23. The user 702 enters the name of the new network layer device as well as a small description of the network layer device in the general section. The name of the network layer device must be unique, for example, a globally unique name up to 200 alphanumeric characters, or an error message appears when the user 702 attempts to save the device details. The software details comprise general information on when the network layer device was deployed and the code version of the software on the network layer device. The user 702 selects the component details, for example, the vendor, device type, series, model or the code version for the network layer device, etc., by choosing the drop down boxes on the interface. The audit management system 701 provides audit results whose accuracy depends on the component details, software details, etc. If the details the user 702 is looking for do not exist in the drop down menu, the user 702 can enter the details using the device management vendor menu option on the interface. The user 702 can edit the location details where the network layer device resides by choosing from the location drop down or entering the location using a location menu option. The user 702 can edit the category details by choosing from the category drop down or by entering the category using a category menu option.

Furthermore, the user 702 can remove a network layer device from the device list. If the user 702 tries to remove a network layer device that is part of an audit policy, the audit management system 701 sends an error message stating that the network layer device cannot be removed. In order to remove that network layer device, the user 702 must first remove the network layer device from the audit policy and then remove the network layer device from the device list. The audit management system 701 enables the user 702 to edit device details by clicking on the name of the network layer device. The screen refreshes and displays the details for the network layer device the user 702 wishes to edit. The user 702 can make changes for that network layer device and save the changes on completion.

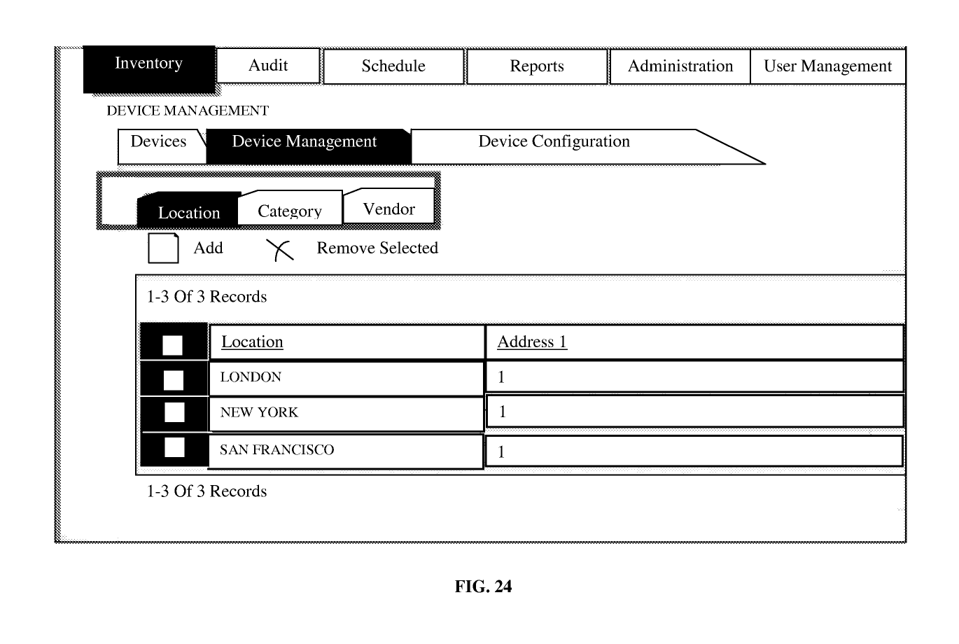

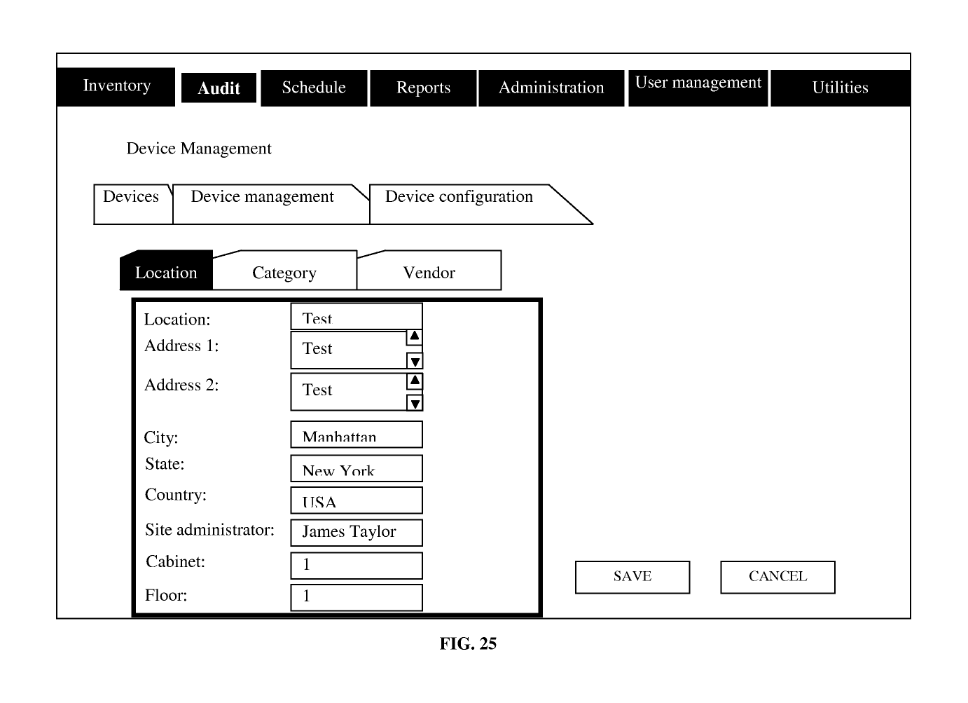

The audit management system 701 provides a device management tab on the interface to add, remove or edit a location and a category as exemplarily illustrated in FIG. 24. When the user 702 first navigates to the location tab, a list of all locations in the inventory is displayed. The location tab allows the user 702 to manage device locations as exemplarily illustrated in FIG. 25. The audit management system 701 requires that the user 702 provides details. For example, when running an audit schedule, the audit management system 701 reviews the device details such as vendor, model, code version, etc., and uses this information to match against the correct audit rules. Once this is completed, the audit management system 701 provides accurate results in the generated report.

The audit management system 701 acquires information from the user 702 such as location, address details, site administrator, etc., via the interface exemplarily illustrated in FIG. 25. If a location has been either created in error or no longer exists in the infrastructure, the audit management system 701 enables the user 702 to remove the location from the list. If the user 702 tries to remove a location that is tied to a network layer device, the audit management system 701 displays an error message to the user 702 stating that the location cannot be removed. In order to remove that location, the user 702 must first remove the location from the network layer device. To edit location details, the user 702 can click on the name of the location to be redirected to the page for the location the user 702 wishes to edit, where the user 702 can make changes to the location.

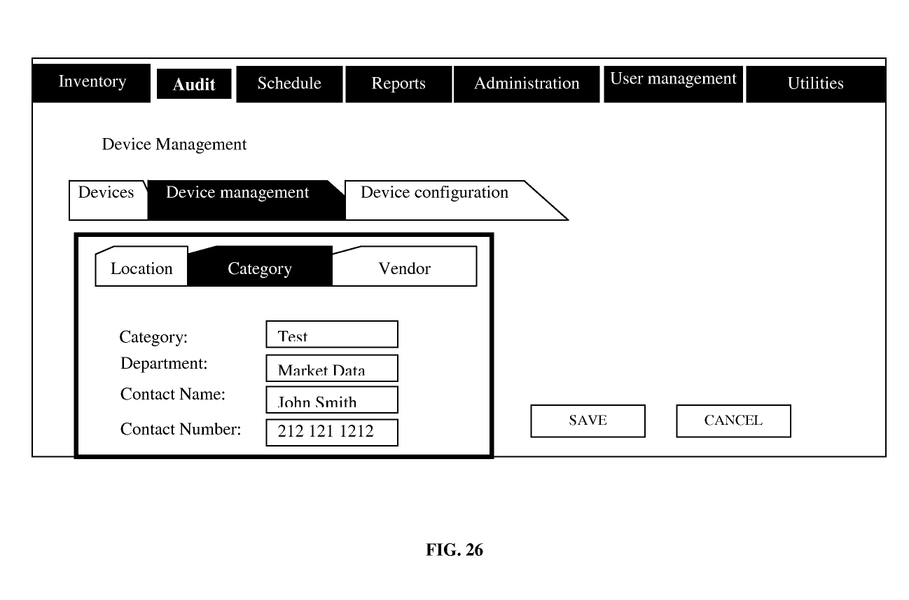

When a user 702 navigates to the category tab as exemplarily illustrated in FIG. 26, the audit management system 701 displays a list of all categories stored in the audit management system 701 in alphabetical order. The category tab allows the user 702 to manage the categories within the infrastructure, for example, data center, internet, intranet, market data, etc. The audit management system 701 enables the user 702 to add a new category to the infrastructure, delete an existing category from the infrastructure, edit the details of an existing category, etc. To add a new category, the user 702 enters details, for example, name of a user-defined category, department details for the user-defined category, contact name and number of the main administrator in charge for that category, etc, as exemplarily illustrated in FIG. 26. To remove an existing item from the list, the user 702 can click a check box on the interface next to the name of the category the user 702 wishes to delete, click on a remove button, and acknowledge to delete the category details. To edit the category details, the user 702 can click on the name of the category to display the details for that category and make changes for that category.

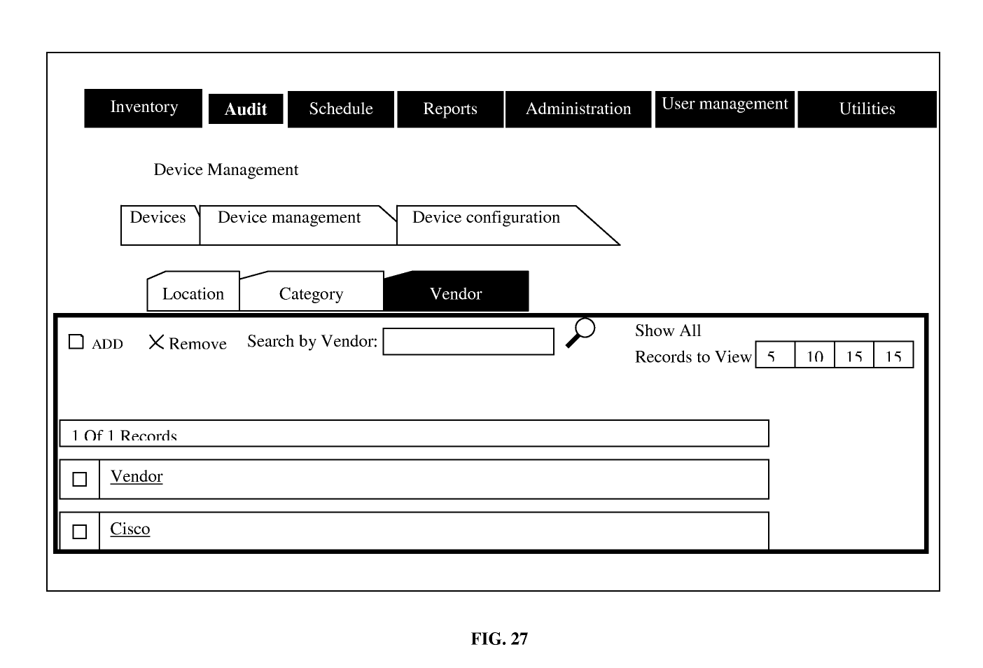

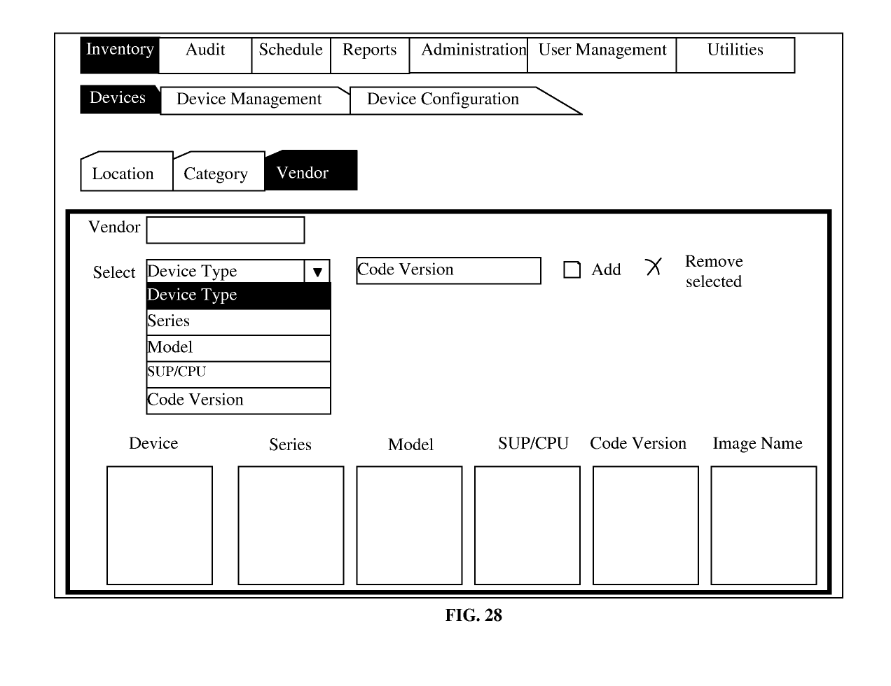

When a user 702 navigates to the vendor tab on the interface as exemplarily illustrated in FIG. 27, the audit management system 701 displays a list of all vendors in the audit management system 701 in alphabetical order for allowing the users 702 to manage the vendors, for example, Cisco Systems®, Inc., Juniper Networks®, Inc., Hewlett-Packard HP®, F5 Networks®, Inc., etc. The audit management system 701 enables the user 702 to add a new vendor, remove a vendor, and edit a vendor using the vendor tab. The audit management system 701 acquires, for example, the name of the vendor, the type of network layer device, the device family, model type of the network layer device, processor type of the network layer device, code version of the network layer device, the software image name, etc., from the user 702 for adding a new vendor as exemplarily illustrated in FIG. 28. To view the vendor information, the user 702 follows the tree structure from left to right by selecting an item. The user 702 removes the vendor details by clicking the item the user 702 wishes to remove and ensuring the item has no details associated to the right of the item. To edit vendor details, the user 702 clicks on an edit menu on the interface and makes changes to the vendor details.

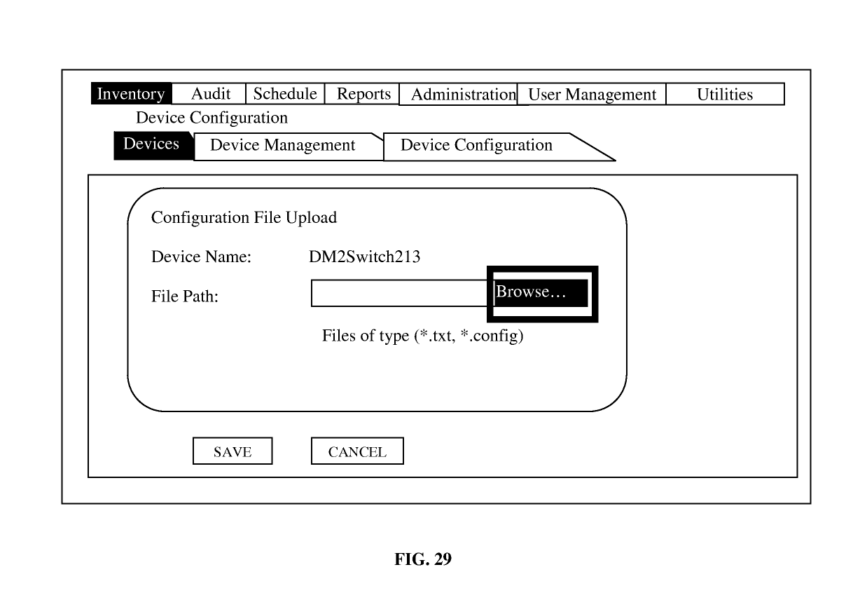

Furthermore, the audit management system 701 provides a screen for device configuration as exemplarily illustrated in FIG. 29, for enabling the user 702 to upload new configuration files, change revision numbers, and compare the changes between revision numbers. As configuration files are uploaded over time, the audit management system 701 saves the previous configuration files to maintain an audit history and, if necessary, to go back and audit against the previous configuration files at any time. When a network layer device has an uploaded configuration file, the audit management system 701 increases the version number by one with each new configuration file upload. The user 702 can upload files with extensions, for example, “.txt” or “.config” into the audit management system 701. To upload a configuration file, the user 702 clicks on the upload icon associated with any device name, browses to where the configuration file is stored, and clicks on the file the user 702 wants to upload as exemplarily illustrated in FIG. 29. The configuration file can be located locally or on a mapped drive. The device configuration screen displays the details by indicating a first time configuration upload by changing the device name to a different color. Subsequent version uploads are indicated by the version number of the network layer device that is incremented by one. The user 702 may click on a device name to view a configuration file.

The current configuration file version is the file which is used in any audit policy for associating with a network layer device. If a network layer device has more than one configuration file, it is possible to revert or forward to another configuration version number. If the user 702 reverts to an older version of the configuration file, the older configuration file becomes the most active configuration file that is used in an audit policy and schedule. The audit management system 701 does not allow removal of the active configuration version. To delete a configuration version, the user 702 clicks an older configuration version in the check box, and clicks to remove configuration.

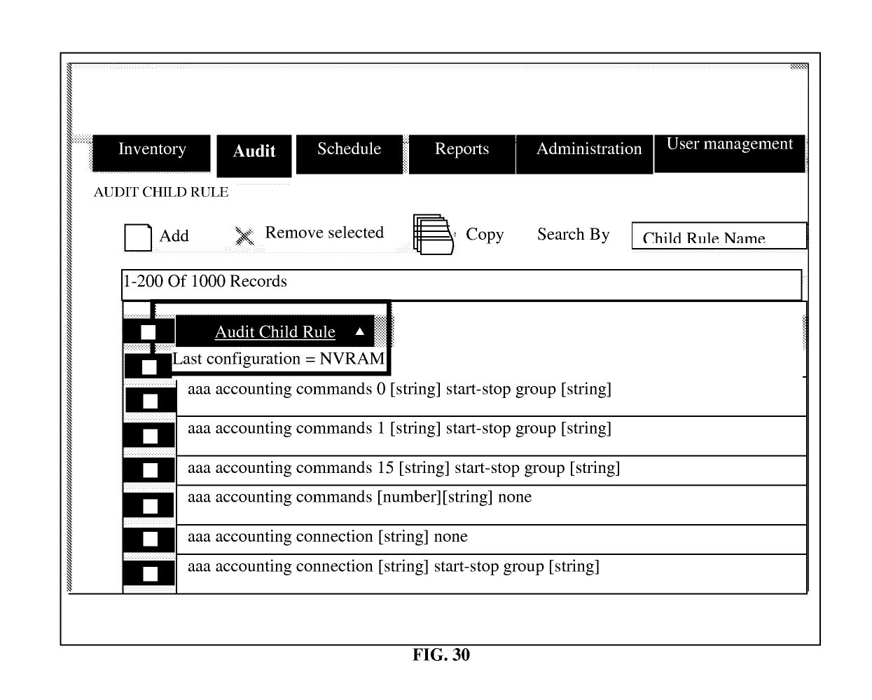

The audit management system 701 provides other features, for example, searching for items within an administration section, setting the page settings on the interfaces of the audit management system 701, and an administration section. The administration section is the back end of the audit management system 701 and allows the user 702 to customize details in order to produce the results of an audit. The administration section provides various options, for example, inventory, audit rules, scheduling of an audit, and other utilities as exemplarily illustrated in FIG. 30.

The user 702 uploads device details manually or using the bulk upload utility. The user 702 uploads the configuration files for the network layer devices. The audit management system 701 provides an inventory menu. The user 702 searches for a device name using the search for device name option on the inventory menu. If the user 702 is not aware of the full name of the network layer device, the user 702 can use wild card masks, for example, s* to display all network layer devices starting with the letter “s”, *1 to display all network layer devices ending with the number 1, etc., to search for the device name. A wild card mask ensures that the user 702 gets one or more device names listed for a search query. The user 702 is able to set the number of records that are displayed on the screen by choosing one of the preset values. The screen updates automatically by clicking one of the values. To select a custom value, the user 702 enters the value in the text box and clicks on set page, whereby the screen updates automatically.

The audit management system 701 performs the audit process as follows. The steps comprise uploading network layer device information, that is, the device details from the infrastructure, uploading configuration files for each of the network layer devices, creating an audit policy by associating network layer devices to audit checks, running an audit schedule by scheduling a date and a time for running the audit checks on the network layer devices within an audit policy, and viewing results of the audit in reports.

An audit policy is the completed coupling of the user-assigned audit checks and the device inventory/configuration files in the infrastructure. Once the audit policy is created, a schedule of the audit policy is then performed. The output of that scheduled policy is the on-screen or PDF report. An audit schedule is a date and a time when an audit policy is executed. The output of that scheduled audit policy is the on-screen or PDF report.

The audit management system 701 allows the user 702 to create a hierarchy of audit checks. An audit group comprises user-assigned child audit rules and parent audit rules together. Audit groups can be referenced within an audit policy, which saves time as the user 702 typically uses the same audit rules repeatedly. A child audit rule provides the user 702 the ability to create a conditional audit check based on a single vendor command, and depending on whether the command exists or does not exist in the actual device configuration file, the results are displayed on the compliance screen. A child audit rule cannot reference any child audit rule. A parent audit rule is similar to a child audit rule only with more features. The parent audit rule allows the user 702 to create conditional audit checks. The conditional child audit rule results provide the user 702 the ability to call other parent audit rules, child audit rules, or customized commands.

The audit management system 701 enables the user 702 to create a new audit rule. In order to create an audit check, the user 702 identifies the details of a specific device series associated with the audit check. The audit management system 701 uses the scope details as a tool to associate network layer devices to audit checks. Defining a rule filter is the first step for creating a conditional audit check. Depending whether the rule is a child audit rule or a parent audit rule, the rule filter is different. Defining a rule action is the second step for creating a conditional audit check. The rule action is similar to an “if then else” statement. This is illustrated with the example: IF “A”=“N”, “THEN” do X, “ELSE” do Y. This allows the user 702 to perform audit checks based on the results of another audit check. Determining risk and providing recommendations is the next step and allows the user 702 to associate a risk description, recommendation description, priority rating and weighting for each compliance policy. This embodiment of the audit management system 701 allows the user 702 to assign each audit check to a compliance policy or internal best practice. Using the exception option for defining an exception is an optional step when creating an audit check, which allows the user 702 to create a condition where a group of network layer devices is excluded during an audit schedule.

Child audit rules are the fundamental building blocks of creating audit checks that are applied to network layer devices listed within the inventory section. The user 702 can create, remove, or edit child audit rules on an interface as exemplarily illustrated in FIGS. 30-31. The user 702 can also customize the child audit rules depending on the vendor and the commands that are required. A child audit rule provides the user 702 with the ability to create a conditional audit check based on a single vendor command and, depending on whether the configuration file command exists or does not exist in the actual device configuration file, the results are displayed on the compliance screen. A child audit rule can be referenced by a parent audit rule or another audit group. However, a child audit rule cannot be referenced by another child audit rule.

The process to create a new child audit rule is as follows. When a user 702 is redirected into the administration section from the front-end section, the child audit rules screen is the first screen displayed as exemplarily illustrated in FIGS. 30-31. In order to create an audit check, the user 702 identifies the details of the specific device series associated with the audit check. The audit management system 701 uses the scope details as a tool to associate network layer devices to audit checks. Defining a rule filter is the first step for creating a conditional audit check by the audit management system 701. Depending on whether the rule is a child audit rule or a parent audit rule, the rule filter is different. Defining a rule action is the second step for creating a conditional audit check by the audit management system 701. The rule action is similar to an “if then else” statement. This is illustrated with the example: IF “A”=“N”, “THEN” do X, “ELSE” do Y. This allows the user 702 to perform checks based on the results of another audit check. Determining risk and providing recommendations is the next step which allows the user 702 to associate a risk description, a recommendation description, a priority rating and weighting for each compliance policy. This embodiment of the audit management system 701 allows the user 702 to assign each audit check to a compliance policy or internal best practice. Using the exception option for defining an exception is an optional step when creating an audit check. This allows the user 702 to create a condition where a group of network layer devices is excluded during an audit schedule.

The audit management system 701 enables the user 702 of the audit management system 701 to create a child audit rule. The audit rules created by the user 702 are listed in the main child audit rule listing screen on the interface as exemplarily illustrated in FIG. 31. The audit rules cannot be deleted by the user 702. If the user 702 tries to delete these audit rules, the audit management system 701 displays a message that the following default audit rules cannot be deleted by the user 702. The audit management system 701 enables the user 702 to change the compliance policy. The audit management system 701 permits the user 702 to copy audit rules. The user 702 can click on the audit rule to edit any aspect of the rule details. The child audit rules can be created, removed or edited. The child audit rules can be customized depending on the vendor and the commands required.

The audit management system 701 enables the user 702 to remove a child audit rule. The audit management system 701 prevents the user 702 from deleting an audit rule if the audit rule is part of an existing audit policy or audit schedule until the audit rule has been removed from the audit policy or audit schedule. The audit management system 701 also enables the user 702 to edit a child audit rule. To edit a child audit rule, the user 702 searches for the name of the child audit rule from the child audit rule name listing screen as exemplarily illustrated in FIG. 31. Once found, the user 702 clicks on the name of the child audit rule to edit the audit rule. When the user 702 clicks within the child audit rule, any audit rule within the child audit rule can be edited.

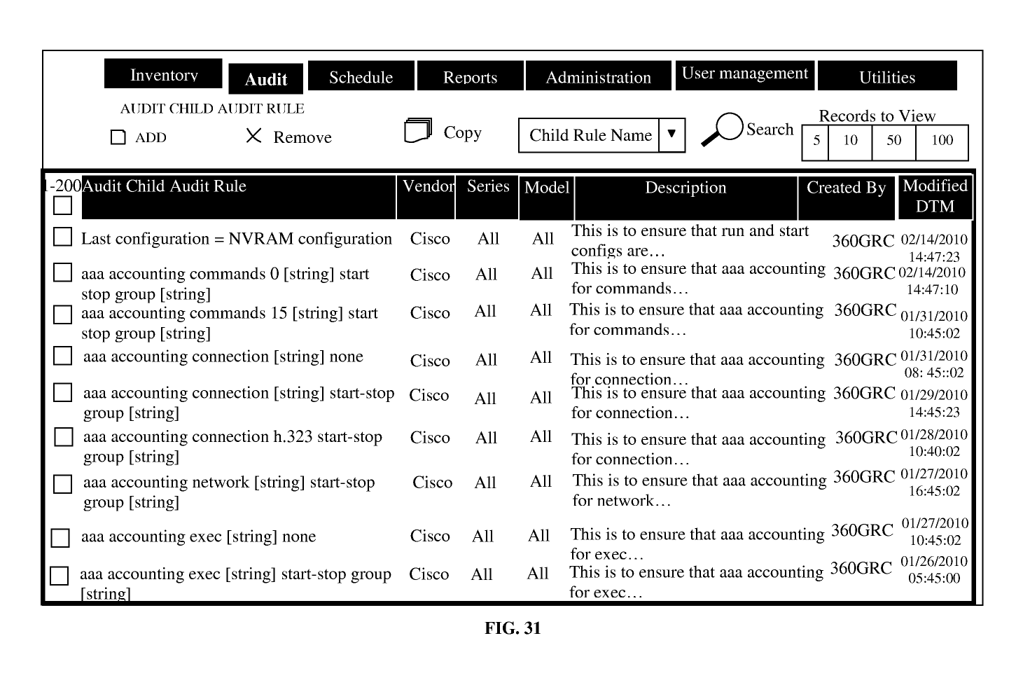

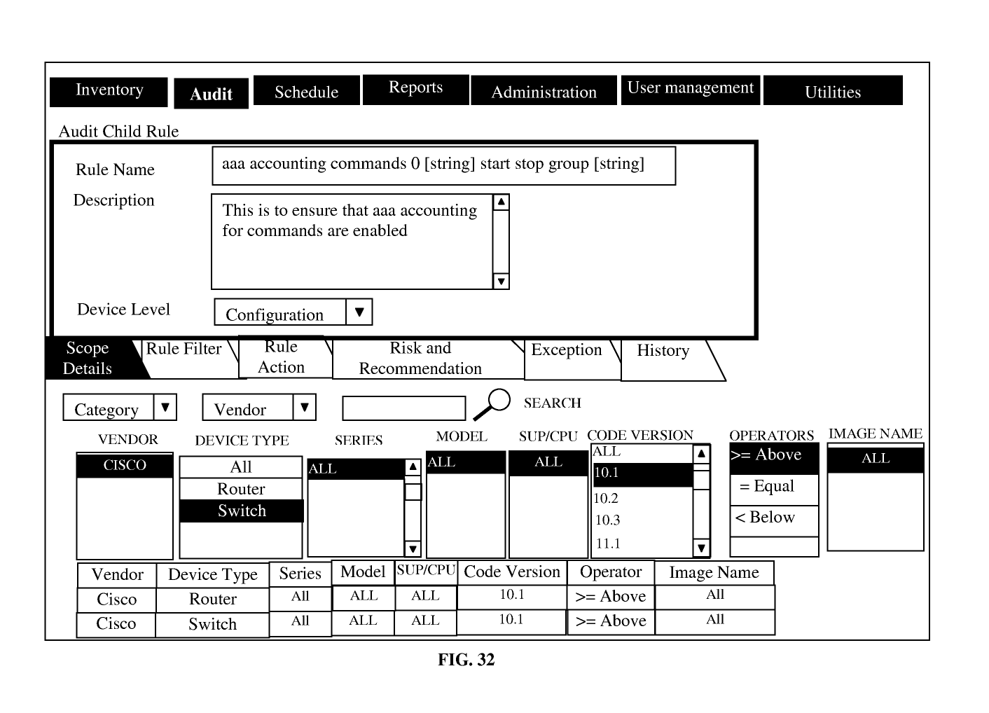

In each of the tabs of the child audit rule, the user 702 can edit the audit rule and description for the child audit rule. The user 702 has to give a unique name to each child audit rule. Each child audit rule can be given a description to highlight the use of the audit check by the user 702. When the user 702 first browses to the child audit rule, during creation of a new child audit rule or editing of a child audit rule, the audit management system 701 redirects the user 702 to the scope detail screen as exemplarily illustrated in FIG. 32. Before creating the audit check, the user 702 has to define the scope around which type of platform and vendor, the audit check must be created. When the user 702 is editing an existing child audit rule, the user 702 cannot change the scope details.

To add a scope to a new child audit rule, the user 702 clicks the vendor and follows the tree down the columns. Once the user 702 has decided on the selection, the user 702 clicks on “add scope” and the choice appears in a table below the selection. The audit management system 701 allows the user 702 to create one audit group across multi-vendor, platform, code versions or image names. The audit management system 701 also enables adding a new platform option to the selection list, removing the selected option by clicking on the check box next to the options in the table to delete the selected option from the list, clearing to begin a new item where a user 702 can clear the current items, etc. For a new child audit rule, the user 702 cannot proceed to the rule filter tab, until a vendor scope has been clearly defined.

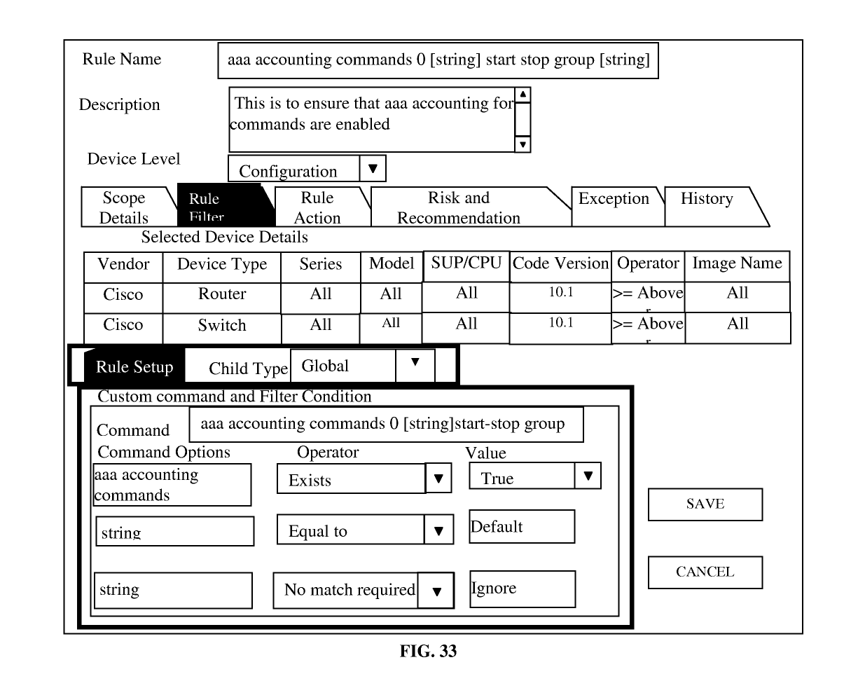

The rule filter tab is the second tab on the child audit rule screen provided by the audit management system 701 as exemplarily illustrated in FIGS. 32-33. The rule filter tab represents the IF condition of the child audit rule. The rule filter tab is divided into two main sections namely rules setup and custom command and filter condition. The user 702 must first define the child type. There are sections within the vendor configuration to create the audit check for that section. The user 702 chooses the vendor specific commands based on the child types chosen. There are multiple child types in the rules setup. The user 702 can select the “ALL” vendor command when the user 702 is not too sure under which child type the command resides. The user 702 can select the “auxiliary” vendor command that resides within the “line aux 0” section of a vendor configuration command. Any keyword may be displayed as the auxiliary number. However, the user 702 can make the audit check more specific and define the exact auxiliary port number, for example, zero, one or two, etc. The user 702 can select the “banner” vendor command that resides within the banner exec, banner motd, banner incoming or banner login. The user 702 enters the text that needs to match exactly with the device configuration. If the user 702 needs it to match all banner types, the user 702 chooses all keywords for the banner type. If the user 702 wants to make the audit rule more specific, the user 702 chooses a more specific banner type. The user 702 can select the “class-map” vendor command that resides within the class-map section of a device configuration. Class-map can have various types, for example, match-any, match-all or generic ALL keyword. The user 702 can look for any class-map name using the “any” keyword or the user 702 can make it more specific. The user 702 can select the “console” vendor command that resides within the console section, for example, line con 0. In the command section, only the commands under the console section are listed, for example, no exec, transport output none, etc. The “any” keyword is displayed as the console number; however, the user 702 can make the audit check more specific and define the exact console port number, for example, zero, one or two, etc. The user 702 can also select the “global” vendor command that resides in the global section of the device configuration. The majority of the commands typically are within this section.

There are a number of interface types for creating an audit rule specifically within “all” interfaces, “any” interface or a specific type of interface, for example, a gigabit Ethernet where the command check resides, for example, speed 1000 or duplex full. Once the user 702 has chosen the interface type, a further option is available to define the chassis, blade or interface detail. The user 702 has options to choose any interface numbers, all interface numbers, and every interface number. The user 702 can also select the “policy-map” vendor command that resides within the policy-map section of a device configuration. Policy-map can have various names and the “any” keyword is used for policy-map and class-map names to make the audit check generic to all policy-maps for the configuration file of the network layer device. The user 702 can also select the “router” vendor command that resides within the router section of a device configuration. This check is specifically for a particular type of routing protocol, for example, BGP, EIGRP or for ALL protocols. The user 702 can also select the “route-map” vendor command that resides within the route-map section of a device configuration. A route-map must have a name, a number, and a permit or deny condition. The “any” keyword is used to make the check generic to any route-map. If a more specific route-map check is required, the user 702 enters the matching characters. The user 702 can also select the “VLAN” vendor command that resides within the VLAN section of a device configuration. A VLAN is the layer two interface on the network layer device and is not the layer 3 “interface vlan x”. VLAN may have a number associated with it, or VLAN has the “any” keyword to apply the check to all the VLAN interfaces in the actual configuration file. The user 702 can also select the “VTY” vendor command that resides within the VTY interface section of a device configuration. Typically, two VTY types of interfaces are configured on a vendor device VTY 0 4 and VTY 5 15. The user 702 creates two audit rules to check for conditions for these VTY ranges or they can generically use the “any” keyword to check for a condition for all VTY interfaces.

The user 702 utilizes the rule filter tab on the interface provided by the audit management system 701, as exemplarily illustrated in FIGS. 32-33, to select the vendor specific commands based on the child types chosen. If the user 702 is unsure of the exact vendor command, based on the scope details and the child type chosen, the audit management system 701 displays the nearest match. Once the user 702 has chosen the exact vendor command, the next step is to choose the filter condition. The filter condition is the actual condition the user 702 wishes to create for the audit check. The filter condition lists the keyword first and then the other options within the command.

The rule action tab is the third tab within the child audit rule as exemplarily illustrated in FIGS. 32-33. The rule action tab represents the “then else” condition of the child audit rule, that is, when the rules filter condition passes what is the next action the user 702 would like to perform. The user 702 has two action choices, namely, “audit rules passes” and “cross reference”. “Audit rules passes” means that if the rules filter condition passes, then there is no other condition that needs to be evaluated. A “cross reference” means that if the rules filter condition passes, then another condition is necessary to be evaluated. The user 702 may use a rules filter, which is the cross referencing element that allows the user 702 to first pull an actual value from the configuration file, and then apply that value for that particular option to another audit command. The user 702 applies the cross reference feature and the use rule filter to any child audit. In this manner, the audit management system 701 allows the user 702 the flexibility to create comprehensive and accurate audit checks or audit rules. The only exception comes for the interface options and by using “every” in the interface value.

The risk and recommendation tab on the interface provided by the audit management system 701, as exemplarily illustrated in FIGS. 32-33, is the fourth tab for the child audit rule and is divided into three sections namely risk, recommendation, rating and weighting. The risk and recommendation tab allows the user 702 to define the risk and recommendation for an audit check where the condition has not passed. If the condition has not passed, the failed condition is displayed in the compliance section and the PDF reports. The risk section allows the user 702 to define the details for non-compliance. The user 702 is able to choose a category, risk definition and audit check rating for the risk section. The recommendation section allows the user 702 to select a category for the audit check, write a definition to highlight the non-compliance risk recommendation, place the recommendation within the specific child type, enter the correct command that should be used should the audit check fail, enter text up to three thousand alphanumeric characters, enter a uniform resource locator (URL) that redirects the user 702 to an online web reference in the root cause window for an audit check, etc. The rating and weighting section allows the user 702 to associate each child audit rule, for example, with up to about six compliances. The user 702 can select the compliance policy, a rating value given to the audit check should the audit check fail, etc., for rating. The objective of weighting is to provide an average score for an audit rule. The user 702 can select the compliance policy, a rating value given to the audit check should the audit check fail, etc., for weighting.

The exception tab is the fifth tab for the child audit rule as exemplarily illustrated in FIGS. 32-33. The exception tab allows the user 702 to define when not to apply a given audit rule even though the audit rule is selected within an audit policy. By choosing an available location or category, the user 702 can select the device name for the exception. By checking off the box on the interface, the user 702 has the option to ensure the audit check is not applied within a certain recurrence or at a specific date and time. The history tab is the last tab available for the child audit rule as exemplarily illustrated in FIGS. 32-33. The history tab only appears when editing an existing audit rule and not when creating a new one. The history tab provides an audit trail by allowing the user 702 to have visibility on who changed the details in one of the tabs. At the history tab, the user 702 can view, for example, date modified, user name of the user 702 who modified the audit rule, tab name of the tab which was modified, field name of the option value that was modified, previous value which was assigned to the option, updated value assigned to the option, etc.

The audit management system 701 enables the user 702 to create a new child audit rule by providing a unique name as a rule name for the new child audit rule and by providing a rule description for each child audit rule as exemplarily illustrated in FIG. 32. The user 702 enters the scope details for the new child audit rule. The rule filter tab, as exemplarily illustrated in FIG. 33, represents the IF condition of the child audit rule. The user 702 must first define the child type and then choose the vendor specific commands based on the child types chosen to create the audit check. The user 702 can create a filter to define the condition for the audit check as exemplarily illustrated in FIGS. 34-37. Once the rule filter tab selection is completed, the user 702 selects the rule action tab as exemplarily illustrated in FIG. 38. The rule action tab represents the “then else” condition of the child audit rule, that is, when the rules filter condition passes what is the next action the user 702 would like to perform. The user 702 has two action choices, namely, “audit rules passes” and “cross reference”. The “audit rules pass” means that if the rules filter condition passes, then there is no other condition that needs to be evaluated. If the rules filter condition passes, then another condition is necessary to be evaluated.

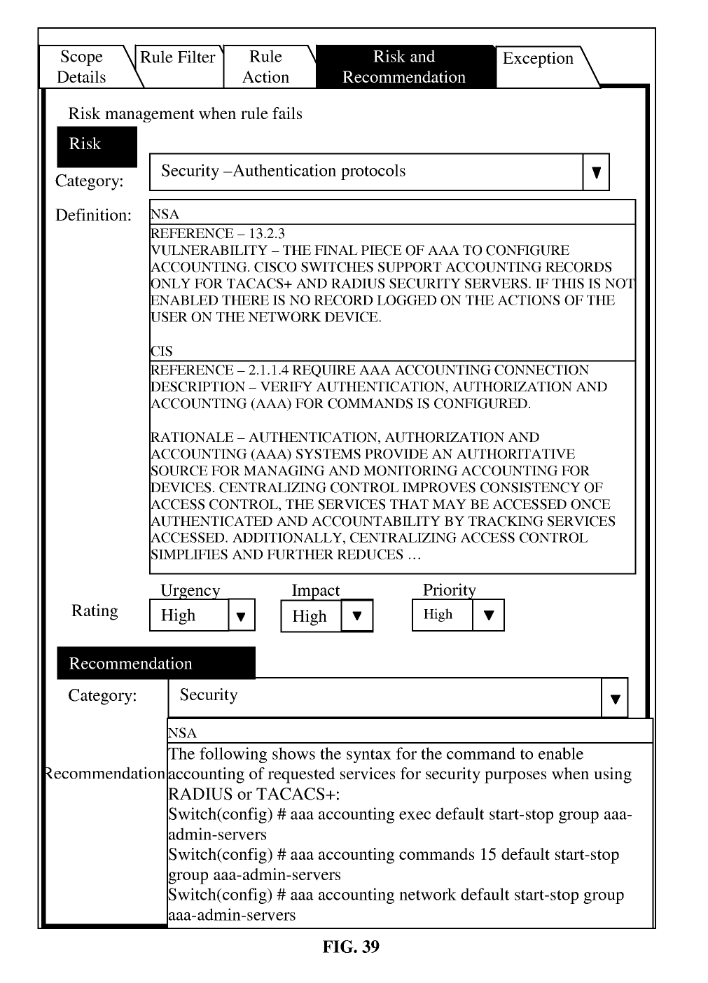

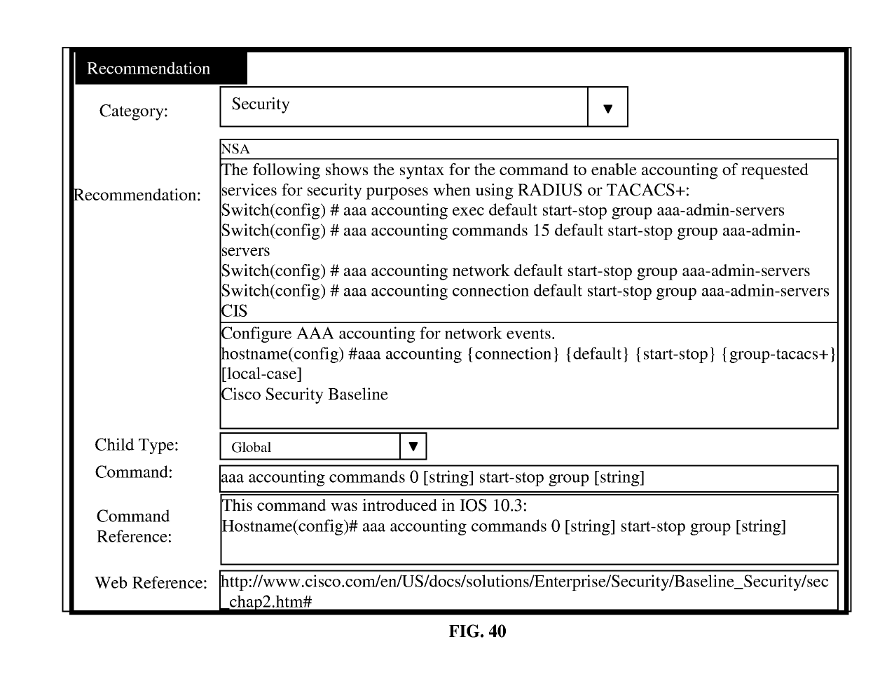

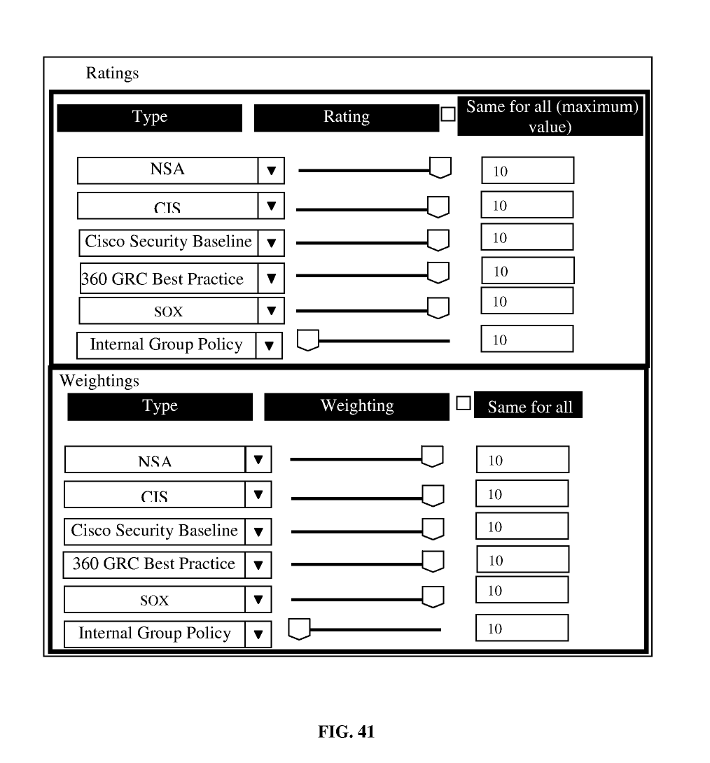

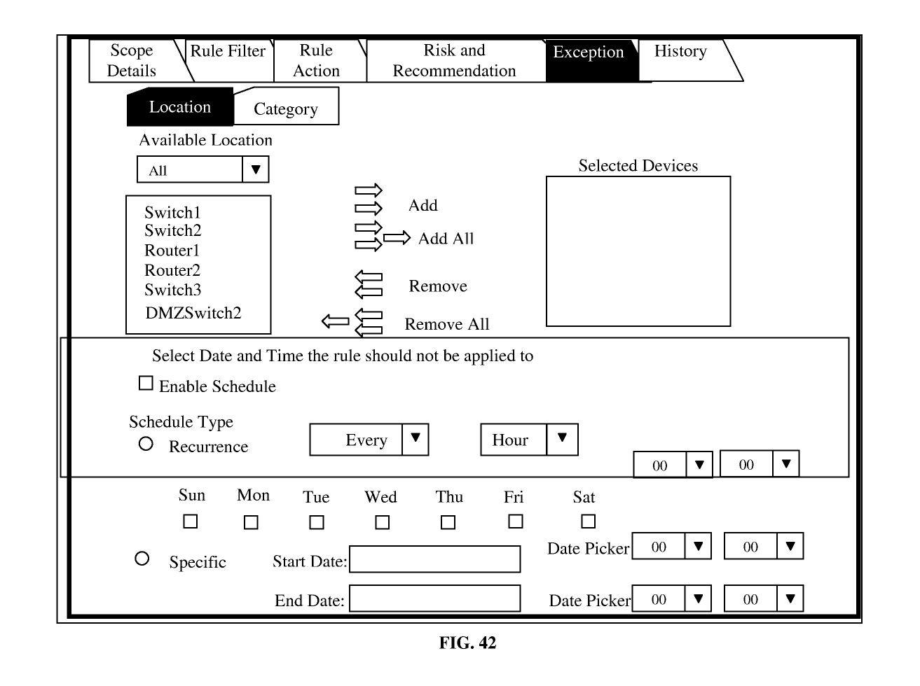

The risk and recommendation section, as exemplarily illustrated in FIG. 39, is divided into three sections namely risk, recommendation, and rating and weighting. The user 702 chooses the risk category, risk non-compliance details, and the risk priority of the audit rules. The user 702 completes the recommendation section to make recommendations to ensure compliance as exemplarily illustrated in FIG. 40. For each child audit rule, the user 702 enters the rating and weighting for that audit rule and assigns the rating and weighting up to six compliance policies as exemplarily illustrated in FIG. 41. The scoring value ranges from zero that indicates it is not relevant to any compliance policy or from one to ten where ten is the highest rating. The exception tab, as exemplarily illustrated in FIG. 42, is the fifth tab for the child audit rule. This allows the user 702 to define when not to apply a given audit rule even though the audit rule is selected within an audit policy.

Parent audit rules are similar to child audit rules. The parent audit rules allow the user 702 to create “conditional” audit checks or “conditional” child audit rules thereby providing the user 702 with the ability to call other parent audit rules, child audit rules, or customized commands. A parent audit rule can be referenced by another parent audit rule or another audit group. However, a parent audit rule cannot be referenced by another child audit rule.

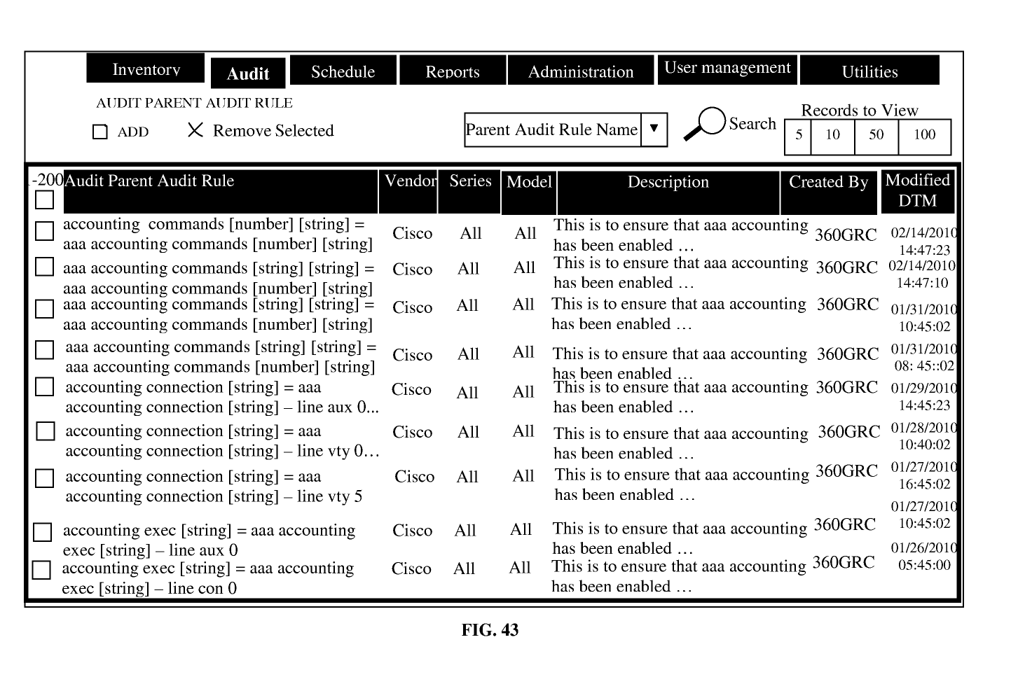

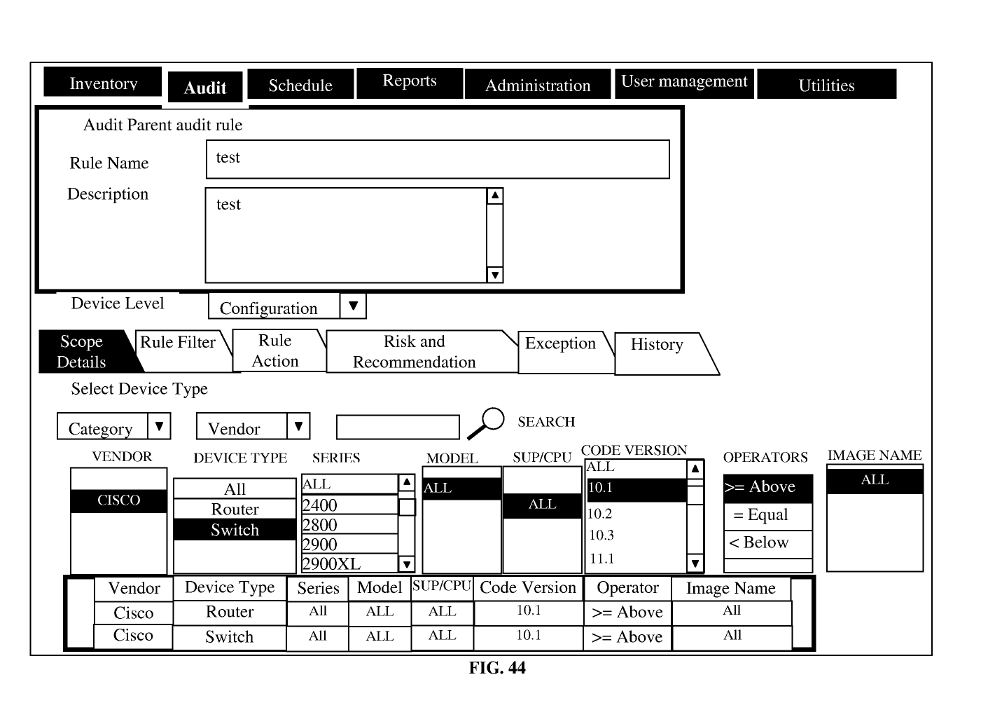

The main parent audit rule listing screen, as exemplarily illustrated in FIG. 43, is similar to the screen for listing the child audit rules. The options for creating a new parent audit rule comprise a scope detail, a rule filter, a rule action, a risk and recommendation, and an exception as exemplarily illustrated in FIG. 44. In order to create an audit check, the user 702 identifies the details of a specific network layer device in the series with which the audit check is associated. The audit management system 701 uses the scope details as a tool to associate network layer devices for audit checks. Defining a rule filter is the first step for creating a conditional audit check. The rule filter is dependent on the associated audit rule, that is, the child audit rule or the parent audit rule and varies accordingly. Defining a rule action is the second step for creating a conditional audit check. The action can be linked to an “IF-THEN-ELSE” statement. For example IF “A”=“N”, “THEN” do X, “ELSE” do Y. Defining a rule action is also called X-referencing. The rule action allows the user 702 to perform checks based on the results of another check. Defining the risk and recommendation is the third step for creating a conditional audit check. The risk and recommendation step allows the user 702 to associate a risk description, recommendation description, priority rating and weighting for each compliance policy. The risk and recommendation step allows the user 702 to assign each audit check to a compliant policy or internal best practice. The last step for conditional audit check is defining an exception using the exception option. This step is an optional step when creating a conditional audit check. This allows the user 702 to create a condition where a group of network layer devices is excluded during an audit schedule. In each of the tabs of the parent audit rule, the user 702 can add and edit the audit rule and description to highlight the use of the audit check.

When the user 702 first enters a parent audit rule, for example, by creating a new audit rule or editing an existing audit rule, the user 702 is redirected to the “scope details” interface as exemplarily illustrated in FIG. 44. Before creating an audit check, the user 702 has to define the scope around the type of platform and vendor for which the audit check has to be created. The information of scope around a vendor and type of platform can be obtained from the audit management system 701 through an interface that contains the vendor information as exemplarily illustrated in FIG. 44. The “scope details” interface displays information, for example, a vendor, a device type, the series of the network layer device, the model type of the network layer device, the type of processor of the network layer device, for example, CPU/SUP, a code version for the network layer device, and image name associated with the network layer device. To add a scope to a new parent audit rule, the user 702 can select a vendor and add the scope. The audit management system 701 allows the user 702 to create one audit group across multiple vendors, platforms, code versions, and image names. On a rule group interface, the user 702 can add a new platform, remove a platform from the list, or clear the current items. For a new parent audit rule, the user 702 cannot proceed to the rule filter tab in the audit management system 701, until a vendor scope has been clearly defined.

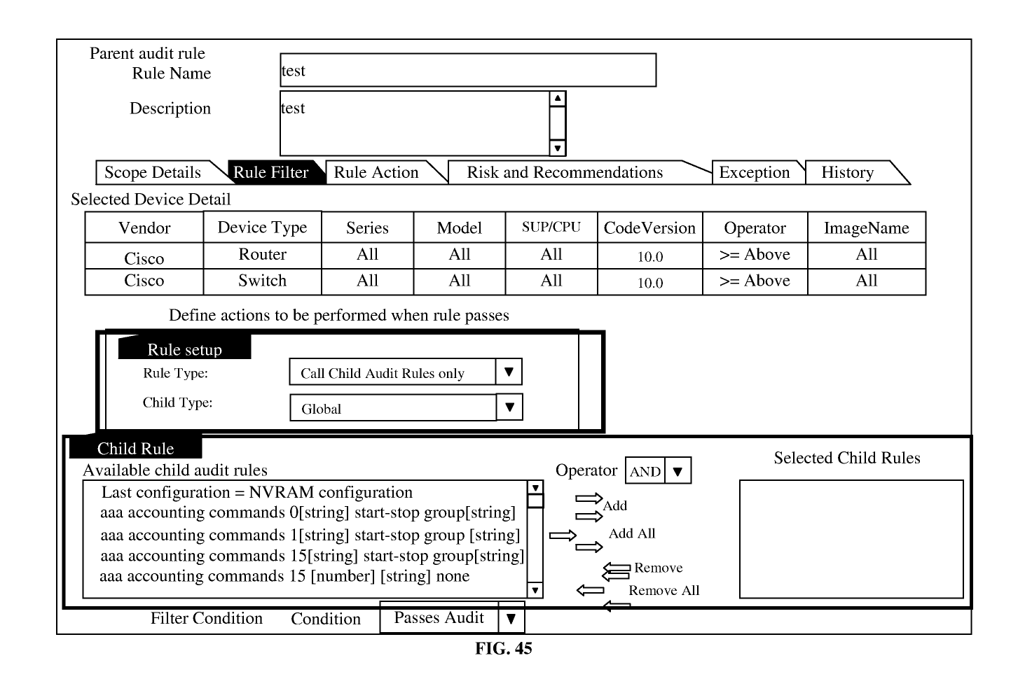

The rule filter tab is an interface within the parent audit rule as exemplarily illustrated in FIG. 45. The rule filter tab represents the IF condition of the parent audit rule. The rule filter tab comprises sections, for example, a “rule setup” section, a “call” section, and a “filter condition” section. The user 702 must define in the “rule setup” section, for example, the “rule type” and “child type” as exemplarily illustrated in FIG. 45. There are three different rule types, for example, a call parent audit rule, a call child audit rule, and a call custom command. The “call” section provides the user 702 with customization options depending on the “rule type”, where the user 702 is presented with options to customize. The “filter condition” defines the condition to either pass or fail. The rule filter tab comprising the rules setup and the “call custom command” is similar to the child audit rule interface rules filter tab. The rule filter tab allows the user 702 to create a custom command.

The rule filter custom command interface is where the user 702 chooses the vendor specific commands based on the child types chosen. If the user 702 is unsure of the exact vendor command, based on the scope details and the child type chosen, the audit management system 701 displays the nearest match. If a command does not exist, the user 702 can add a command by clicking on an icon next to the custom command box to redirect the user 702 to the command upload feature interface. Commands can be added, removed or edited from this box. Once the user 702 has chosen the exact command, the next step is to choose the filter condition. The filter condition is the actual condition the user 702 wishes to create for the audit check. The filter condition lists the keyword first and then the other options within the command. To create the proper filter condition, there are three items, for example, a command option, an operator, and a keyword, that need to be present and customized.

The call child audit rule in the rules setup option of the rule filter tab is a feature available to parent audit rules. This allows the user 702 to call a child audit rule and based on the condition if the child audit rule failed or passed, a rule action is evaluated. In order to call child audit rules, the user 702 can select a rule type, a child type, or select a child audit rule. The rule type is, for example, “call child audit rule only”. The child type allows selection of the child type, for example, global router, policy map, etc. The select child audit rule once selected gives a list of available child audit rules by child type. The audit management system 701 enables the user 702 to perform the options of adding and removing one or more child audit rules.

The “call parent audit rule” in the rule setup of the rule filter tab is a feature available to parent audit rules. This allows the user 702 to call a parent audit rule and based on the condition if the parent audit rule failed or passed, a rule action is evaluated. In order to call child audit rules, the user 702 can select a rule type, a child type, and select a parent rule. The “rule type” allows “Call Parent Audit Rule Only” to be selected. The child type option allows, for example, global router, policy-map, etc., to be selected. Once rule type is selected, a list of available parent audit rules by child type is listed to the user 702 for adding or removing.

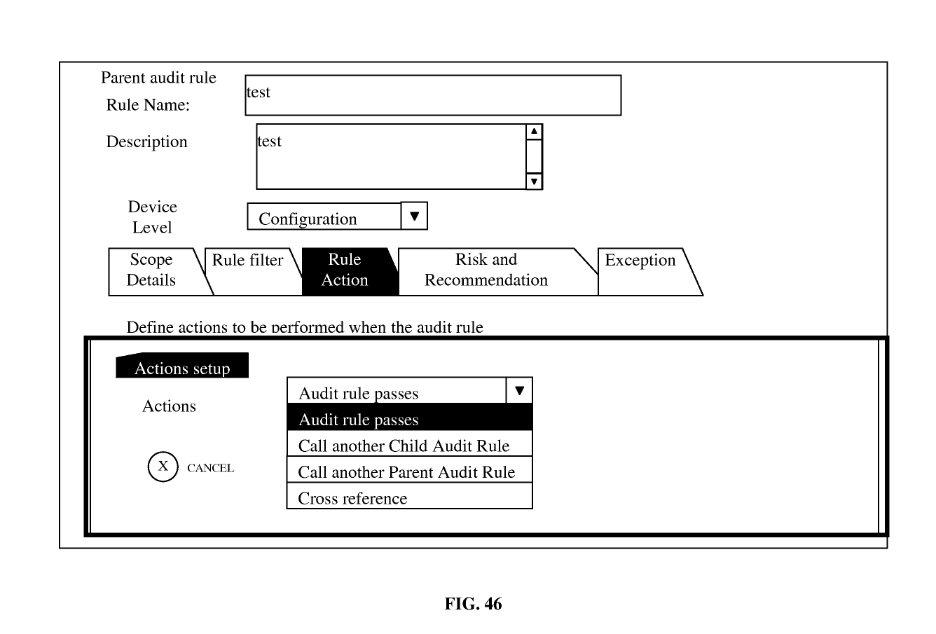

The rule action tab is the third interface within the parent audit rule as exemplarily illustrated in FIG. 46. The rule action tab represents the “then else” condition of the child audit rule, that is, when the rules filter condition passes what is the next action the user 702 would like to perform. The user 702 has four action choices, for example, audit rules passes, call another audit child rule, call another audit parent rule, and cross reference. The audit rules passes means that if the rules filter condition passes, then there is no other condition that needs to be evaluated. The “call another child audit rule” means referencing child audit rules depending on whether the audit filter condition passes or fails. This is similar to linking other audit rules. The “call another parent audit rule” means referencing parent audit rules depending on whether the audit filter condition passes or fails. This is similar to linking other audit rules. If the rules filter condition passes, then another condition is necessary to be evaluated. The cross reference allows selection of the child type, and usage of the rule filter.

The risk and recommendation tab is the fourth interface for the parent audit rule, as exemplarily illustrated in FIGS. 44-46, and comprises three main sections, namely, “risk”, “recommendation”, and “rating and weighting”. This interface allows the user 702 to define the risk and recommendation for an audit check when the condition has not passed. If the condition has not passed, the risk and recommendation is displayed in the compliance section and the PDF reports. The “risk” section allows the user 702 to define the details for non-compliance. The user 702 can choose, for example, the category for associating the audit check, risk definition for highlighting the non-compliance risk definition, and rating for an audit check. The “recommendation” section provides options for category, recommendation, child type, command, command reference, and web reference. There are more than fifty recommendation categories defined. This allows the audit check to be associated with the right category. These categories align with the risk section categories. The “recommendation” section allows the user 702 to write the definition up to 3000 alphanumeric characters necessary to highlight the non-compliance risk recommendation. The child type allows the user 702 to place the recommendation within the specific child type. The command allows the user 702 to enter the correct command that should be used should the audit check fail. The command reference allows the user 702 to enter the text up to 3000 alphanumeric characters. The web reference allows a URL to be entered that redirects the user 702 to an online web reference in the root cause window for an audit check.

The rating and weighting section allows the user 702 to associate each child audit rule with up to six compliances. The user 702 can select a compliance policy for associating the audit check, a rating value for the audit check should it fail, etc., for rating. The audit check is reported in the appropriate PDF reports for that particular compliance. The user 702 can select compliance policy and rating value for weighting which provides an average score for an audit rule.

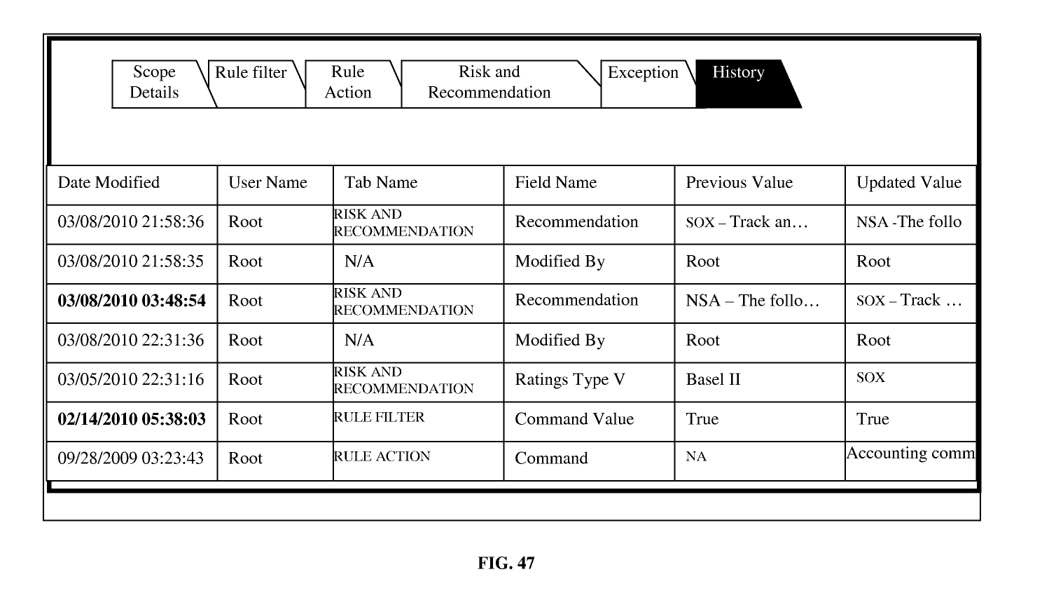

The exception tab is the fifth interface for the parent audit rule as exemplarily illustrated in FIGS. 44-46. This allows the user 702 to define when not to apply a given audit rule even though the audit rule is selected within an audit policy. By choosing an available location or category, the user 702 can select the device name for the exception. By checking a box on the interface, the user 702 has the option to ensure that the audit check is not applied within a certain recurrence or at a specific date and time. The history tab is the last interface available for the parent audit rule as exemplarily illustrated in FIG. 47. This interface only appears when editing an existing audit rule and not when creating a new one. The history tab provides an audit trail by allowing the user 702 to have visibility on who changed the details in one of the interfaces. On the history tab, the user 702 can view the date and time that the option was modified, user name of the user 702 who modified the audit rule, tab name modified, field name that is the option value that was modified, previous value assigned to the option, and updated value assigned to the option.

A new parent audit rule can be created by following a sequence of steps. The user 702 can add a new parent audit rule by providing a unique rule name, a rule description, providing the scope details for the parent audit rule, defining a rule filter, a rule action, etc., selecting risk and recommendation, and performing an exception. The best practice for creating scope details comprises ensuring the scope is as large as possible to future proof against newer model revisions, code versions and image names revisions. For a new parent audit rule, the user 702 cannot proceed to the rule filter tab until a vendor scope has been defined. Once an option has been entered in the scope selection table, then the rule filter tab can be selected. The rule filter tab represents the “if” condition of the child rule. The user 702 can select the “call child audit rule only” option, if the user 702 wants to create a condition based on results of a child audit rule. The user 702 can select the “call another parent audit rule” option, if the user 702 wants to create a condition based on results of a child audit rule. The user 702 has to first define the “child type” to easily create the check for that section. Custom command condition is applicable when the user 702 chooses the vendor specific commands based on the child types chosen to create the audit check. The user 702 can create a filter to define the condition for the audit check. Depending on the custom command chosen and the number of options within them, the filter condition allows the user 702 to choose the conditions. Once the rule interface selection is completed, the user 702 can select the rule action tab.

The rule action tab is the third interface within the parent audit rule. The rule action tab represents the “then else” condition of the child audit rule, that is, when the rules filter condition passes what is the next action the user 702 would like to perform. The user 702 has options, for example, audit rules passes, call another audit child rule, call another audit parent rule, and call custom command. The audit rule passes means that if the rules filter condition passes, then there is no other condition that needs to be evaluated. The call another child audit rule refers to referencing child audit rules depending on whether the audit filter condition passes or fails. This is similar to linking other audit rules. The call another audit parent rule refers to referencing parent audit rules depending on whether the audit filter condition passes or fails. This is similar to linking other audit rules. The call custom command indicates that if the rules filter condition passes, then another condition is necessary to be evaluated. The risk and recommendation section comprises risk, recommendation, and rating and weighing. The user 702 selects the risk category along with risk non-compliance details and the risk priority of the audit rules. The recommendation section makes recommendations to ensure compliance. The user 702 can enter the rating and weighting for that audit rule and assign it up to six compliances. The exception tab is the fifth interface for the parent audit rule. This allows the user 702 to define when not to apply a given audit rule even though the audit rule is selected within an audit policy.

The parent audit rule can be removed by selecting the parent audit rule using the check box next to the rule name. By clicking the remove button, one or more parent audit rules are removed. By clicking the OK button, the selected parent audit rule is deleted. If the audit rule being deleted is part of an existing audit group or parent audit rule, and the audit rule is being deleted, then an acknowledgement box appears to confirm the action. If the audit rule is part of an existing audit policy or audit schedule, the audit rule cannot be deleted until the audit rule has been removed from the audit policy or schedule. The user 702 can also edit the parent audit rule. In an embodiment, default audit rules created by the audit management system 701 cannot be deleted by the user 702. The audit management system 701 allows only the compliance to be changed and permits the copying of audit rules.

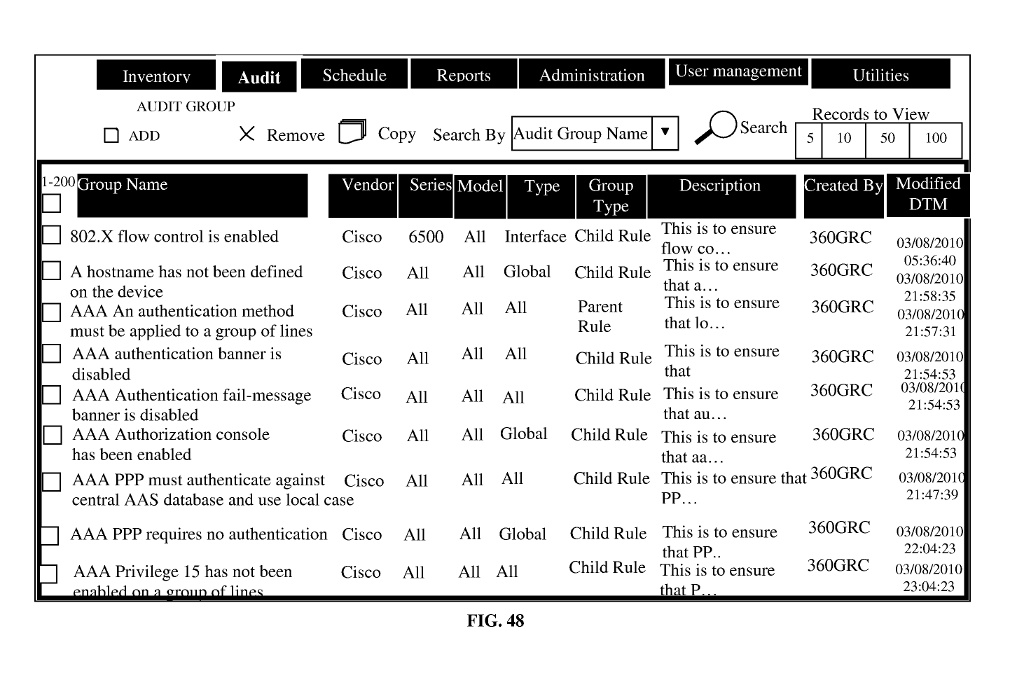

Audit groups are used to logically categorize sets of parent audit rules or child audit rules as exemplarily illustrated in FIG. 48. The audit groups can then be referenced easily within an audit policy rather than by calling the individual child audit rules. Audit groups are used to group sets of child audit rules and parent audit rules together. By grouping audit rules together, the user 702 can functionally create groups that can then be referenced within an audit policy easily. Audit groups reside on the top of the audit rule tree. Audit groups can reference either single or multiple child audit rules or parent audit rules. Parent audit rules can in turn reference single or multiple audit rules. Audit groups can be referred to within an audit policy. Child audit rules and parent audit rules are typically used to create audit checks based on a vendor command. Within a category, for example, simple network management protocol (SNMP), multiple audit checks can be written to audit various areas of the configuration file. The user 702 has an option to refer to these individual audit rules within an audit policy or logically categorize audit rules and refer to a single audit group. The process to create a new audit group comprises tasks such as identifying scope details and selecting audit rules. In order to create an audit group, the user 702 needs to identify the details of the network layer device and the audit rules to associate through scope details. The audit rule comprises two options namely selecting child audit rules or parent audit rules. This allows the user 702 to logically refer to sets of audit rules that can be categorized together.

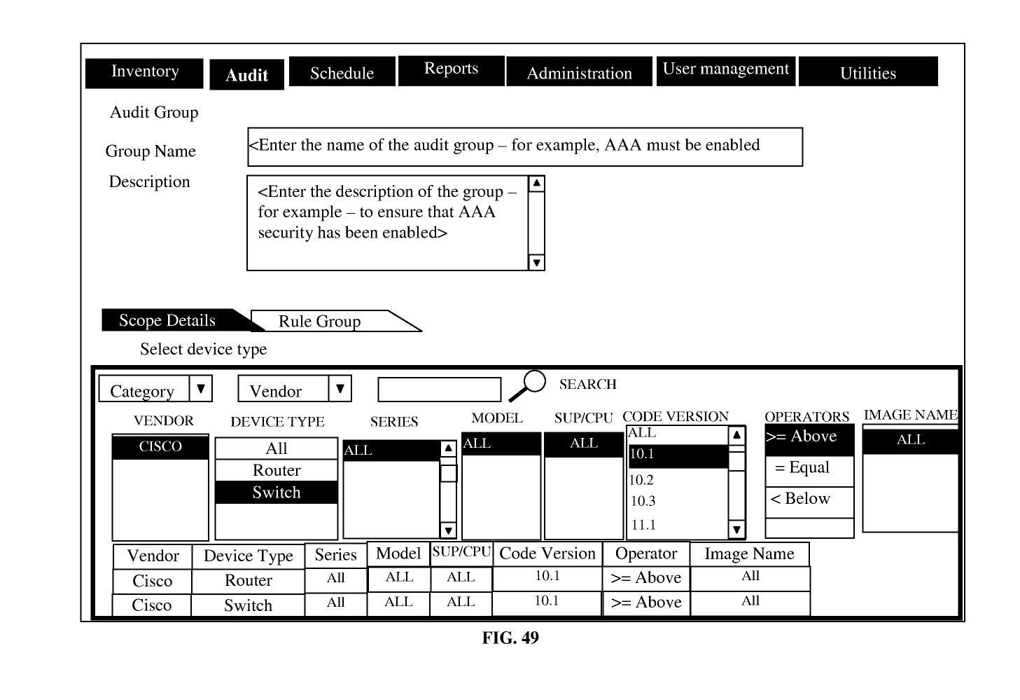

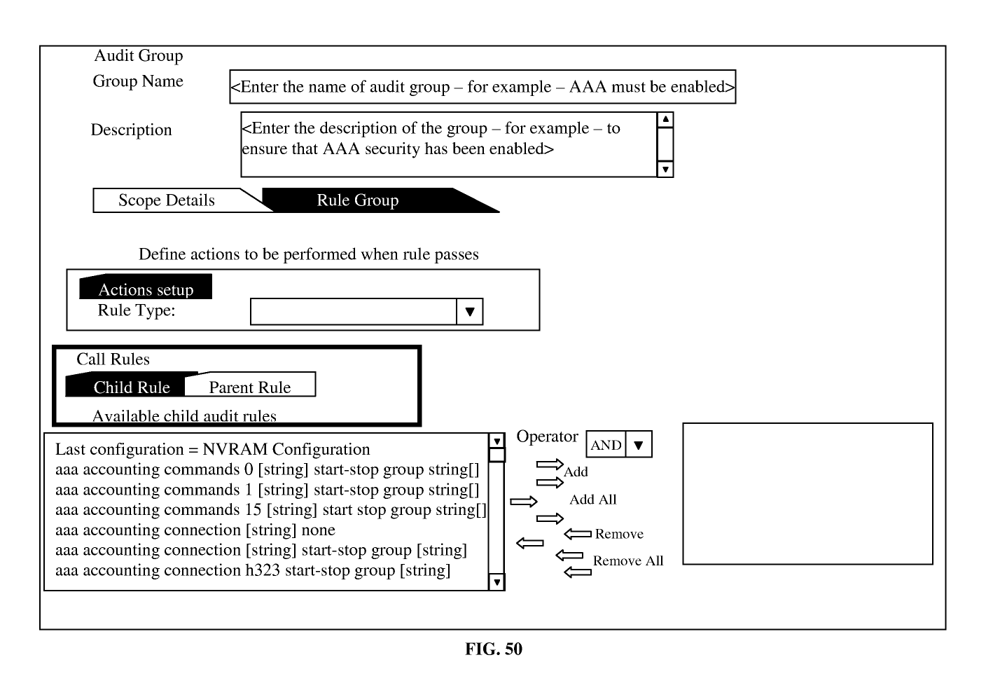

When browsing to an audit group, the user 702 is redirected to the scope details interface as exemplarily illustrated in FIG. 49. Before creating the audit group, the user 702 must define the scope for the vendor and the platform for which the audit check was created. The details of this can be obtained through the vendor interface that is a part of the device management interface, under the parent inventory. The scope details interface allows the user 702 to select a vendor, type of network layer device, series of the network layer device, model type of the network layer device, code version of the network layer device, the image name of the network layer device, etc. To add a scope to a new audit group, the vendor list is clicked and the tree down the columns is followed. The audit management system 701 allows the user 702 to create one audit group across multiple vendors, platforms, code versions, or image names. When the user 702 moves to the rule group interface as exemplarily illustrated in FIG. 50, the user 702 can add a new platform option to the selection list, remove a platform from the list, or clear the current items. For a new child audit rule, the user 702 cannot proceed to the rule filter tab, until a vendor scope has been clearly defined.

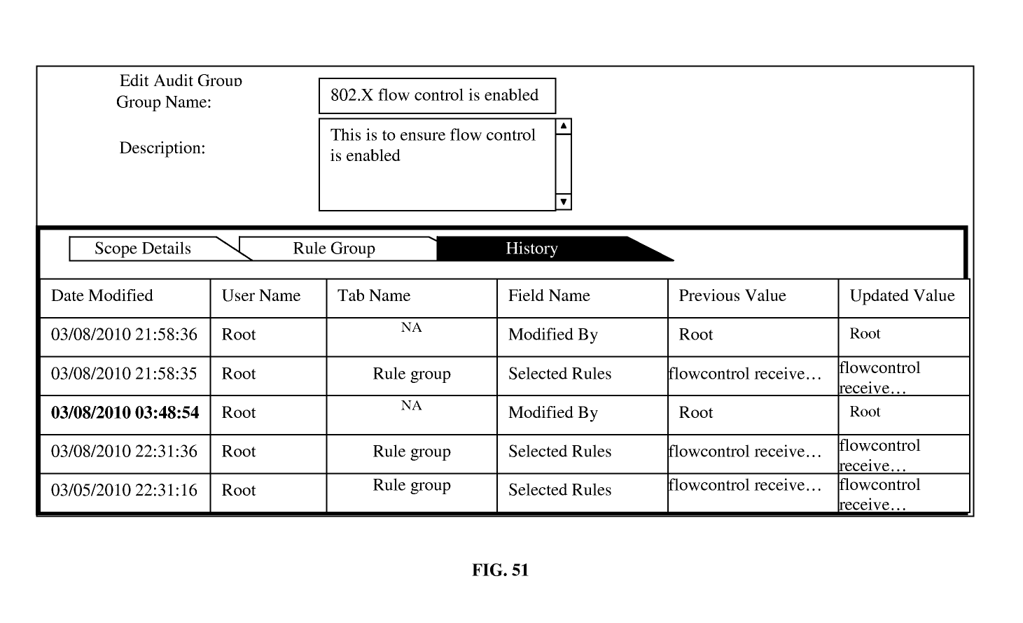

Within the rule group interface as exemplarily illustrated in FIG. 50, the user 702 has two options to logically group single or multiple child audit rules or parent audit rules. In order to select audit rules, the user 702 must first select the child type. This is the child type using which the child audit rules or the parent audit rules were created. Once the proper child type has been selected, the user 702 can choose from a list of available audit rules. In the child audit rule interface, the user 702 can select single or multiple child audit rules by child types. In the parent audit rule interface, based on the child type, the user 702 can select single or multiple parent audit rules. The user 702 is allowed to select only child audit rules or parent audit rules. If the user 702 tries to select both child and parent audit rules within the same audit group, the audit management system 701 displays an error message appears when the user 702 tries to save the audit group. If the user 702 selects a child audit rule option, all child audit rules are listed for that child type. The user 702 can then add single or multiple child audit rules or remove child audit rules. If the user 702 selects the parent audit rule option, all the available parent audit rules are listed for that child type. The user 702 can then add single or multiple parent audit rules or remove parent audit rules. The history tab is the last interface available for audit groups as exemplarily illustrated in FIG. 51. The history tab appears only when editing an existing group. This interface provides an audit trail allowing the user 702 to have visibility on who changed the details in one of the tabs.

A new audit group can be created by following a sequence of steps. The user 702 can add an audit group by providing a unique name and a description for each audit group, and entering the scope details. The best practice for creating scope details comprises ensuring the scope is as large as possible to future proof revisions. If the scope is specific to a single image, the “equal to” option is used. If the scope of the audit rule applies to more than one vendor or device type, the user 702 ensures that all the choices are included within the selection table to prevent multiple audit rules from being created. For a new audit group, the user 702 cannot proceed to the rule group interface, until a vendor scope has been clearly defined. Once an option has been entered in the scope selection table, then the rule group interface can be selected. In the rule group interface, the user 702 selects a child audit rule or a parent audit rule based on the child type. The user 702 can also edit or remove one or more audit groups. In an embodiment, the audit groups created by the audit management system 701 cannot be deleted or edited by the user 702. The audit rules created by the audit management system 701 cannot be edited, that is, no other setting within the audit group can be changed. If the user 702 tries to change any setting, the audit management system 701 displays an error message.

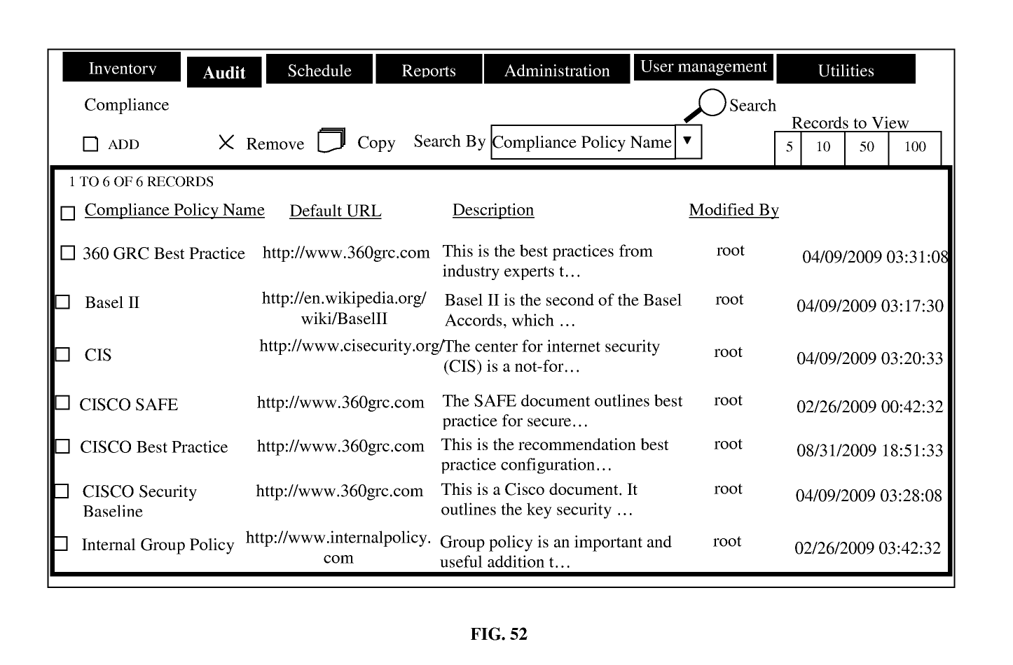

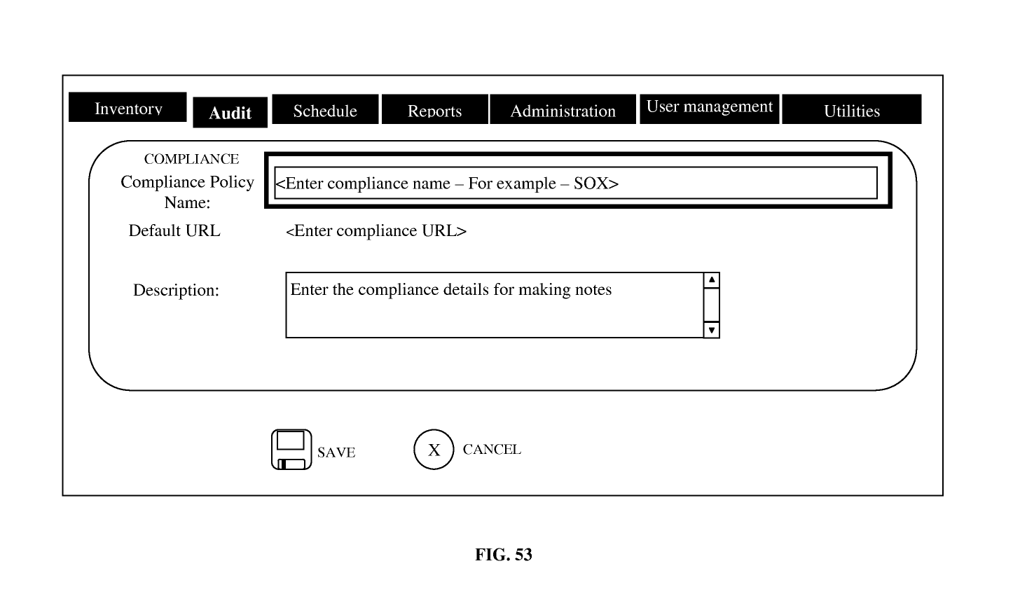

The compliance interface, as exemplarily illustrated in FIG. 52, is used to add or remove any mandatory, best practice or internal compliance details so that child audit rules and parent audit rules can be mapped to the compliance policies. The compliance interface lists mandatory compliance policies, industry best practices, governance frameworks or internal compliance names. Any compliance policy created here is reflected within the risk and recommendation tab under the rating and weighting sections. Compliance policies can be created, copied or deleted from within this interface. Once a compliance policy has been created, the details cannot be edited. The compliance policy can be viewed by clicking on the name of the compliance policy. A new compliance policy can be added by providing a unique name to the compliance policy, entering the URL to a main compliance policy website, entering the compliance policy description, and saving the compliance policy created as exemplarily illustrated in FIG. 53. A compliance policy created can be copied, deleted, or removed.

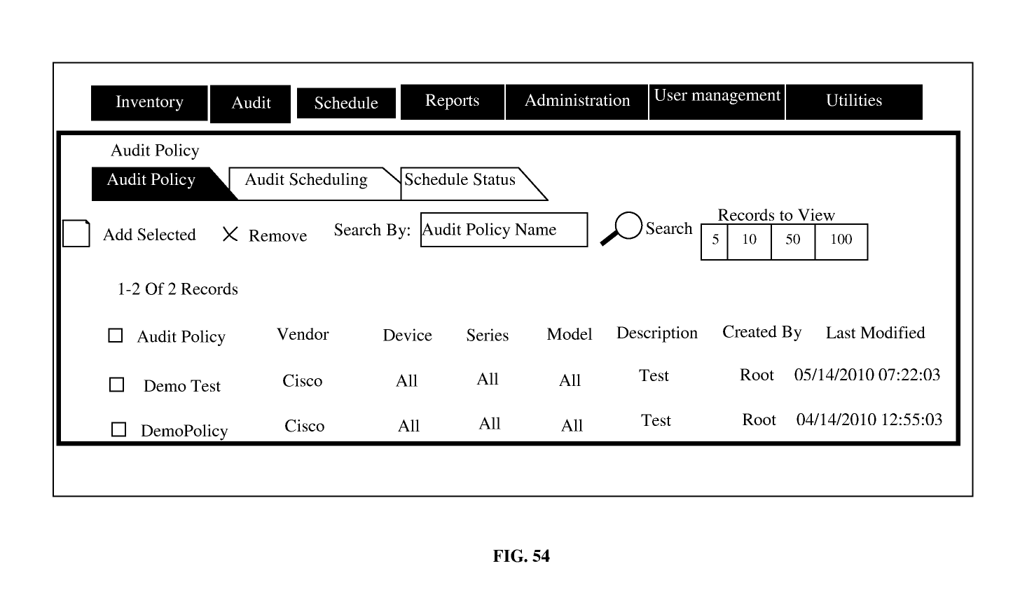

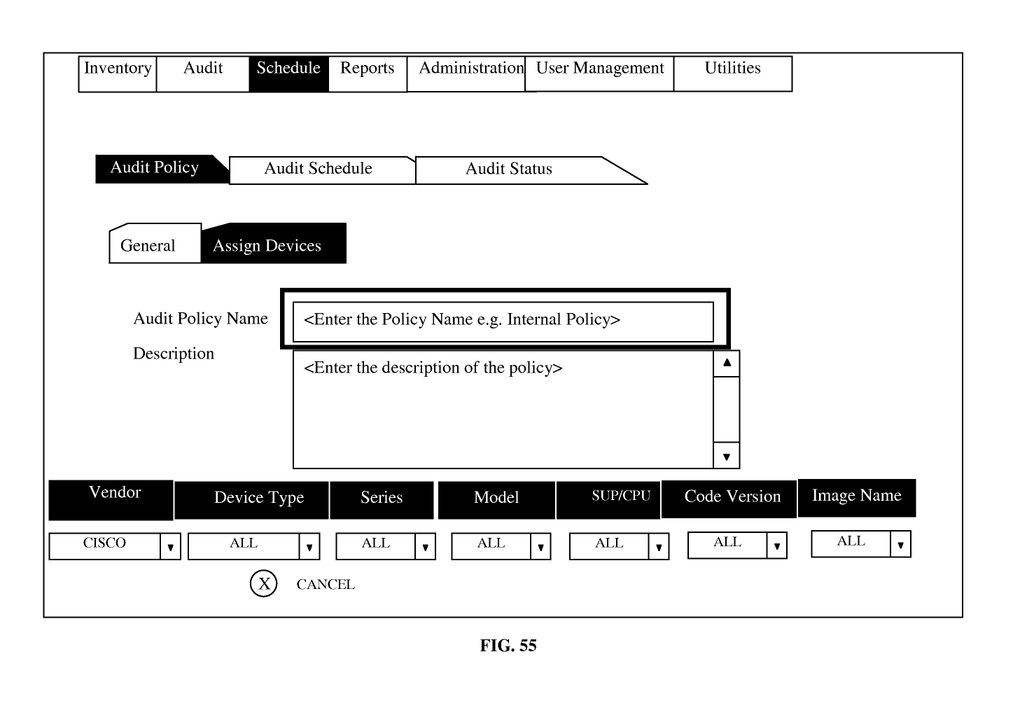

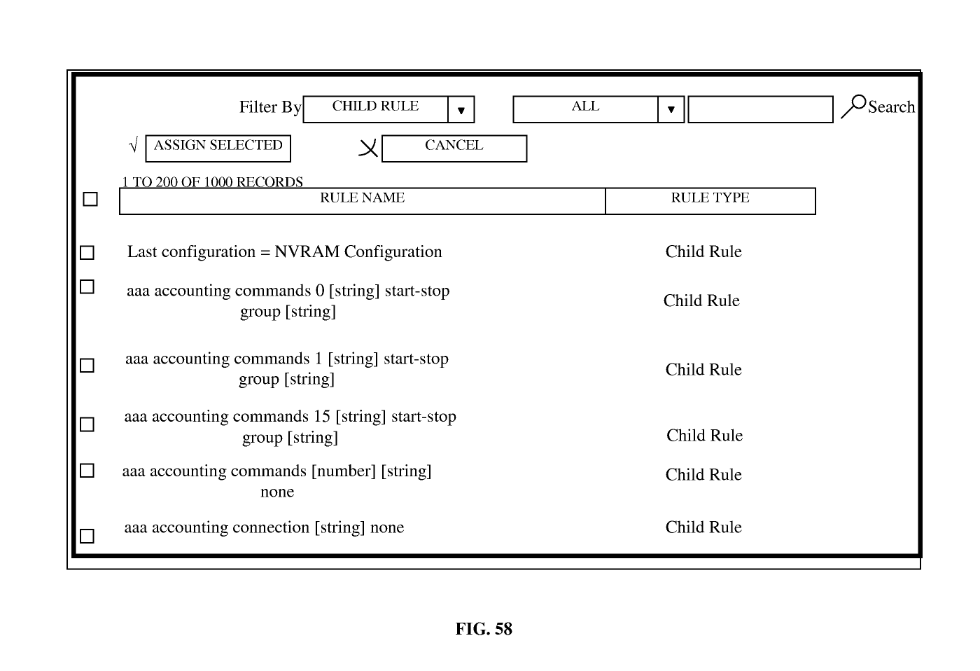

An audit policy is what defines which audit rules are applied to which network layer devices. The audit policy can be customized per the user environment and once created can be used to schedule an audit. An audit policy is the third step in order to create a successful audit. The audit policy is where the user 702 can assign audit rules to network layer devices within the infrastructure. Once the user 702 has assigned network layer devices and the audit is scheduled, the audit management system 701 ensures that the proper audit checks are executed with the correct vendor or platform. In an embodiment, the audit policy is located on a schedule interface as exemplarily illustrated in FIG. 54. The user 702 can create a new audit policy by adding the new audit policy with a unique name, entering an audit policy description, defining the audit policy scope, selecting the network layer devices based on scope details, and selecting the audit rules to be assigned to each network layer device as exemplarily illustrated in FIGS. 55-57. The user 702 can search for the network layer devices based on a location, a category, and a vendor. The next step is to assign audit rules to the network layer devices. The audit management system 701 allows the user 702 to assign different audit rules to different network layer devices within the same audit policy. The user 702 can search for audit rules using filters, for example, a child audit rule filter, a parent audit rule filter, an audit group filter, and a compliance filter as exemplarily illustrated in FIG. 58. The user 702 can edit and remove the audit policy.

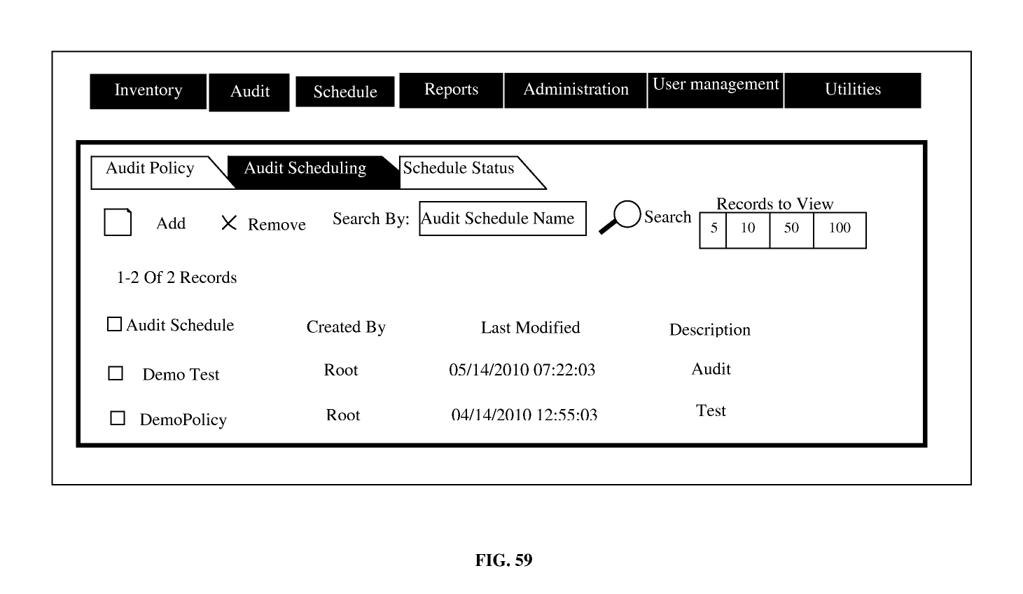

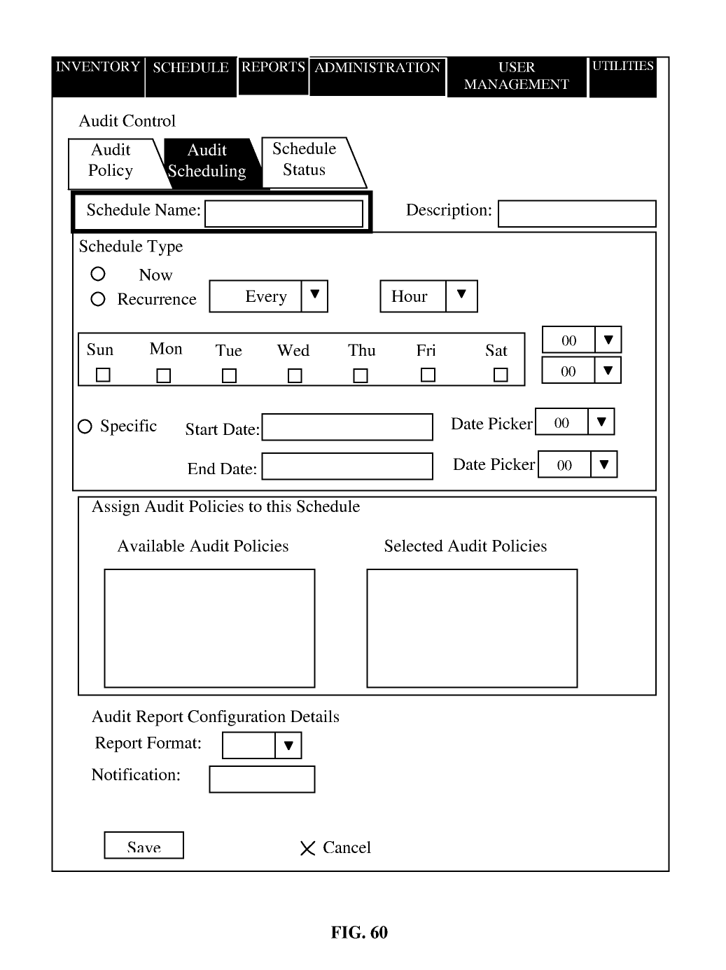

An audit schedule is the date and time when the audit rules are executed by the audit management system 701 on the device configurations. The audit schedule determines whether the results should be displayed on the screen, as exemplarily illustrated in FIG. 59, or whether the user 702 wants to generate a compliance-based audit report in a PDF format. The audit schedule is the fourth step in order to create a successful audit. On completion of the audit schedule, the compliance front-end sections are updated and a PDF report may optionally be generated.

The user 702 can create the audit schedule by adding a new schedule with a unique audit schedule name, defining an audit schedule description, defining the date and time to run an audit schedule, assigning an audit policy, defining configuration details, and saving the audit schedule as exemplarily illustrated in FIG. 60. The user 702 can schedule an immediate audit, a recurring audit, or an audit scheduled at a specific date and time. The user 702 can define the format of the report. The user 702 can create a report only or create a report and a PDF report for a particular compliance policy. The report can be displayed on the screen. If the user 702 chooses a particular option, the results of the audit are displayed in the compliance front-end section only. The user 702 has the option of entering where an electronic mail (email) notification can be sent out once the schedule is complete. The report can be in the form of an Adobe® PDF document. The user 702 can view the results in the dashboard and also create an Adobe® PDF report based on a compliance policy. For the PDF report to be created, the user 702 must define the audit report name, audit report description, name of the company, etc. The third format is “All”, wherein the audit management system 701 allows creation of a PDF report for all compliance policies. The user 702 can also edit and remove the created audit schedule.

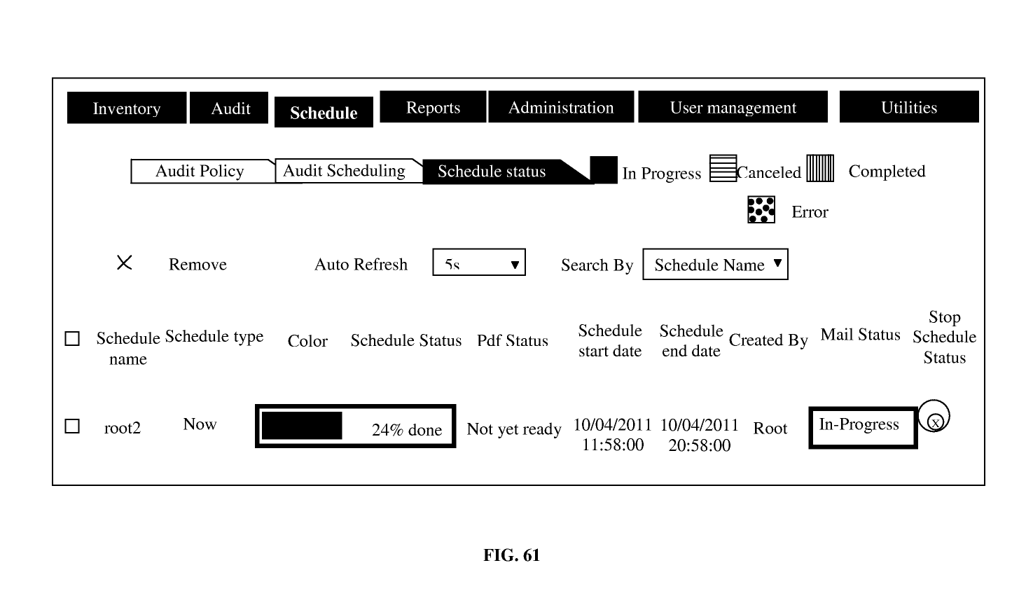

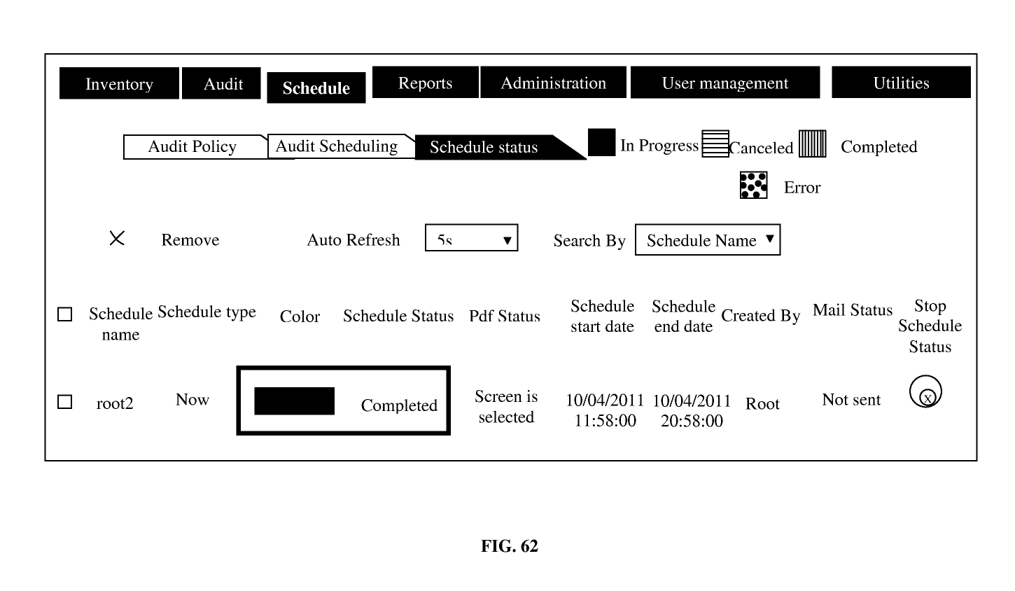

Once an audit has been scheduled, the audit appears in the schedule status. There are various status stages, and this helps the user 702 identify when the audit schedule is completed. The schedule status guides the user 702 to schedule an audit at a specific time and to be able to either view the results on the interface or generate a PDF report. Once an audit has been scheduled, the audit is assigned a status. An audit schedule comprises two phases, for example, “in progress” and “completed”. Once the audit schedule date and time has been reached, the schedule is assigned an “in progress” status depicting, for example, the percentage of completion as exemplarily illustrated in FIG. 61. The user 702 is able to identify the date and time when the audit was started and this coincides with the start date and time of the audit schedule. Once the audit has been completed, the audit schedule is assigned a “completed” phase status as exemplarily illustrated in FIG. 62. If the user 702 has scheduled an audit and requested for a PDF report, the audit management system 701 first completes the front-end section and then creates the PDF report. Once the front-end section is complete, the user 702 can view the results, while the PDF report is being generated. Once both sections are complete, a completed status is assigned to the PDF column.

If the user 702 wants to stop an audit in progress, the user 702 can click on the “stop” button for terminating the audit schedule immediately. This provides the user 702 flexibility in case the wrong schedule was started or any changes need to be made to the audit policy assigned to the audit schedule. If the user 702 tries to schedule another audit while the schedule of an existing audit is being executed, a warning message is displayed to the user 702 about resource issues. The user 702 has the option to continue or reschedule the audit after the existing one has been completed.

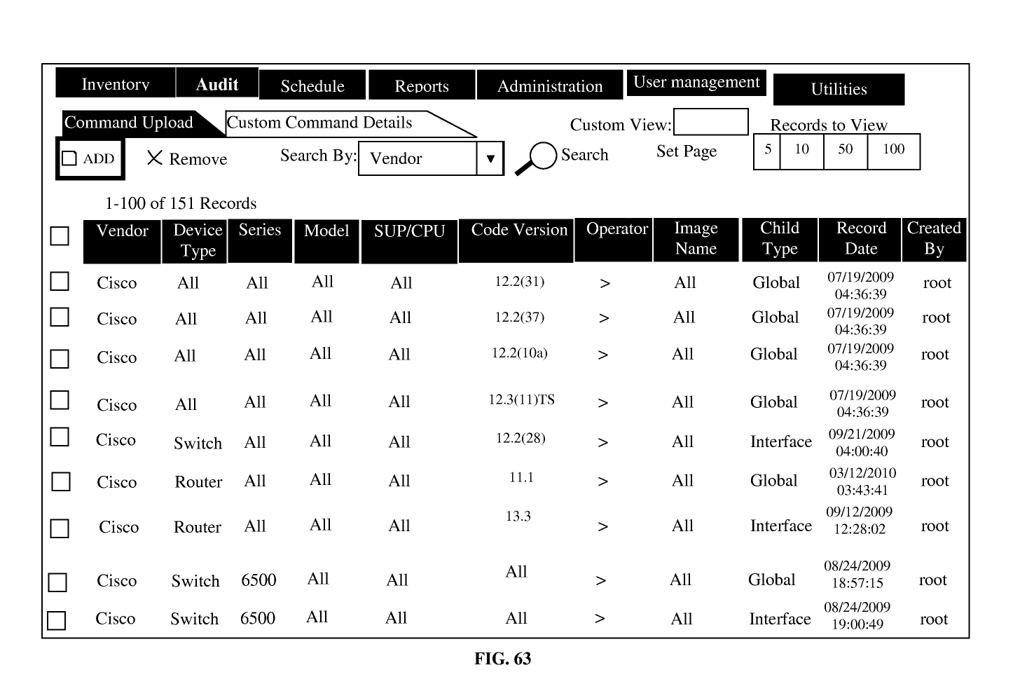

The audit management system 701 provides an option for command upload as exemplarily illustrated in FIG. 63. Command upload allows the user 702 to customize the commands for various vendors that are mapped in the inventory management section. As vendors release new products, series or code images, the command upload utility provides the user 702 the flexibility to enter commands that match these newer revisions. These commands are then referenced by child audit rules and parent audit rules to create filter conditions and audit the device configurations. The command upload utility allows the user 702 to add, view or delete any command that relates to a vendor. As vendors update existing hardware or begin selling new hardware, the user 702 has the ability to add new commands that relate to the new hardware. These new commands can then be referenced by child audit rules and parent audit rules to create filter conditions. The audit management system 701 enables the user 702 to view existing commands that are associated with a specific vendor platform, add a single command for a scope vendor platform, remove a single command, and add bulk commands. The command terminology comprises a command syntax that must be entered for a child audit rule or a parent audit rule to create filter conditions. The command syntax has a specific format comprising, for example, a keyword, a command option that has a string, a number, and an address such as an internet protocol address.

In an embodiment, the audit management system 701 provides a device inventory upload utility to the user 702 for bulk uploading a number of network layer devices into the inventory section. The device inventory upload utility saves the user 702 time from manually entering the network layer devices individually. Uploading device details is the first step of an audit process. This section is mainly used when the audit management system 701 is first deployed, or if the user 702 is deploying a new site, acquiring a new business, etc., and a large number of device details need to be entered at the same time. The audit management system 701 provides the user 702 with a device utility sheet in a predefined format, for bulk uploading the network layer devices.

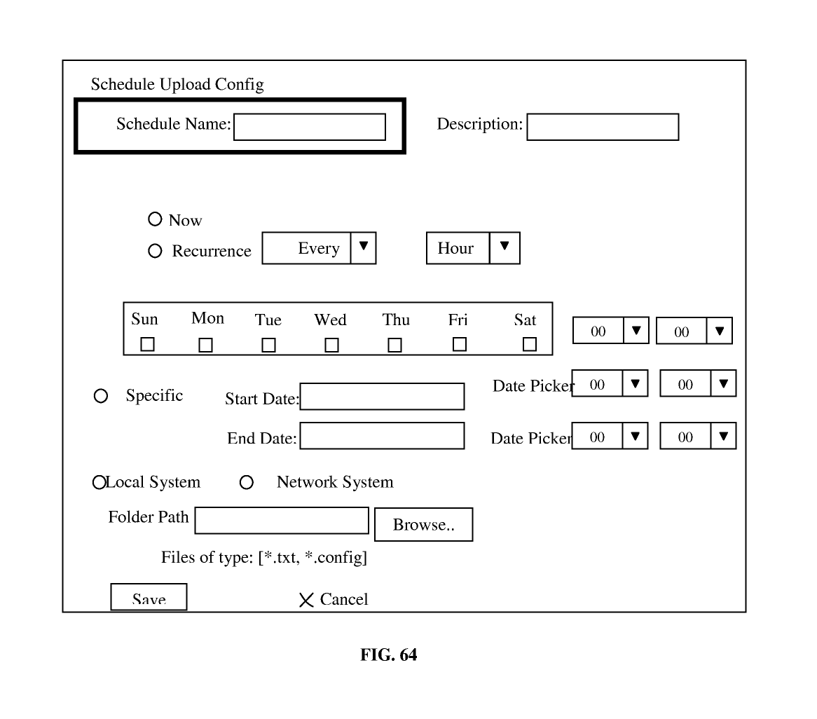

In another embodiment, when the user 702 wants to bulk upload a number of device configuration files, the audit management system 701 provides a device configuration upload utility. This device configuration upload utility saves the user 702 time from manually uploading each of the configuration files of the network layer devices individually. Uploading device configurations is the second step of an audit process. A configuration file of a network layer device changes over time whether through new code versions, deployment of new features, or configuration changes. In order to automate this process, in another embodiment, the audit management system 701 provides a schedule configuration utility to the user 702 as exemplarily illustrated in FIG. 64. The schedule configuration utility can upload new configuration files at scheduled points in time and then run audits on the configuration files.

In another embodiment, the audit management system 701 provides an upload logo utility that allows the user 702 to add their personalized corporate logo to the generated PDF report. The logo is, for example, in a joint photographic experts group (JPEG) format or a tagged image file format (TIFF), which is of about 50×20 pixels. In another embodiment, the audit management system 701 performs user management to allow the user 702 to assign access to the audit management system 701 based on roles. The audit management system 701 allows the administrator to assign users 702 in groups and departments for better administration. The audit management system 701 shows how users 702, groups and departments can be added, edited and removed, and how administrative rights can be placed on user privileges. The audit management system 701 creates user accounts with user privilege, group privileges, and departments.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the audit database 701m, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for managing an audit of one or more network layer devices, comprising:
providing an audit management system accessible by a user via a graphical user interface;
acquiring network layer device information of said one or more network layer devices via said graphical user interface by said audit management system;
acquiring a configuration file comprising configuration file commands that define configuration of each of said one or more network layer devices, via said graphical user interface by said audit management system;
allowing one or more of creation and selection of one or more audit policies comprising one or more audit rules for said one or more network layer devices by said audit management system, wherein said one or more audit rules define functioning of said one or more network layer devices for one or more compliance policies;
executing said one or more audit policies for performing said audit of said one or more network layer devices by said audit management system; and
generating a report comprising information about security and compliance of said one or more network layer devices with said one or more compliance policies based on said execution of said one or more audit policies.

2. The computer implemented method of claim 1, wherein said one or more audit policies define an association of said one or more network layer devices with said one or more audit rules.

3. The computer implemented method of claim 1, wherein said execution of said one or more audit policies comprises comparing said configuration file commands of said configuration file with said one or more audit rules of said one or more audit policies for verifying said security and said compliance of said one or more network layer devices with said one or more compliance policies.

4. The computer implemented method of claim 1, wherein said one or more audit rules of said one or more audit policies comprise one of parent audit rules, child audit rules, and a combination thereof, wherein said audit management system selects one or more of said parent audit rules and said child audit rules for enabling a conditional audit of said one or more network layer devices.

5. The computer implemented method of claim 1, further comprising creating said one or more audit rules for said one or more audit policies by said audit management system, comprising:
identifying scope details from said network layer device information associated with said one or more network layer devices for selecting one or more of said network layer devices for said audit;
defining audit commands that correspond to said configuration file commands of said configuration file; and
creating one or more filter conditions for each of said audit commands, wherein said created one or more filter conditions specify criteria for finding a match between said configuration file commands of said configuration file and said one or more audit rules during said execution of said one or more audit policies, and wherein said audit commands with said created one or more filter conditions create said one or more audit rules for performing said audit of said selected one or more network layer devices.

6. The computer implemented method of claim 5, further comprising defining risk information for each of said selected one or more network layer devices when said match between said configuration file commands of said configuration file and said one or more audit rules is not found during said execution said one or more audit policies.

7. The computer implemented method of claim 5, further comprising defining a rule action associated with said one or more filter conditions of said one or more audit rules by said user via said graphical user interface, wherein said audit management system performs said rule action when said one or more filter conditions are met.

8. The computer implemented method of claim 1, further comprising selecting one or more of said audit rules to be excluded during said execution of said one or more audit policies comprising said audit rules, by said user via said graphical user interface.

9. The computer implemented method of claim 1, further comprising selecting one or more of said network layer devices to be excluded during said execution of said one or more audit policies by said user via said graphical user interface.

10. The computer implemented method of claim 1, further comprising grouping one or more of said audit rules within each of said one or more audit policies by said audit management system for optimizing said execution of said one or more audit policies.

11. The computer implemented method of claim 1, further comprising automatically selecting audit commands that match said network layer device information and said configuration file commands of said configuration file by said audit management system for creating said one or more audit rules for said one or more audit policies.

12. The computer implemented method of claim 1, further comprising:
performing a root cause analysis by said audit management system for determining cause of non-compliance of said one or more network layer devices with said one or more compliance policies on said execution of said one or more audit policies, wherein said non-compliance is determined on identifying disparities between said configuration file commands of said configuration file with said one or more audit rules of said one or more audit policies, and on identifying absence of one or more of said configuration file commands in said configuration file;
collecting risk information associated with said non-compliance by said audit management system, wherein said risk information comprises a risk rating that defines severity of said non-compliance;
assigning a non-compliance score as a measure of said non-compliance by said audit management system; and
generating recommendations for remediating said non-compliance and presenting said generated recommendations to said user by said audit management system via said graphical user interface.

13. The computer implemented method of claim 12, further comprising setting scope criteria based on scope details acquired from said network layer device information for said audit of said one or more network layer devices, identifying one or more of said one or more network layer devices that fail to match said scope criteria set for said audit, and notifying said user on said identified one or more network layer devices failing to match said scope criteria, during said performance of said root cause analysis by said audit management system.

14. The computer implemented method of claim 12, wherein said generated recommendations specify modes of adjusting, adding, and removing one or more of said one or more audit rules from said one or more audit policies.

15. The computer implemented method of claim 1, further comprising selectively extracting results of said audit of said one or more network layer devices by said audit management system based on ad-hoc queries associated with said one or more compliance policies and said network layer device information, received from said user via said graphical user interface.

16. The computer implemented method of claim 1, further comprising tracking said performance of said audit of said one or more network layer devices over a predetermined period of time by said audit management system, and presenting risks associated with non-compliance of said one or more network layer devices with said one or more compliance policies, steps for remediation of said risks, and trends analyzed from said audit of said one or more network layer devices by said audit management system to said user via said graphical user interface.

17. The computer implemented method of claim 1, wherein said creation of said one or more audit policies comprises identifying one or more of said one or more audit rules that apply commonly across said one or more compliance policies to generate a list of unique audit rules for said one or more audit policies.

18. The computer implemented method of claim 1, wherein said acquisition of said network layer device information of said one or more network layer devices by said audit management system comprises one or more of acquiring manual entries of said network layer device information from said user via said graphical user interface, extracting said network layer device information based on a simple network management protocol, and performing an interoperable gathering of said network layer device information from third party entities associated with said audit management system.

19. The computer implemented method of claim 1, wherein said acquisition of said configuration file by said audit management system comprises one or more of acquiring manual entries of said configuration file from said user via said graphical user interface, extracting said configuration file based on a simple network management protocol, and performing an interoperable gathering of said configuration file from third party entities associated with said audit management system.

20. The computer implemented method of claim 1, further comprising scheduling said acquisition of said network layer device information, said acquisition of said configuration file, said creation of said one or more audit policies, said execution of said one or more audit policies, said generation of said report comprising said information about said security and said compliance of said one or more network layer devices with said one or more compliance policies, and transmission of notifications on status of said audit by said audit management system based on input received from said user via said graphical user interface.

21. The computer implemented method of claim 1, further comprising monitoring changes in one or more of said network layer device information, said configuration file, and said one or more audit policies by said audit management system, and triggering said acquisition of said network layer device information, said acquisition of said configuration file, acquisition of input from said user for said creation of said one or more audit policies and scheduling of said execution of said one or more audit policies by said audit management system on detecting said changes in said network layer device information, said configuration file, and said one or more audit policies.

22. The computer implemented method of claim 1, wherein said generation of said report by said audit management system comprises one or more of highlighting, prioritizing, and filtering said information about said security and said compliance of said one or more network layer devices with said one or more compliance policies by said audit management system based on predetermined criteria, wherein said predetermined criteria comprise one or more of ratings of impact assessment, said network layer device information, assignment of said one or more network layer devices to said audit, exposure of said one or more network layer devices to potential intrusions, and categories of said one or more network layer devices.

23. A computer implemented system for managing an audit of one or more network layer devices, comprising:
an audit management system accessible to a user via a graphical user interface, wherein said audit management system comprises:
a device information acquisition module that acquires network layer device information of said one or more network layer devices via said graphical user interface;
a configuration file acquisition module that acquires a configuration file via said graphical user interface, wherein said configuration file comprises configuration file commands that define configuration of each of said one or more network layer devices;
an audit policy creation module that allows one or more of creation and selection of one or more audit policies comprising one or more audit rules for said one or more network layer devices, wherein said one or more audit rules define functioning of said one or more network layer devices for one or more compliance policies;
an audit policy execution module that executes said one or more audit policies for performing said audit of said one or more network layer devices; and
a report generation module that generates a report comprising information about security and compliance of said one or more network layer devices with said one or more compliance policies based on said execution of said one or more audit policies.

24. The computer implemented system of claim 23, wherein said audit policy execution module compares said configuration file commands of said configuration file with said one or more audit rules of said one or more audit policies during said execution of said one or more audit policies for verifying said security and said compliance of said one or more network layer devices with said one or more compliance policies.

25. The computer implemented system of claim 23, wherein said audit policy creation module creates said one or more audit rules for said one or more audit policies by:
identifying scope details from said network layer device information associated with said one or more network layer devices for selecting one or more of said network layer devices for said audit;
defining audit commands that correspond to said configuration file commands of said configuration file; and
creating one or more filter conditions for each of said audit commands, wherein said created one or more filter conditions specify criteria for finding a match between said configuration file commands of said configuration file and said one or more audit rules during said execution of said one or more audit policies, and wherein said audit policy creation module creates said one or more audit rules from said audit commands with said created one or more filter conditions for performing said audit of said selected one or more network layer devices.

26. The computer implemented system of claim 25, wherein said audit policy creation module enables definition of a rule action associated with said one or more filter conditions of said one or more audit rules by said user via said graphical user interface, and performs said rule action when said one or more filter conditions are met.

27. The computer implemented system of claim 23, wherein said audit management system further comprises a scheduling engine that schedules said acquisition of said network layer device information, said acquisition of said configuration file, said creation of said one or more audit policies, said execution of said one or more audit policies, said generation of said report comprising said information about said security and said compliance of said one or more network layer devices with said one or more compliance policies, and transmission of notifications on status of said audit based on input received from said user via said graphical user interface.

28. The computer implemented system of claim 23, wherein said audit management system further comprises a root cause analysis module that performs:
a root cause analysis for determining cause of non-compliance of said one or more network layer devices with said one or more compliance policies on said execution of said one or more audit policies, wherein said non-compliance is determined on identifying disparities between said configuration file commands of said configuration file with said one or more audit rules of said one or more audit policies, and on identifying absence of one or more of said configuration file commands in said configuration file; and
setting scope criteria based on scope details acquired from said network layer device information for said audit of said one or more network layer devices, identifying one or more of said one or more network layer devices that fail to match said scope criteria set for said audit, and notifying said user on said identified one or more network layer devices failing to match said scope criteria, during said performance of said root cause analysis.

29. The computer implemented system of claim 23, wherein said audit management system further comprises a risk management module that performs:
defining risk information for each of said selected one or more network layer devices when said match between said configuration file commands of said configuration file and said one or more audit rules is not found during said execution said one or more audit policies; and
collecting said risk information associated with non-compliance of said one or more network layer devices with said one or more compliance policies determined on said execution of said one or more audit policies, and assigning a non-compliance score as a measure of said non-compliance.

30. The computer implemented system of claim 23, wherein said audit management system further comprises a recommendation engine that generates recommendations for remediating said non-compliance and presents said generated recommendations to said user via said graphical user interface, wherein said generated recommendations specify modes of adjusting, adding, and removing one or more of said one or more audit rules from said one or more audit policies.

31. The computer implemented system of claim 23, wherein said audit management system further comprises an ad-hoc query module that selectively extracts results of said audit of said one or more network layer devices based on ad-hoc queries associated with said one or more compliance policies and said network layer device information, received from said user via said graphical user interface.

32. The computer implemented system of claim 23, wherein said audit management system further comprises a tracking module that performs:
tracking said performance of said audit of said one or more network layer devices over a predetermined period of time, and presenting risks associated with non-compliance of said one or more network layer devices with said one or more compliance policies, steps for remediation of said risks, and trends analyzed from said audit of said one or more network layer devices to said user via said graphical user interface; and
monitoring changes in one or more of said network layer device information, said configuration file, and said one or more audit policies, and triggering said acquisition of said network layer device information, said acquisition of said configuration file, acquisition of input from said user for said creation of said one or more audit policies and scheduling of said execution of said one or more audit policies on detecting said changes in said network layer device information, said configuration file, and said one or more audit policies.

33. The computer implemented system of claim 23, wherein said report generation module performs one or more of highlighting, prioritizing, and filtering said information about said security and said compliance of said one or more network layer devices with said one or more compliance policies based on predetermined criteria, wherein said predetermined criteria comprise one or more of ratings of impact assessment, said network layer device information, assignment of said one or more network layer devices to said audit, exposure of said one or more network layer devices to potential intrusions, and categories of said one or more network layer devices.

34. A computer program product comprising computer executable instructions embodied in a non-transitory computer readable storage medium, wherein said computer program product comprises:
a first computer program code for acquiring network layer device information of one or more network layer devices via a graphical user interface of an audit management system accessible by a user;
a second computer program code for acquiring a configuration file comprising configuration file commands that define configuration of each of said one or more network layer devices, via said graphical user interface;
a third computer program code for allowing one or more of creation and selection of one or more audit policies comprising one or more audit rules for said one or more network layer devices by said audit management system, wherein said one or more audit rules define functioning of said one or more network layer devices for one or more compliance policies, and wherein said one or more audit policies define an association of said one or more network layer devices with said one or more audit rules;
a fourth computer program code for executing said one or more audit policies for performing said audit of said one or more network layer devices by said audit management system, wherein said execution of said one or more audit policies comprises comparing said configuration file commands of said configuration file with said one or more audit rules of said one or more audit policies for verifying security and compliance of said one or more network layer devices with said one or more compliance policies; and
a fifth computer program code for generating a report comprising information about said security and said compliance of said one or more network layer devices with said one or more compliance policies based on said execution of said one or more audit policies.
